(19) United States
(12) Patent Application Publication
(10) Pub. No.: US 2003/0123827 A1
(43) Pub. Date: Jul. 3, 2003

(54) Systems and methods of manufacturing integrated photonic circuit devices

(75) Inventors: Jack P. Salerno, Newton, MA (US); Guanghai Jin, Boxborough, MA (US); David J. Brady, Durham, NC (US)

Correspondence Address: BOWDITCH & DEWEY, LLP, 161 WORCESTER ROAD, P.O. BOX 9320, FRAMINGHAM, MA, 01701-9320, US

(73) Assignee: Xtalight, Inc., Newton, MA

(21) Appl. No.: 10/032,702

(22) Filed: Dec. 28, 2001

(51) Int. Cl. G02B 6/10; G02B 6/26

(52) U.S. Cl. 385/129; 385/27

(57) ABSTRACT

The systems and methods of the present invention includes the manufacturing of integrated photonic circuit devices using deposition processes such as, for example, supercritical fluid deposition (SFD). The present invention further includes the coupling of photonic crystal structures and planar waveguides to provide high performance, low-cost and scalable photonic components.

Preferred embodiments of the methods in accordance with the present invention produce high quality metal, metal dioxide, polymers, semiconductor and metal alloy deposits of precisely tailored composition in the form of thin films, conformal coatings on topologically complex surfaces, uniform deposits within high aspect ratio features, and both continuous and discrete deposits within microporous supports.

### BACKGROUND OF THE INVENTION

Photonic crystals including, for example, low loss periodic dielectrics allow the propagation of electromagnetic energy, for example, light, to be controlled in otherwise difficult or impossible ways. They are of great interest in the field of electromagnetics because certain types of photonic crystals exhibit a photonic band gap or stop band. The band gap defines a range of frequencies at which electromagnetic radiation striking the crystal is reflected by the crystal rather than being permitted to propagate through the crystal.

The typical photonic crystal is a spatially periodic structure. One well-known photonic crystal is formed of multiple elements of a dielectric material arranged in a three-dimensional lattice. Other crystals exhibit two-dimensional periodicity in which elongated, for example, cylindrical, elements made of dielectric material are arranged in a two-dimensional periodic pattern with their longitudinal axes parallel to each other. In these crystals, the dimensions of the lattice structures and the dielectric elements are selected to produce band gaps having desired center frequencies and bandwidths. Electromagnetic radiation at a frequency within the band gap is reflected from the structure via, for example, the Bragg reflection phenomenon.

The development of photonic crystals, structures with band gaps that prevent the propagation of light in a certain frequency range, has led to several proposals of many novel devices for important applications in lasers, opto-electronics, and communications. These devices, however, require the fabrication of photonic crystals allowing confinement of light in three dimensions. Moreover, the dimensional period of the features in a structure must be on the order of microns in order to control light of wavelengths typical in opto-electronics and other applications.

The market for optical networking components is one of the fastest growing segments of the data and telecommunications equipment and infrastructure industry. However, as recent market conditions have illustrated, most optical component manufacturers cannot scale manufacturing costs to meet industry demands due to the inherent limitations of the hand-assembly methods employed for their predominantly hybrid-component product lines. Moreover, even if these component suppliers introduce automated assembly methods, the level of cost reductions required to fuel industry growth cannot be achieved due to barriers that limit hybrid-architecture manufacturing capability. Further, component vendors who are trying to implement integrated component architectures are typically doing so with technologies that are not scalable to achieve increasingly higher levels of integration and the ensuing cost reductions. There is a need for technologies with the ability to scale, to enable photonic component and device architectures that can fuel the growth of optical networking components which provide continual reduction in functional cost.

### SUMMARY OF THE INVENTION

The systems and methods of the present invention includes the manufacturing of integrated photonic circuit devices using deposition processes such as, for example, supercritical fluid deposition (SFD). The present invention further includes the coupling of photonic crystal structures and planar waveguides to provide high performance, low-cost and scalable photonic components.

Preferred embodiments of the methods in accordance with the present invention produce high quality metal, metal oxide, polymers, semiconductor and metal alloy deposits of precisely tailored composition in the form of thin films, conformal coatings on topologically complex surfaces, uniform deposits within high aspect ratio features, and both continuous and discrete deposits within microporous supports. Moreover, the absence of surface tension inherent to supercritical solutions ensures complete wetting of surfaces of varying complexities.

Preferred embodiments of these devices are optical filters, waveguides permitting tight bends with low losses, channel-drop filters, efficient LEDs, and enhanced lasing cavities.

In accordance with a preferred embodiment, a photonic crystal structure includes a substrate having a surface characteristic and at least a first material disposed on the surface characteristic and conformally covering the surface.

The first material is disposed using deposition processes such as, but not limited to, supercritical fluid deposition processes. The surface characteristic can be a patterned substrate wherein the patterned substrate has submicron features. The features have an aspect ratio of between approximately twenty and thirty. Further, the first material can be one of at least a metal, a semiconductor, a polymer, a mixture of metals, a metal dioxide or metal sulphide and metal alloys.

The photonic crystal structure of a preferred embodiment includes a silicon wafer, and/or a silicon wafer having a silicon dioxide cladding layer. In a preferred embodiment, the photonic crystal structure forms a thin film filter. In alternate preferred embodiments the photonic crystal structure forms an integrated circuit.

A preferred embodiment of the present invention is an integrated waveguide device which includes a substrate having a first refractive index characteristic, a material disposed on the substrate having a second refractive index characteristic, and forming a waveguide layer. A second material is disposed at least within the first material having a third refractive index characteristic wherein the third refractive index characteristic is greater than the first and second refractive index characteristics. The integrated waveguide device further includes a cladding layer disposed on the first material. The integrated waveguide device has a waveguide layer having dimensions of approximately 6×6 μm². The integrated waveguide device of a preferred embodiment includes the second material deposited in one of a plurality of at least holes, trenches and/or cylinders. In a preferred embodiment, the aspect ratio of the plurality of holes is approximately in the range of 20 to 30.

In a preferred embodiment of the integrated waveguide device the first material has at least one patterned array of submicron features wherein the second material is deposited therein.

In accordance with another aspect of the present invention, a photonic crystal filter includes an input waveguide which carries a signal having at least one frequency including at least one desired frequency, an output waveguide, and a photonic crystal resonator system coupled between the input and output waveguides. The resonator is operable for the adjustable transfer of at least one desired frequency to the output waveguide. The photonic crystal filter is a fixed single-wavelength filter in one preferred embodiment. The photonic crystal filter is tunable for wavelength and polarization.

In a preferred embodiment, the photonic crystal filter includes a multi-cavity Fabry-Perot resonator. In the alternate, the photonic crystal filter includes a photonic crystal resonator system which is a single cavity Fabry-Perot resonator. The photonic crystal filter includes a photonic crystal resonator which has a first photonic crystal mirror and a second photonic crystal mirror, the second photonic crystal mirror is spaced from the first photonic crystal mirror to form a resonant cavity. In a preferred embodiment, the first and second photonic crystal mirrors are a two-dimensional hexagonal structure. In an alternate embodiment the first and the second photonic crystal mirrors are a three-dimensional structure.

In accordance with a preferred embodiment, the photonic crystal filter is a tunable filter wherein a change in a refractive index characteristic of the photonic crystal resonator system provides for tuning of the filter. The refractive index can be controlled by using one of either thermal optics, electro-optics, magneto-optics and piezo-optics means.

According to another aspect of the present invention, the photonic crystal filter has a photonic crystal resonator system which includes a photonic crystal that is a three-dimensionally periodic dielectric structure. In an alternate embodiment, the photonic crystal filter includes a photonic crystal that is a two-dimensionally periodic dielectric structure. Further, another embodiment includes a photonic crystal resonator system having a one-dimensionally periodic photonic crystal structure.

In accordance with another aspect of the present invention, a photonic crystal wavelength router includes at least a first input waveguide, at least a first output waveguide, a chromatic dispersion compensator, at least one wavelength division multiplex filter and photonic crystal reflectors. In a preferred embodiment the photonic crystal wavelength router further includes a power tap disposed therein. The photonic crystal wavelength router includes a material with tunable dielectric or absorbing properties. The photonic crystal wavelength router includes one of at least a one-dimensionally periodic photonic crystal, a two-dimensionally periodic photonic crystal or a three-dimensionally periodic photonic crystal.

In another preferred embodiment, a photonic crystal dynamic optical add/drop multiplexer includes a plurality of input waveguides, a plurality of output waveguides, a plurality of photonic crystal resonator systems disposed between the plurality of input waveguides and plurality of output waveguides, and a photonic crystal reflector coupled to the plurality of photonic crystal resonator systems.

Another aspect of the present invention includes a photonic crystal optical add/drop multiplexer having an input waveguide, at least a first output waveguide, an optical performance monitor, a photonic crystal wavelength router, and a dispersion compensation module.

A method of producing an integrated photonic circuit device, includes providing a substrate with a surface characteristic and a first refractive index characteristic, disposing at least a first material with a second refractive index characteristic onto the surface characteristic, wherein the second refractive index characteristic is higher than the first. The method of producing an integrated photonic circuit device further includes etching the surface characteristic of the substrate to form a plurality of cavities having an aspect ratio characteristic and depositing a second material having a third refractive index characteristic in the plurality of cavities, the third refractive index characteristic being higher than the first and the second refractive index characteristic. The aspect ratio characteristic is approximately 30.

In another preferred embodiment, a periodic three-dimensional photonic crystal structure includes a substrate having a surface characteristic, at least one thin film deposited on the surface characteristic to result in a multi-layer photonic crystal, the multi-layer photonic crystal being adapted to have an induced variation in an index of refraction characteristic and wherein a plurality of the multi-layer photonic crystals are placed in a stack configuration. Further, a material is deposited in-situ using supercritical fluid deposition processes into interstitial gaps formed in the stack configuration. The substrate in a preferred embodiment is spherical in shape.

The foregoing and other features and advantages of the system and method of manufacturing integrated photonic circuit devices will be apparent from the following more particular description of preferred embodiments of the system and method as illustrated in the accompanying drawings in which like reference characters refer to the same parts throughout the different views.

### BRIEF DESCRIPTION OF THE DRAWINGS

FIG. 1 illustrates a substrate coated with a prior art deposition process;

FIG. 2 illustrates the results of a prior art method of sealing interstitial gaps in the substrate layer;

FIG. 3 illustrates another prior art method of sealing interstitial gaps in the substrate layer;

FIG. 4 illustrates a preferred embodiment of a substrate coated with a method of supercritical fluid deposition in accordance with a present invention;

FIG. 5A illustrates preferred embodiment of a guided wave thin film filter in accordance with the present invention;

FIG. 5B is a cross sectional view of a patterned substrate resulting from supercritical fluid deposition nanostructure processing in accordance with a preferred embodiment of the present invention;

FIG. 5C is a cross section of a planar waveguide structure in accordance with a preferred embodiment of the present invention;

FIG. 6 illustrates a preferred multilayer embodiment of photonic crystals in accordance with the present invention;

FIG. 7 illustrates a preferred embodiment of a stack configuration of multilayer photonic crystals in accordance with the present invention;

FIG. 8 illustrates a preferred embodiment of a stack configuration with in-situ deposition in accordance with the present invention;

FIG. 9 is a diagram illustrating a preferred embodiment of an integrated planar and fiber waveguide device in accordance with the present invention;

FIG. 10 illustrates a preferred embodiment of a multilayer lens device in accordance with the present invention;

FIGS. 11A and 11B illustrate preferred embodiments of mode conversion devices in accordance with the present invention;

FIG. 12 is a preferred embodiment of a device having cavities formed by skewed deposition techniques in accordance with the present invention;

FIGS. 13A-13C are preferred embodiments of devices having skewed axis elements such as, for example, a detector and source in accordance with the present invention;

FIG. 14 illustrates a preferred embodiment of a wavelength division multiplexer (WDM) processing circuit in accordance with the present invention;

FIG. 15 is a preferred embodiment of a mode-matching device in accordance with the present invention;

FIG. 16 is a preferred embodiment of a method for manufacturing structured fibers in accordance with the present invention;

FIG. 17 illustrates a preferred embodiment of a device manufactured with thick depositions on device surfaces using supercritical fluid deposition methods in accordance with the present invention;

FIGS. 18A through 18D illustrate a method of stacking two different media through a deposition/etch cycle in accordance with the present invention;

FIG. 19 is a preferred embodiment of an integrated circuit device including partial reflectors, beam splitters and lenses in accordance with the present invention;

FIG. 20 illustrates a Fabry-Perot cavity structure in accordance with a preferred embodiment of the present invention;

FIG. 21 illustrates graphically the transmission spectra of a Fabry-Perot resonant cavity in accordance with a preferred embodiment of the present invention;

FIG. 22 is a top view of a waveguide Fabry-Perot filter using photonic crystal mirrors in accordance with a preferred embodiment of the present invention;

FIG. 23 graphically illustrates the reflectivity of a preferred embodiment photonic crystal Fabry-Perot reflector versus wavelength for both polarizations, transverse electric (TE) mode and transverse magnetic (TM) mode, optimized for C-band operation;

FIG. 24 illustrates a sectional view of a double cavity Fabry-Perot structure in accordance with a preferred embodiment of the present invention;

FIG. 25 graphically illustrates the transmission spectrum in a double cavity Fabry-Perot structure wherein the x axis is expressed in wavelength (nm) in accordance with a preferred embodiment of the present invention;

FIG. 26 graphically illustrates the transmission spectrum in a single cavity Fabry-Perot structure wherein the x axis is expressed in wavelength (nm) in accordance with a preferred embodiment of the present invention;

FIG. 27 is a graphical illustration of the transmission-spectrum for full width at half maximum (FWHM) in a double cavity Fabry-Perot structure, wherein the x axis is expressed as a frequency differential and 25 GHz corresponds to 0.2 nm in accordance with a preferred embodiment of the present invention;

FIG. 28 graphically illustrates a transmission spectrum for FWHM in a single cavity Fabry-Perot structure wherein the x axis is expressed in frequency differential and 25 GHz corresponds to 0.2 nm, in accordance with a preferred embodiment of the present invention;

FIGS. 29A-29C illustrate the relation between electric vectors in successive layers of double or single cavity Fabry-Perot structures, in accordance with preferred embodiments of the present invention;

FIG. 30A is a sectional view of a tunable filter in accordance with a preferred embodiment of the present invention;

FIG. 30B is a graphical illustration of a tuning spectrum for a 25 GHz space dense wavelength division multiplexer (DWDM) by using a direct tuning method in accordance with a preferred embodiment of the present invention wherein λc=1550 nm, Δn=±2×10⁻⁴;

FIG. 31 is a graphical illustration of the numerical comparison between a direct tuning method and a resonant tuning method to account for vernier effects in accordance with preferred embodiments of the present invention;

FIG. 32 graphically illustrates the spectral plots for the refractive index (n) and the absorption coefficient (k) for copper dioxide (Cu₂O) in accordance with a preferred embodiment of the present invention;

FIG. 33 graphically illustrates the spectral plots for the refractive index (n) and absorption coefficient (k) for copper dioxide (CuO) in accordance with a preferred embodiment of the present invention;

FIG. 34 graphically illustrates a portion of the spectral plots for the refractive index (n) and absorption coefficient (k) illustrated in FIG. 33, in particular for a wavelength range of 1 to 2 μm in accordance with a preferred embodiment of the present invention;

FIG. 35 graphically illustrates the spectral plots for the refractive index (n) and absorption coefficients (k) for lead sulphide in accordance with a preferred embodiment of the present invention;

FIG. 36 graphically illustrates the spectral plots for the refractive index (n) and absorption coefficients (k) for titanium dioxide in accordance with a preferred embodiment of the present invention;

FIG. 37 graphically illustrates a portion of the spectral plots for the refractive index (n) and absorption coefficient (k) for the wavelength range of 1-2 μm in accordance with a preferred embodiment of the present invention;

FIG. 38 graphically illustrates the spectral plots for the refractive index (n) and absorption coefficient (k) for zinc selenide (ZnSe) in a preferred embodiment of the present invention;

FIG. 39 graphically illustrates a portion of the spectral plots illustrated in FIG. 38 for the wavelength range of 0.5 to 1.5 μm;

FIG. 40 graphically illustrates the optical properties (n and k) at 1.55 microns for different materials of interest in accordance with preferred embodiments of the present invention;

FIGS. 41A and 41B graphically illustrate the real and imaginary values of the dielectric constants for metals such as gold, copper, silver and aluminum in accordance with preferred embodiments of the present invention;

FIG. 42A is a preferred embodiment of a tunable filter in accordance with the present invention;

FIG. 42B and FIG. 42C are cross-sectional views of the filter illustrated in FIG. 42A in accordance with a preferred embodiment of the present invention;

FIG. 42D is a sectional view and a view along the lines A-A in accordance with the preferred embodiment illustrated in FIG. 42A;

FIGS. 43A and 43B illustrate a preferred embodiment of a tunable filter having two-dimensional photonic crystals and the related directions of propagation, respectively, in accordance with the present invention;

FIGS. 44A and 44B illustrate a three-dimensional photonic crystal tunable filter along with a diagram of the direction of propagation in accordance with a preferred embodiment of the present invention;

FIGS. 45A and 45B illustrate a preferred embodiment of a multicavity tunable filter in accordance with the present invention;

FIG. 45C is a graphical plot of reflectivity versus wavelength for a mirror used in the filter described with respect to FIGS. 45A and 45B;

FIGS. 46A and 46B graphically illustrate the reflectivity in the transverse electric mode and transverse magnetic mode of tunable filter devices in accordance with a preferred embodiment of the present invention;

FIG. 47 is a preferred embodiment of a dual wavelength tunable filter in accordance with the present invention;

FIGS. 48A and 48B illustrate a preferred embodiment of an optical add/drop multiplexer device and the directions of propagation respectively in accordance with the present invention;

FIGS. 49A and 49B illustrate a preferred embodiment of an optical add/drop multiplexer using a three-dimensional photonic crystal tunable filter and the related spectrum respectively in accordance with the present invention;

FIG. 49C is a view of a three-dimensional photonic crystal structure realized by a lithographic pattern and exemplary angle-controlling etching methods in accordance with the present invention;

FIG. 49D is a cross-sectional view of elements in a three-dimensional photonic crystal structure realized by a lithographic pattern and exemplary wet-dry mixed etching technologies in accordance with a preferred embodiment of the present invention;

FIG. 50 illustrates a dynamic four port optical add/drop multiplexer in accordance with a preferred embodiment of the present invention;

FIG. 51 illustrates a multi-port wavelength router in accordance with a preferred embodiment of the present invention;

FIGS. 52A and 52B graphically illustrate the levels of cross talk in a single-cavity filter and a multi-cavity device in accordance with preferred embodiments of the present invention;

FIG. 53A illustrates a multi-functional device including at least an optical add/drop multiplexer, and an optical monitor in accordance with a preferred embodiment of the present invention;

FIG. 53B is a schematic view for a 2×2 wavelength router with a tap mirror in accordance with a preferred embodiment of the present invention;

FIG. 54A illustrates a schematic of an integrated photonic crystal device having zero-radius waveguide bends in accordance with a preferred embodiment of the present invention;

FIG. 54B graphically illustrates the reflectivity versus the wavelength for the photonic crystal reflectors in the device illustrated in FIG. 54A.

FIG. 55 is a preferred embodiment of a variable optical attenuation spectral equalizer array in accordance with the present invention;

FIG. 56 is a cross-sectional view of the spectral equalizer array illustrated with respect to the preferred embodiment in accordance with the present invention in FIG. 55;

FIGS. 57A and 57B graphically illustrate the spectrums at the input port and the output port of the preferred embodiment illustrated in FIG. 55;

FIG. 58 illustrates a preferred embodiment of a resonant coupled waveguide structure in accordance with the present invention;

FIG. 59 illustrates a schematic view of an asymmetric Fabry-Perot cavity (Gires-Tournois etalon) in accordance with a preferred embodiment of the present invention;

FIG. 60 graphically illustrates the phase of the reflection of the light beam versus wavelength at R=0.9 and d=20 λc/n in accordance with a preferred embodiment of the present invention;

FIG. 61 graphically illustrates the group velocity dispersions (ps/GHz) in the reflected light versus wavelength for R=0.95 and R=0.9 in accordance with a preferred embodiment of the present invention; and

FIG. 62 graphically illustrates the group velocity dispersion compensation (ps/nm) tuning in the reflected light beams versus wavelength in accordance with a preferred embodiment of the present invention.

The drawings are not necessarily to scale, emphasis instead being placed upon illustrating the principles of the invention.

### DETAILED DESCRIPTION OF THE INVENTION

The system and methods of the present invention are directed to manufacturing integrated photonic circuit devices. Preferred embodiments of the devices in accordance with the present invention are manufactured using chemical fluid deposition processes and in particular embodiments employing supercritical fluid deposition processes.

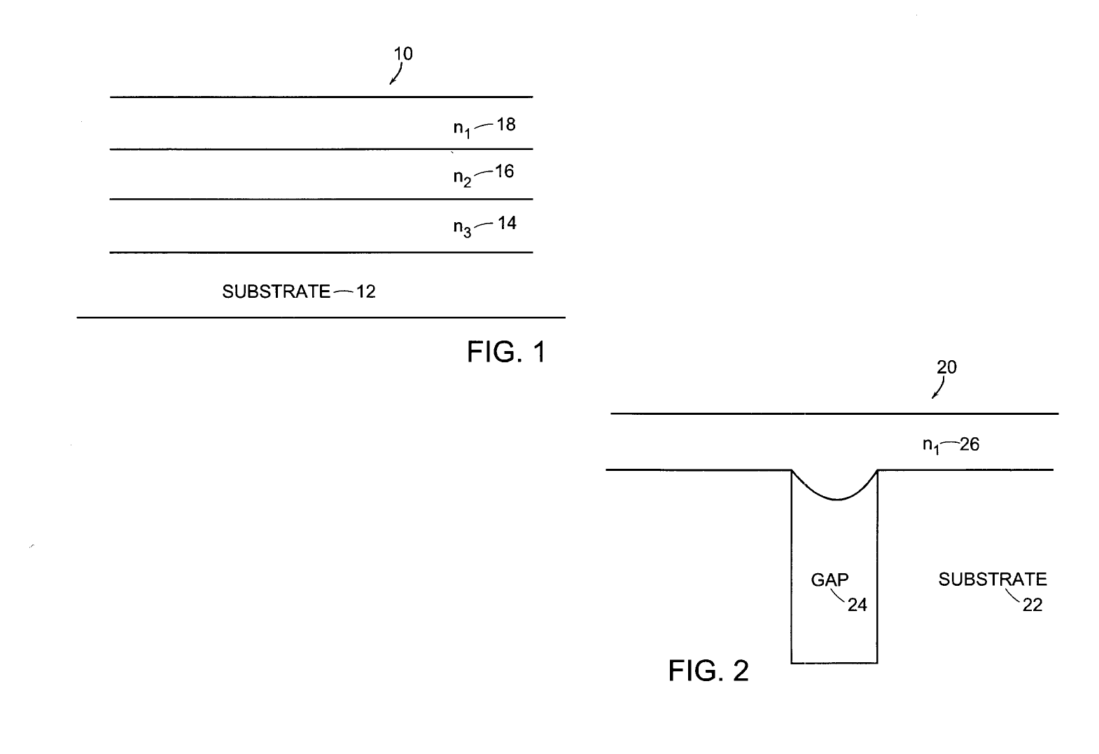

Supercritical fluid deposition (SFD) is a surface wetting deposition process that applies a uniform conformal coating. SFD enables the fabrication of two-dimensional and three-dimensional photonic crystal structures, materials and devices. SFD further enables the layering of materials in directions skewed relative to the deposition surface normal. Critical photonic devices such as, for example, but not limited to, spectral filters, mode and polarization matching filters, wave formers and cavity mirrors include layered media. Conventional deposition processes produce layers that fill interstitial gaps according to, for example, surface tension constraints. The conventional deposition processes struggle with having sufficient quantities of reactants and/or control of conditions under which reactions occur only on the surfaces and tend to minimize deposition layer bends. FIG. 1 illustrates a substrate coated with a conventional prior art deposition process. The layers 14, 16, 18, having different indices of refraction n₁, n₂ and n₃, respectively, are deposited over a substrate 12.

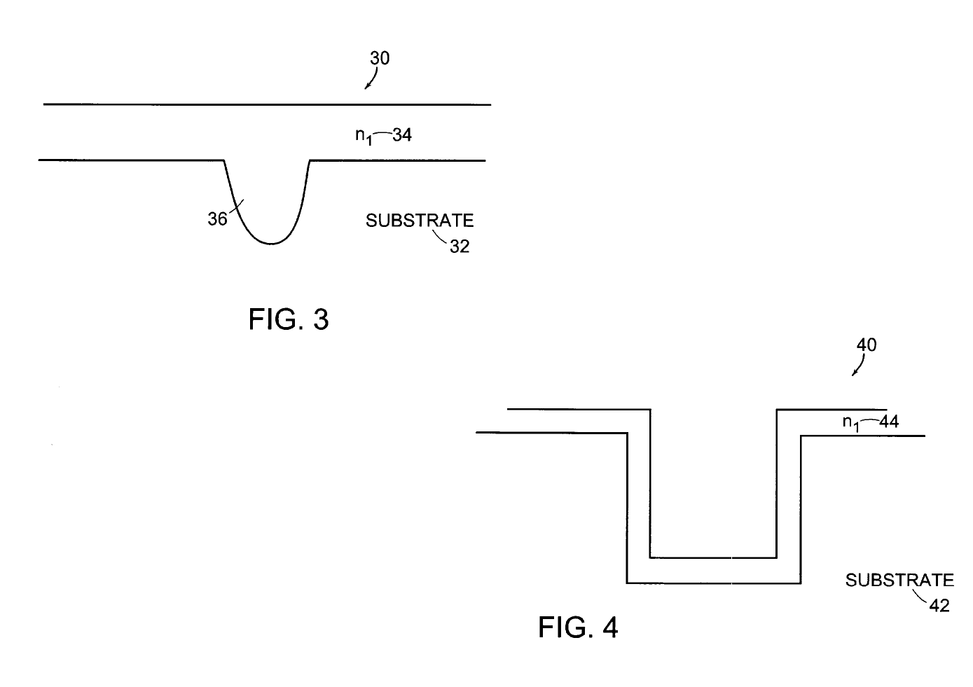

FIG. 2 illustrates the results of a prior art method of sealing interstitial gaps in the substrate layer. Gaps such as gap 24, in the substrate layer 22 are sealed by prior art deposition techniques. FIG. 3 illustrates another prior art method of sealing interstitial gaps. The gap 36 is filled with a fluid. In contrast, the SFD process conformally coats surface bends and distortions as illustrated in FIG. 4 which illustrates a preferred embodiment of a coated substrate 42 in accordance with the present invention. The coating layer 44 has a particular index of refraction and is conformally applied over the substrate.

Chemical, or SFD methods as described in U.S. Pat. No. 5,789,027 issued on Aug. 4, 1998 to Watkins et al., entitled “Method of Chemically Depositing Material Onto A Substrate,” and in International publication WO 01/32951 A2, having an application number PCT/US00/30264 filed on Nov. 2, 2000 by Watkins et al., entitled “Chemical Fluid Deposition for the Formation of Metal and Metal Alloy Films on Patterned and Unpatterned Substrates”, the entire teachings of both being incorporated herein by reference, are used in preferred embodiments of the methods of the present invention.

A method for depositing a material onto a substrate surface or into a porous solid is referred to herein as chemical fluid deposition (CFD) or SFD. CFD involves dissolving a precursor of the material into a solvent under supercritical or near-supercritical conditions and exposing the substrate (or porous solid) to the solution. A reaction reagent is then mixed into the solution and the reaction reagent initiates a chemical reaction involving the precursor, thereby depositing the material onto the substrate surface (or within the porous solid). Use of a supercritical solvent in conjunction with a reaction reagent produces high purity thin films at temperatures that are much lower than conventional Chemical Vapor Deposition (CVD) temperatures.

Preferred embodiments of the present invention include a method for depositing a film of a material, for example, without limitation, a metal, mixture of metals, metal dioxide, metal sulfide, insulator, polymer or monomers which can be subsequently cross-linked to form a polymer, or semiconductor, onto the surface of a substrate, for example, a silicon wafer or preprocessed silicon wafer, as containing a patterned silicon dioxide surface, by dissolving a precursor of the material into a solvent, for example, carbon dioxide, under supercritical or near-supercritical conditions to form a supercritical or near-supercritical solution; exposing the substrate to the solution under conditions at which the precursor is stable in the solution; and mixing a reaction reagent, for example, hydrogen, into solution under conditions that initiate a chemical reaction involving the precursor, for example, but not limited to, a reduction, oxidation, decomposition or hydrolysis reaction, thereby depositing the material onto the surface of the substrate, while maintaining supercritical or near-supercritical conditions.

For example, the method for supercritical fluid deposition can be conducted so that the temperature of the substrate is maintained at no more than approximately 200° C, 225° C., 275° C. or 300° C. The solvent has a reduced temperature between 0.8 and 2.0, the solvent has a density of at least 0.1 g/cm³, the solvent has a density of at least one third of its critical density, or the solvent has a critical temperature of less than 150° C. In addition, preferred embodiments of the method in accordance with the present invention can be carried out so that the temperature of the substrate measured in Kelvin is less than twice the critical temperature of the solvent measured in Kelvin, or so that the temperature of the substrate measured in Kelvin divided by the average temperature of the supercritical solution measured in Kelvin is between 0.8 and 1.7. A preferred embodiment of the method of SFD can also be conducted such that the average temperature of the supercritical solution is different from the temperature of the substrate.

In another preferred embodiment of the present invention, a method for depositing material within a microporous or nanoporous solid substrate, includes dissolving a precursor of the material into a solvent under supercritical or near-supercritical conditions to form a supercritical or near-supercritical solution; ii) exposing the solid substrate to the solution under conditions at which the precursor is stable in the solution; and iii) mixing a reaction reagent into the solution under conditions that initiate a chemical reaction involving the precursor, thereby depositing the material within the solid substrate while maintaining supercritical or near-supercritical conditions. A preferred embodiment of the method can be conducted such that the temperature of the solid substrate is maintained at no more than approximately 200° C.

In another preferred embodiment of the present invention, a film of a material, for example, but without limitation, a metal, a metal dioxide, a polymer or semiconductor, on a substrate, the coated substrate itself, and microporous or nanoporous solid substrates have such materials deposited on and within them.

Further, preferred embodiments include methods for depositing a material, for example, a thin film of a pure metal, a mixed metal, a metal dioxide, semiconductor, a polymer or a metal alloy, or a layer, for example, a discontinuous layer of discrete uniformly distributed clusters, onto a substrate surface or into a porous solid substrate. The substrate surface can include one or more layers, which may be patterned. When patterned substrates are used, for example, having deep sub-micron, high-aspect ratio features such as, but not limited to, trenches or cylinders, SFD can provide uniform conformal coverage and uniform filling of the features.

Preferred embodiments of the present invention include a two-step process that involves the deposition of a catalytic seed layer, for example, of palladium, platinum, or copper, by SFD, followed by plating, for example, electrolyses or electrolytic plating, or additional SFD, of more of the same metal or another metal or alloy. The seed layer need not be continuous, i.e., the seed layer can be made of clusters of deposited material, but the isolated catalytic seed clusters are distributed uniformly in any patterns, for example, trenches or invaginations, in the surface of the substrate. The surface can be functionalized prior to deposition using coupling agents, for example, chlorotrimethoxysilane, for example, to control the concentration and location of the seed layer deposit.

In another two-step process, a seed layer and a thin film is created simultaneously by a first thermal disproportionation step using a precursor such as copper, for example, Cu(I) followed by the addition of a reaction reagent such as H₂ to reduce the products of the disproportionation reaction in a CFD method to obtain high yield deposition of the precursor onto a substrate.

The substrate can be a patterned substrate, formed using processes such as photolithography which are used similar to one used in the microelectronics industry. The patterned substrate can have submicron features which may have an aspect ratio greater than about two. Preferably the aspect ratios are in the range of approximately 20 to 30. The material can be deposited to conformally cover the features. The features may be at angles other than an angle normal to the surface. In one embodiment, the substrate is a patterned silicon wafer and the material is palladium or a palladium alloy that conformally covers the patterned features. In another embodiment, the substrate is a patterned silicon wafer and the material is copper or a copper alloy that conformally covers or fills the patterned features.

In another aspect, a preferred embodiment of the present invention features an integrated circuit including a patterned substrate having submicron features and a film including palladium or copper conformally covering the features. The aspect ratio of the patterned features can be greater than about two and preferably in the range of 20 to 30.

As used herein, a “supercritical solution” (or solvent) is one in which the temperature and pressure of the solution (or solvent) are greater than the respective critical temperature and pressure of the solution (or solvent). A supercritical condition for a particular solution (or solvent) refers to a condition in which the temperature and pressure are both respectively greater than the critical temperature and critical pressure of the particular solution (or solvent). A “near-supercritical solution” (or solvent) is one in which the reduced temperature (actual temperature measured in Kelvin divided by the critical temperature of the solution (or solvent) measured in Kelvin) and reduced pressure (actual pressure divided by critical pressure of the solution (or solvent)) of the solution (or solvent) are both greater than 0.8 but the solution (or solvent) is not a supercritical solution. A near-supercritical condition for a particular solution (or solvent) refers to a condition in which the reduced temperature and reduced pressure are both respectively greater than 0.8 but the condition is not supercritical. Under ambient conditions, the solvent can be a gas or liquid. The term solvent is also meant to include a mixture of two or more different individual solvents. The “aspect ratio” of a feature on a patterned substrate is the ratio of the depth of the feature and the width of the feature.

Preferred embodiments of the present invention include a number of advantages, including the use of process temperatures that are much lower than conventional chemical vapor deposition (CVD) temperatures. A reduction in process temperature is advantageous in several respects: it aids in the control of depositions, minimizes residual stress generated by thermal cycling in multi-step device fabrication that can lead to optical artifacts, such as changing the refractive index, and/or thermal-mechanical failure, minimizes diffusion and reaction of the incipient film with the substrates, renders the deposition process compatible with thermally labile substrates such as polymers, and suppresses thermally-activated side-reactions such as, for example, thermal fragmentation of precursor ligands that can lead to film contamination. Thus, the films produced by the processes and methods in accordance with preferred embodiments of the present invention are substantially free of impurities.

An additional advantage of the preferred embodiments of the present invention is that they obviate the CVD requirement of precursor volatility since the processes are performed in solution. Furthermore, since the process is performed under supercritical or near-supercritical conditions, the diffusivity of precursors dissolved in solution is increased relative to liquid solutions, thereby enhancing transport of precursor and reaction reagent to and decomposition products away from the incipient film. The supercritical fluid is also a good solvent for ligand-derived decomposition products, and thus facilitates removal of potential film impurities and increases the rate at which material forms on the substrate in cases where this rate is limited by the desorption of precursor decomposition products. In addition, since the reactants are dissolved into solution, precise control of stoichiometry is possible.

Another advantage of the preferred embodiments of the present invention is that the supercritical solution is usually miscible with gas phase reaction reagents such as hydrogen. As a result, gas/liquid mass transfer limitations common to reactions in liquid solvents are eliminated, and so excess quantities of the reaction reagent can easily be used in the reaction forming the material.

Thus, the techniques produce high quality metal, metal dioxide, polymers, semiconductor and metal alloy deposits of precisely tailored composition in the form of thin films, conformal coatings on topologically complex surfaces, uniform deposits within high aspect ratio features, and both continuous and discrete deposits within microporous supports. Moreover, the absence of surface tension inherent to supercritical solutions ensures complete wetting of tortuous surfaces.

Using chemical fluid deposition (CFD) which may be defined as a chemical reaction of soluble precursors, desired materials can be deposited on a substrate, such as a silicon wafer, to form a high-purity (for example, better than 99%) thin film (for example, less than 5 microns). The supercritical fluid transports the precursor to the substrate surface where the reaction takes place and transports ligand-derived decomposition products away from the substrate thereby removing potential film impurities. Typically, the precursor is unreactive by itself and a reaction reagent (for example, a reducing or oxidizing agent) is mixed into the supercritical solution to initiate the reaction which forms the desired materials. The entire process takes place in solution under supercritical conditions. The process provides high-purity films at various process temperatures under 250° C., (for example, below 200° C., 150° C., 100° C., 80° C., 60° C., or 40° C.), depending on the precursors, solvents, and process pressure used.

SFD can be used, for example, to deposit platinum (Pt) and palladium (Pd) films onto silicon wafers or fluoropolymer substrates. In these examples, process temperatures of as low as 80° C. provide a film purity that can be better than 99%. SFD can also be used to deposit materials into mesoporous or microporous inorganic or polymer solids. Examples include the metallation of nanometer-size pores in catalyst supports such as silicalites and amorphous mesoporous aluminosilicate molecular sieves. Supercritical fluids have gas-like transport properties (for example, low. viscosity and absence of surface tension) that ensure rapid penetration of the pores. Uniform deposition throughout the pores is further facilitated by independent control of the transport (via solution) and deposition (via reaction reagent) mechanisms in SFD. By contrast, metallation of porous substrates by CVD often results in choking of the pores by rapid deposition at the pore mouth resulting from high process temperatures.

A preferred embodiment of a method of the present invention includes a batch SFD run which involves the following general procedure. A single substrate and a known mass of precursor are placed in a reaction vessel (for example, a stainless steel pipe), which is sealed, purged with solvent, weighed and immersed in a circulating controlled temperature bath. The vessel is then filled with solvent using a high pressure manifold. The contents of the reactor are mixed using a vortex mixer and conditions are brought to a specified temperature and pressure at which the solvent is a supercritical or near-supercritical solvent. The mass of solvent transferred into the reaction vessel is determined gravimetrically using standard techniques. The vessel is maintained at this condition (at which the precursor is unreactive) for a period of time, for example, up to one hour or longer, sufficient to ensure that the precursor has completely dissolved and that the reaction vessel is in thermal equilibrium.

A reaction reagent is then transferred through a manifold connected to the reaction vessel. The reaction reagent can be a gas or a liquid, or a gas, liquid, or solid dissolved in a supercritical solvent. The transfer manifold is maintained at a pressure in excess of that of the reaction vessel. The mass of reaction reagent transferred into the reaction vessel is usually in molar excess relative to the precursor. The reaction is typically carried out for at least one hour, though the reaction may be complete at times much less than one hour, for example, less than 20 minutes or less than 30 seconds. The optimal length of reaction time can be determined empirically. When the reactor has cooled, the substrate is removed and can be analyzed.

A continuous SFD process is similar to the above batch method except that known concentrations of the supercritical (or near-supercritical) solution and reaction reagent are taken from separate reservoirs and continuously added to a reaction vessel containing multiple substrates as supercritical solution containing precursor decomposition products or unused reactants is continuously removed from the reaction vessel. The flow rates into and out of the reaction vessel are made equal so that the pressure within the reaction vessel remains substantially constant. The overall flow rate is optimized according to the particular reaction. Prior to introducing precursor-containing solution into the reaction vessel, the reaction vessel is filled with neat solvent (which is the same as the solvent in the precursor solution) at supercritical or near-supercritical pressures and is heated to supercritical or near-supercritical temperatures. As a result, supercritical or near-supercritical conditions are maintained as the precursor-containing solution is initially added to the reaction vessel.

Alternate preferred embodiments include deposition processes other than SFD such as, for example, but not limited to, CVD, and/or electroplating and atomic layer deposition. Alternate embodiments may include post deposition treatments to optimize optical properties of photonic crystal devices. Such post processing treatments may include, but are not limited to, annealing, heat treatment, and chemical treatment. In particular the properties such as the refractive index (n) and the absorption coefficient (k) may be optimized for the photonic materials used in the devices.

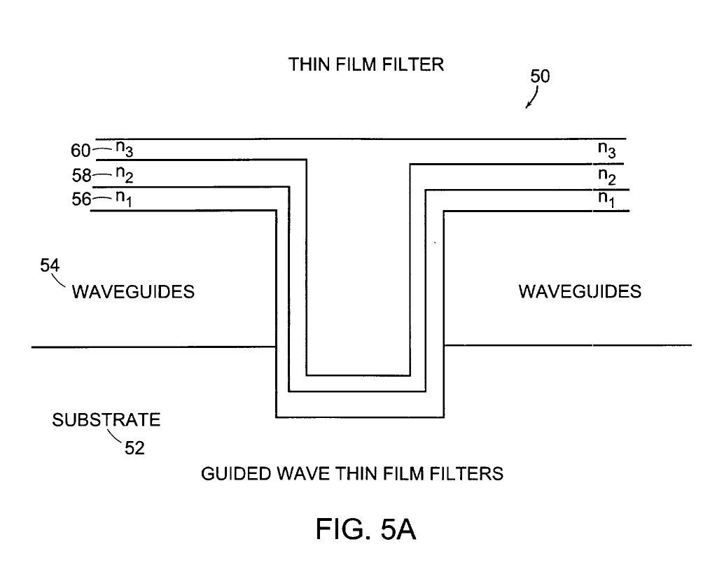

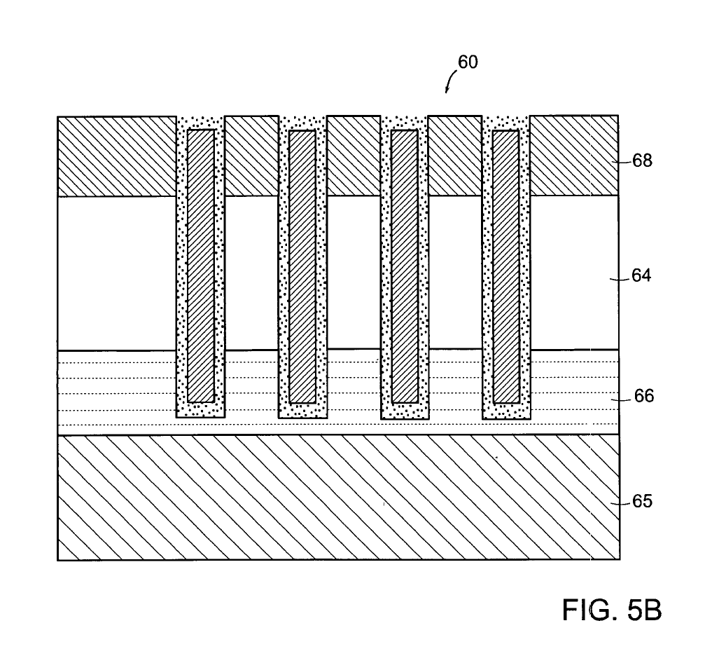

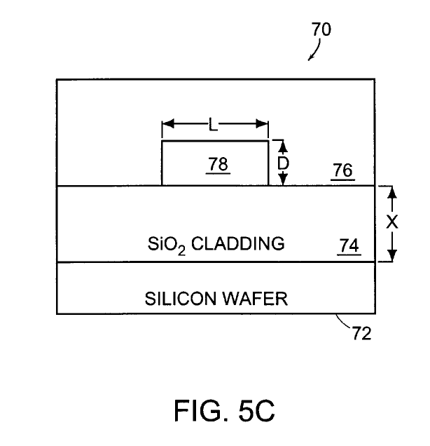

Multilayer deposition with SFD enables devices as illustrated in FIG. 5A which is a preferred embodiment of a thin film filter having a waveguide in accordance with the present invention. A waveguide 54 is disposed on a substrate 52. Thin films having different indices of refraction n₁, n₂, and n₃ are deposited on the waveguide.

FIG. 5B is a cross-sectional view of a patterned substrate resulting from supercritical fluid deposition (SFD) nanostructure processing in accordance with the present invention. The integrated waveguide includes photonic crystals in accordance with the present invention. The integrated device is manufactured by disposing a high refractive index material within a relatively low refractive index material. The device includes a waveguide having dimensions for maximizing fiber coupling. Fiber optic single mode propagation is maximized by using dimensions such as, for example, 6×6 μm². Thus, coupling losses and propagation losses are minimized and preferably eliminated due to low transmission in transverse area. Further, the integrated devices in accordance with the present invention are polarization independent. The fibers, and in particular, the cross-section of fibers may be aligned or coupled to the cross-section of the waveguides and attached using index matching adhesives in a preferred embodiment of the present invention. In an alternate embodiment the fibers may be coupled to the waveguides using a lens system.

The cladding 66 disposed over the substrate 65 has a low refractive index (n₀) and a thickness of approximately 20μ. The waveguide layer 64 has a thickness of approximately 6 microns. The second layer of cladding 68 has a thickness of approximately 2 to 4 microns. An etching process etches holes approximately in a range of 10 to 20 microns. The diameter of the holes etched is typically in the range of between approximately 0.1 to 1.5 microns, and is preferably 0.7 microns. The preferable spacing between the holes is typically 1.03 microns.

It should be noted that the simplest photonic crystal is a one-dimensional system and consists of alternating layers of material with different dielectric constants. This photonic crystal can act as a perfect mirror for light with a frequency within a sharply defined gap, and can localize light modes if there are any defects in its structure. This arrangement is used in dielectric mirrors and optical filters. A two-dimensional photonic crystal is periodic along two of its axes and homogenous along the third axis. A square lattice of dielectric columns is an example of a two-dimensional photonic crystal. For certain values of the column spacing, the crystal can have a photonic band gap in the XY plane, for example. Inside this gap, no extended states are permitted and incident light is reflected. But although the multilayer film (one-dimensional photonic crystal) only reflects light at normal incidence, this two-dimensional photonic crystal can reflect light incident from any direction in the plane. Further, a three-dimensional photonic crystal is a dielectric that is periodic along three different axes.

Conventional optical systems are limited to longitudinal designs with a well-defined optical axis or to waveguide designs in one-dimension (fiber) or two-dimensions (integrated optical). In preferred embodiments, SFD enables optical devices which combine longitudinal and waveguide components.

FIG. 5C is a cross-sectional view of a planar waveguide structure. The silicon wafer 72 has disposed over it a silicon dioxide cladding 74 having a thickness within the range of 20-40 microns. The refractive index of the cladding 74 layer is n₁. The cladding layer 74 is blanketed with a dopant such as germanium. A material having a refractive index of n₂ which is greater than refractive index n₁ of the cladding is then patterned into the waveguide. The difference between the refractive indices in a preferred embodiment is approximately 0.01 to 0.02.

As described hereinbefore, conventional photonic crystal designs are constructed of periodic arrays of two materials, such as air and semiconductor. SFD deposition enables the generation of multilayer “photonic atoms”. In an alternate embodiment, a photonic crystal configuration includes a stack of multilayer spheres formed using SFD deposition techniques. In a particular embodiment, the spheres are formed by a conventional CVD multilayer deposition process.

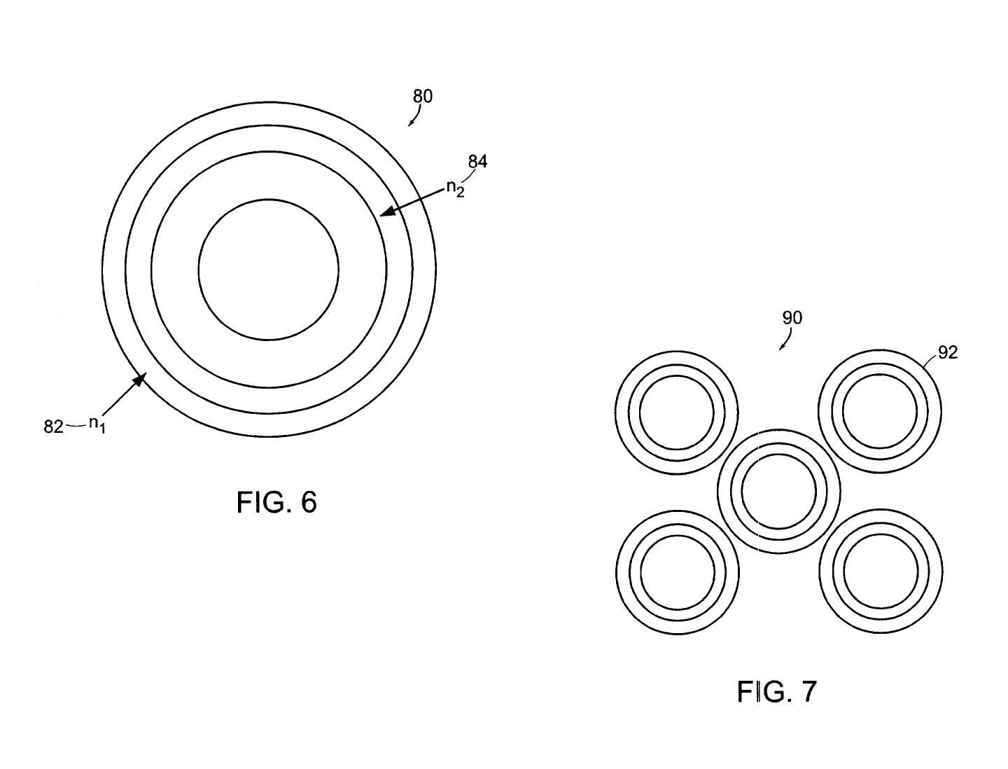

FIG. 6 illustrates a preferred multilayer embodiment of photonic crystals in accordance with the present invention. A multilayer sphere 80 is formed by the deposition of a plurality of materials having different indices of refraction n₁ 82 and n₂ 84 on a substrate.

FIG. 7 illustrates a preferred embodiment of a stack configuration of multilayer photonic crystals in accordance with the present invention. A stack 90 configuration includes a plurality of the multilayer spheres 92.

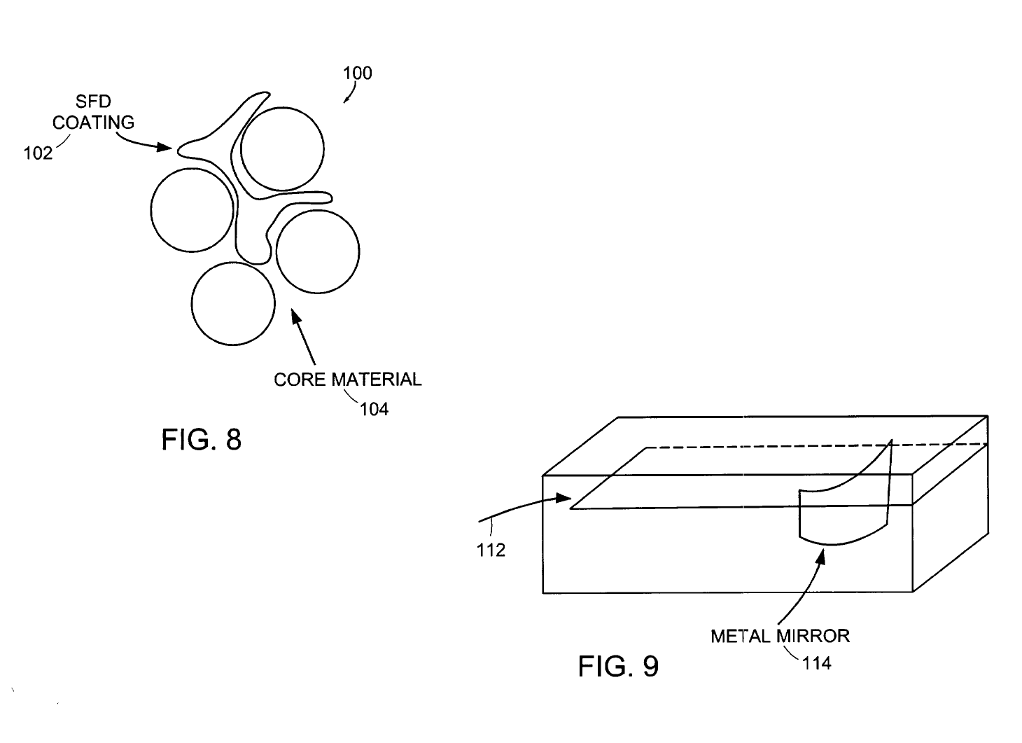

FIG. 8 illustrates a preferred embodiment of a stack configuration 100 with in-situ deposition in accordance with the present invention. SFD deposition enables a different class of atoms combining stacking with in situ deposition as described herein. The core material 104 such as the multilayer spheres described with respect to the previous embodiments is arranged in a stack configuration. The interstitial gaps created during the stacking of the multilayer spheres are then filled with a coating 102 using SFD. The ability of SFD to internally coat a material enables three-dimensional photonic crystal growth. In one embodiment, the core material is etched out, for example, as it may be, but is not limited to, water soluble. A three-dimensional semiconductor photonic crystal is created by coating the semiconductor on a polymer bead matrix and then removing, for example, by washing the bead matrix out. Alternatively, a silica bead matrix may be used which is removed after a hydrofluoric acid etch process.

FIG. 9 is a diagram illustrating a preferred embodiment of an integrated thin film component, in particular an integrated planar and fiber waveguide device 110 in accordance with the present invention. The embodiments of the present invention provide the ability to integrate longitudinal devices and materials with planar and fiber waveguide devices as discussed hereinbefore. A reflector, for example, metal mirror 114 is coupled with a waveguide 112 to provide an integrated photonic circuit.

This ability to create optical elements transverse to the waveguide plane by high aspect ratio deposition enables the integration of layered devices, electro-optic modulators, metal optical elements and liquid crystal modulators with planar components. Preferred embodiments of the present invention optical systems include lens and mirror based systems. It should be noted that any conventional optical system can be replicated in accordance with the present invention systems and methods in planar systems by this technology.

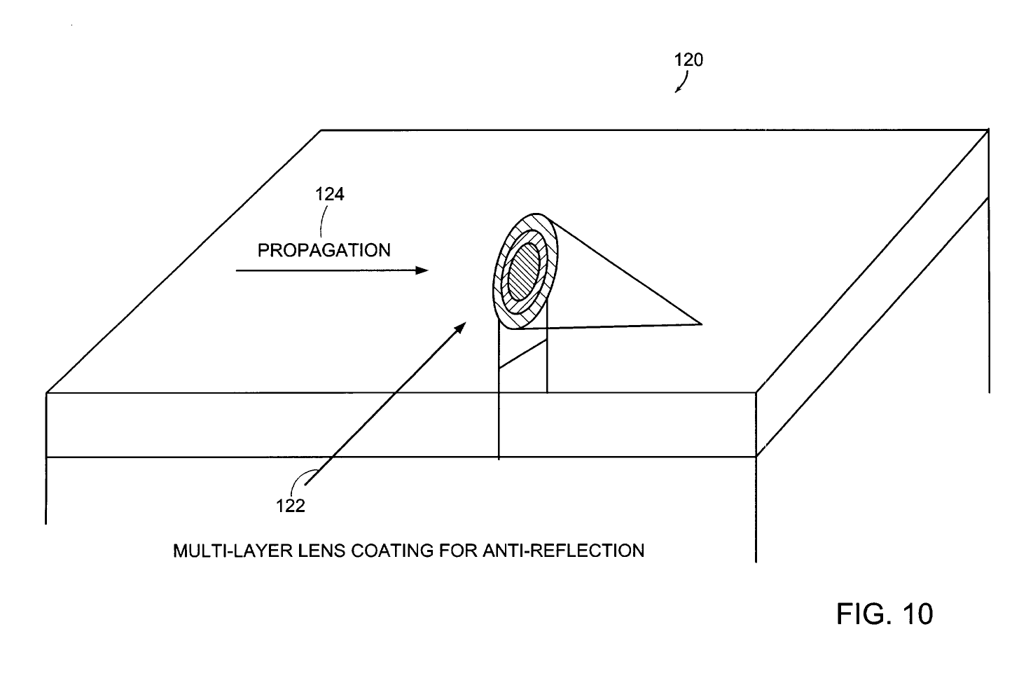

FIG. 10 illustrates a preferred embodiment of another thin film component in particular an embedded multilayer lens device in accordance with the present invention. A multilayer lens 122 is embedded in the device 124. The multilayer lens may be coated for anti-reflection. The direction of propagation of light is perpendicular to the lens surface. In preferred embodiments at least two classes of lenses are included: cylindrical lenses are created by etching and alternatively filling a lens-shaped hole in a planar structure.

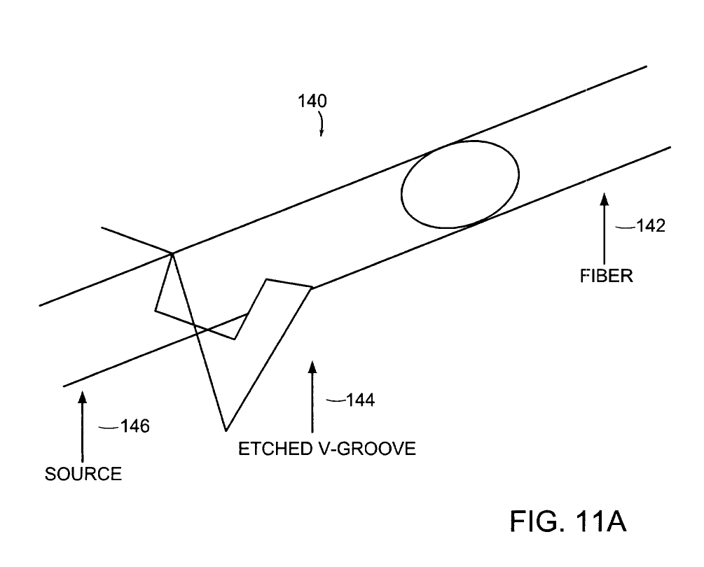

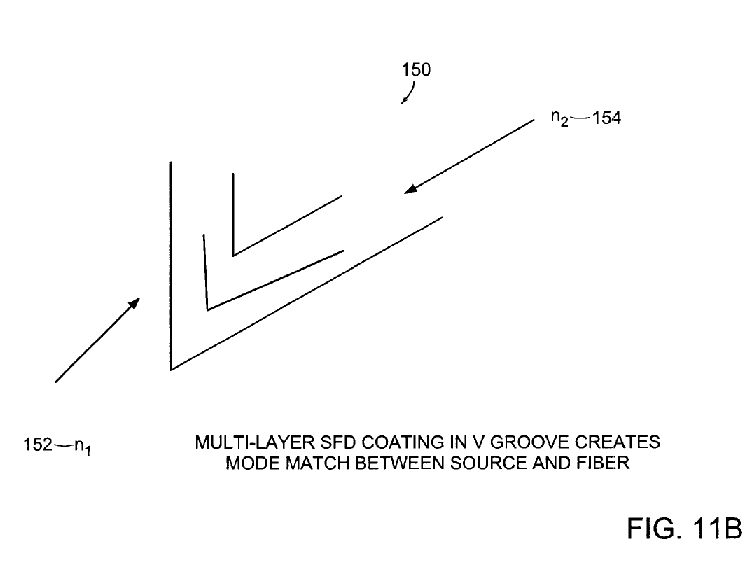

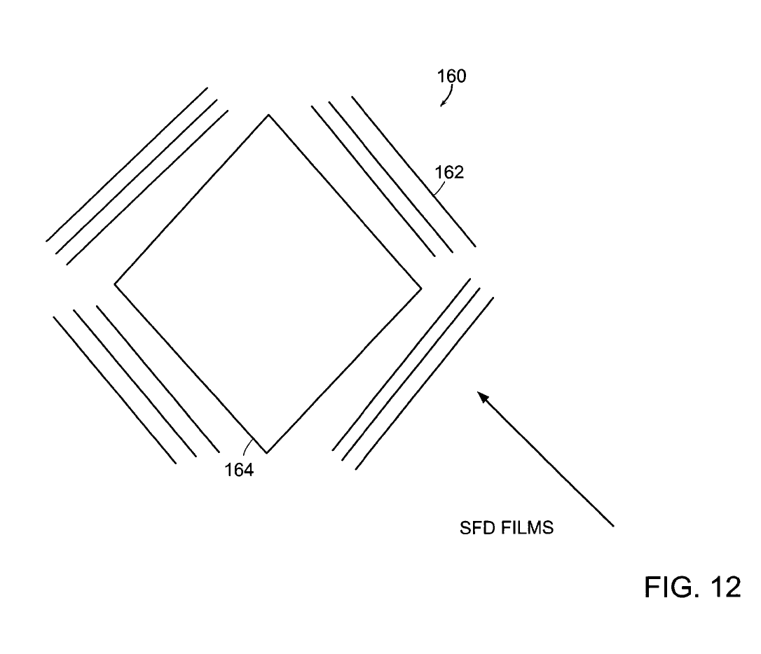

FIGS. 11A and 11B illustrate preferred embodiments of alternate thin film components, in particular mode conversion devices in accordance with the present invention. A longitudinal lens is created for mode conversion by deposition of materials on heterogeneous coupled devices. Multilayer SFD coating such as, for example, of materials having different refractive indices (n₁) 152, (n₂) 154 create mode matching between the source 146 and the fiber 142.

Preferred embodiments of the present invention include SFD deposition on skewed and curved surfaces. SFD conformal coating of bulk optical components is of great interest for conventional optical applications. FIG. 12 is a preferred embodiment of a device 160 having cavities formed by skewed deposition techniques in accordance with the present invention. One such cavity 164 is formed by skewed deposition. Skewed surface deposition also enables new classes of devices, including coupled cavity switches and memories. Preferred embodiments of the present invention include arbitrary three-dimensional structures for field processing. Processing is particularly strong with cavities. SFD enables compact devices to enhance both electrical non-linearities, by making gap sizes smaller and effective fields bigger, and optical non-linearities by focusing fields.

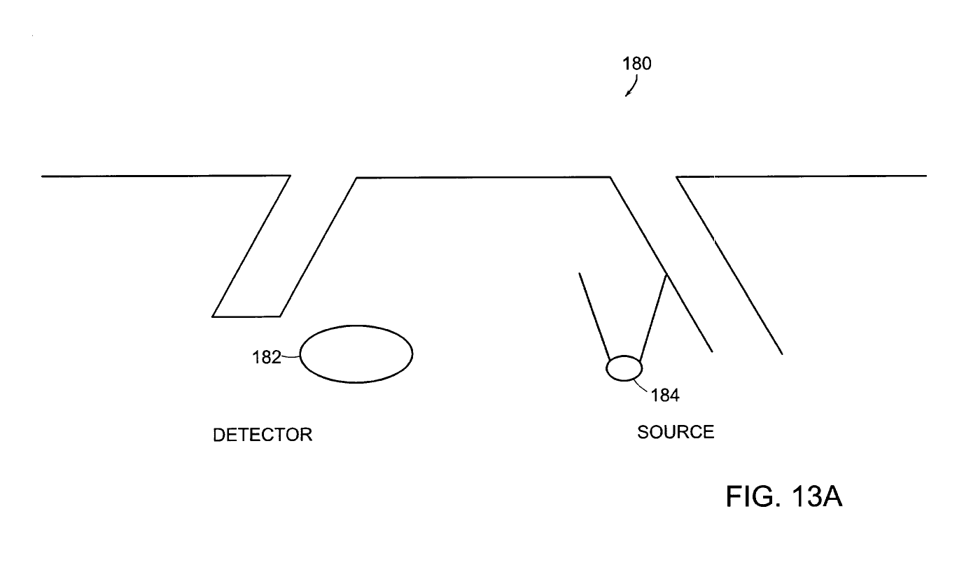

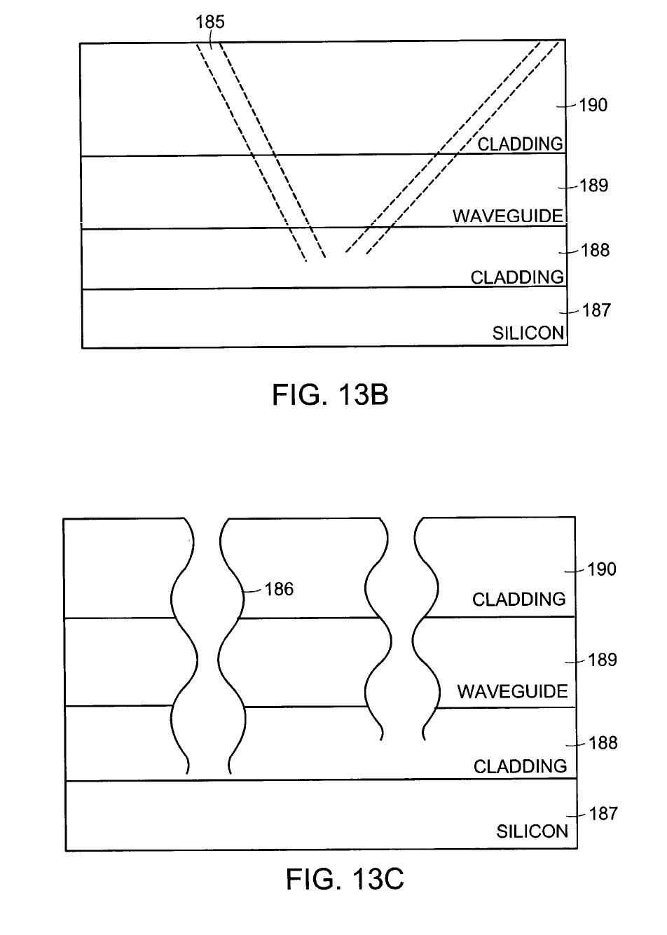

FIG. 13A is a preferred embodiment of a device 180 having skewed axis elements such as, for example, a detector 182 and a source 184 in accordance with the present invention. The skewed elements might be formed by stacking in accordance with a preferred embodiment of the present invention. The skewed axis elements in a preferred embodiment may also be formed by projecting three dimensional structures such as holes 185 at an angle as depicted in FIG. 13B. Further, by using processes such as etching, a skewed element 186 maybe disposed in an integrated photonic crystal device as shown in FIG. 13C. Etching methods that combine Chemical Amplifying of Resist Lines (CARL™) lithography, Inductive Coupled Plasma (ICP) for dry development and high density plasma etching may be used to fabricate holes in the order of approximately 30 nm and trenches in the order of approximately 25 nm in dioxides with aspect ratios of up to 30:1 in accordance with preferred embodiments of the present invention. Such methods are described in a paper entitled “Fabrication of Sub-0.1 μm contacts with 193 nm CARL™ photolithography by a combination of ICP dry development and MØRI™ HDP dioxide etch,” by Y. P. Song et al. as presented at The Electrochemical Society Conference, Hawaii, 1999, the entire contents of which being incorporated herein by reference.

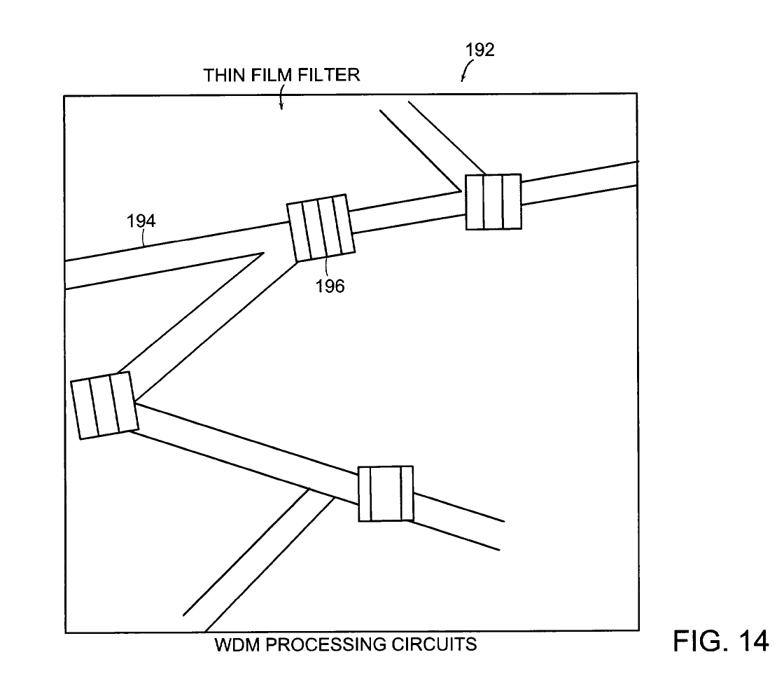

FIG. 14 illustrates a preferred embodiment of a wavelength division multiplexer (WDM) processing circuit 192 in accordance with the present invention. Integrated transverse thin film filter systems enables two-dimensional WDM processing circuits. These circuits incorporate three or more port devices. The waveguide 194 is coupled to, for example, a thin film filter 196. Such devices may incorporate mode matching components into thin film filters using curved surface deposition.

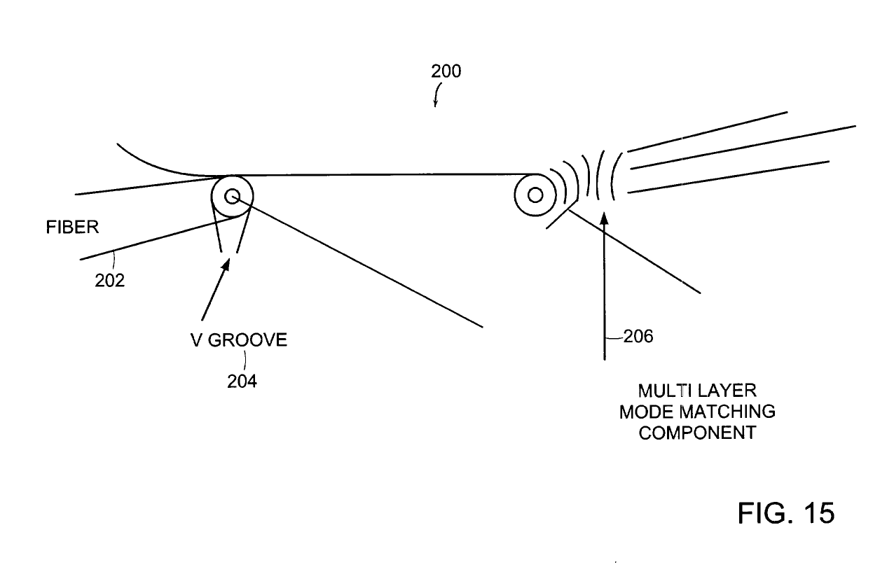

FIG. 15 is a preferred embodiment of another integrated thin film component, in particular a mode-matching device 200 in accordance with the present invention. Mode matching may be particularly significant in automated fiber coupling to two-dimensional circuits. In a preferred embodiment of the method of manufacturing photonic integrated circuits, mode matching may be selected to use both SFD and conventional deposition and etching processes. Skewed multilayer deposition may also be significant in optical switching by enabling both non-linear and electro-optic switching material integration and by enabling propagating field concentration in switching layers.

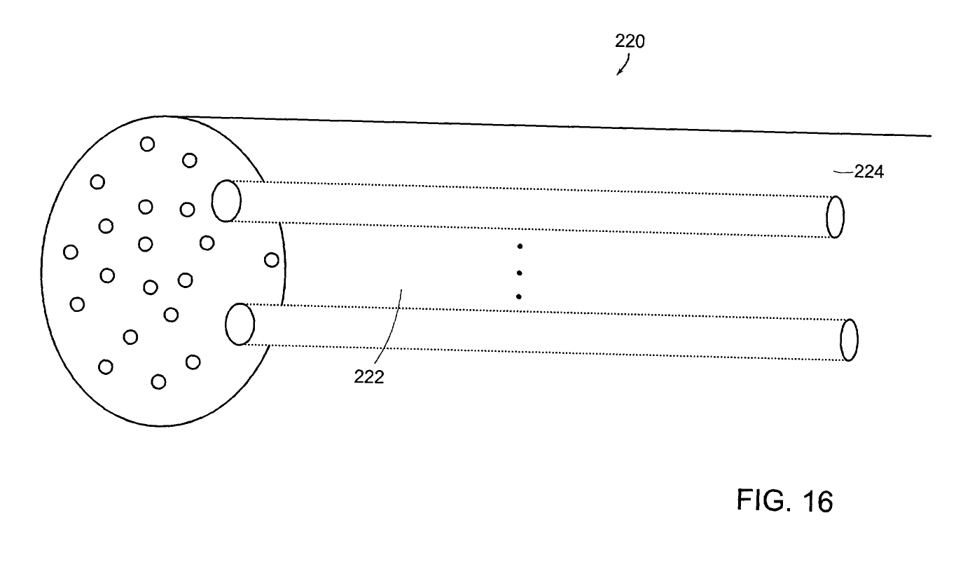

FIG. 16 is a preferred embodiment of a method for manufacturing structured fibers 222 in accordance with systems of the present invention. Thus, SFD is used for fabrication of waveguides with “holes.” Waveguides with complex transverse structures such as, for example, holes and trenches enables design of dispersion and polarization properties. SFD can be applied in fiber pulling processes to create structured fibers.

SFD can also be used to locally fill holes in a holey fiber for switch and/or laser fabrication. In a preferred embodiment, combinations of SFD and pulling create novel fibers. Further, in a particular embodiment, SFD is used to fill fiber cores after preferential core-specific etch processes.

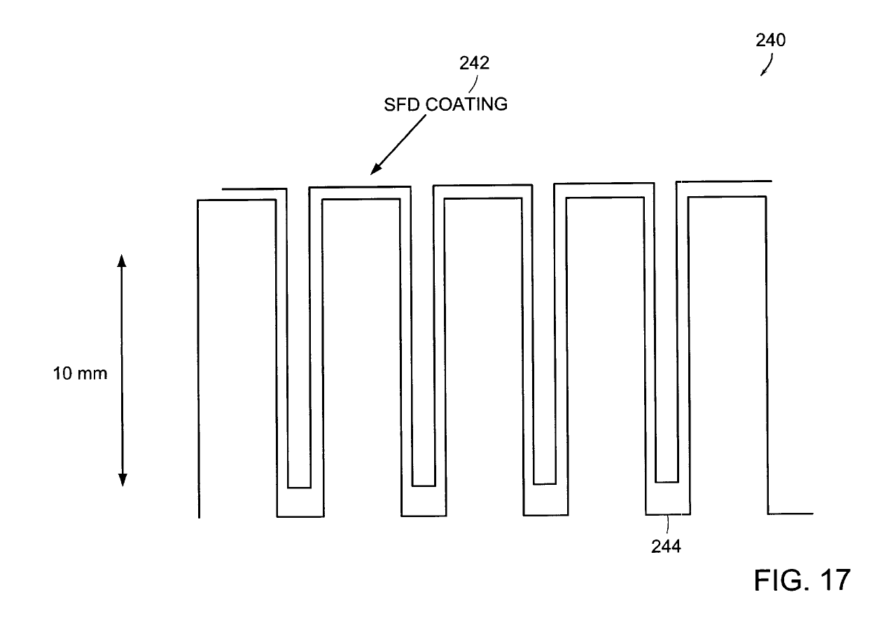

Hereinbefore, SFD methods were discussed with respect to providing uniform thin films. FIG. 17 illustrates a preferred embodiment of devices manufactured with thick depositions on surfaces using supercritical fluid deposition methods in accordance with the present invention. SFD enables thick device deposition 242 on surfaces 244 of substrates or materials. SFD fills deep into structured surfaces, enabling thick devices. Thick coatings may be particularly useful when combined with conventional etch and deposition technologies, in which case SFD is used to create three-dimensional devices and mode matching systems.

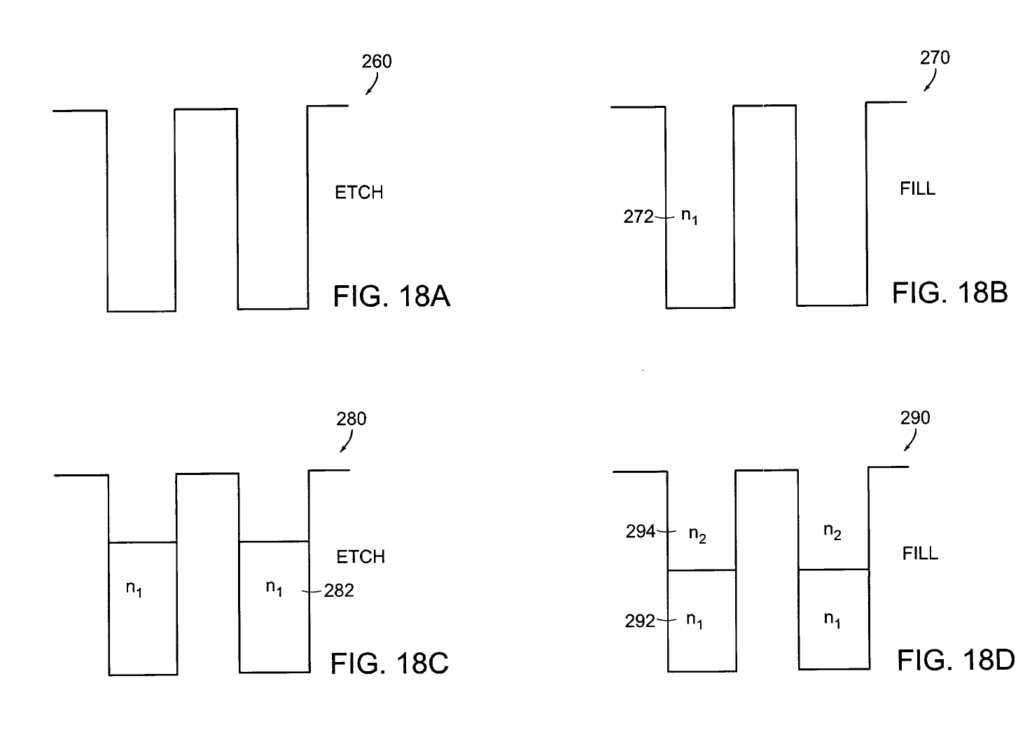

FIGS. 18A through 18D illustrate a method of stacking two different media through a deposition/etch cycle in accordance with a preferred embodiment of the present invention. The stacking process of two different media through a deposition/etch cycle includes etching the surface of the substrate in step 260, filling the high aspect ratio surfaces with a material having a refractive index n₁ per step 270, etching the surface and filling the gaps with a material having a second index of refraction n₂ per steps 280 and 290, respectively. SFD enable three-dimensional device fabrication by allowing stacking, formation of cavities and heterogeneous deposition and etching.

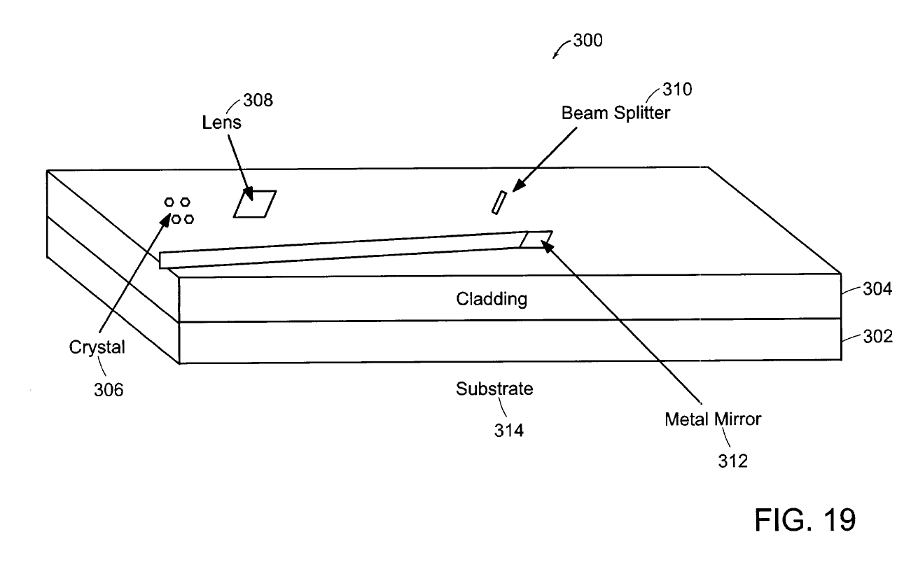

FIG. 19 is a preferred embodiment of an integrated circuit device 300 including a waveguide 316, partial reflectors 312, beam splitters 310, filters 306 and lenses 308 in accordance with the present invention. SFD enables the integration of and processing of unique and heterogeneous materials. Since SFD is a low temperature process it enables device fabrication from a much wider class of materials than conventional devices. Integration of organic, metallic, semiconductor, polymeric, inorganic glass and ceramic materials is possible. Incorporation of nanoparticles, liquid crystals and semiconductors into various lattices enables switch and source development. Heterogeneous devices may also be used to create a complete optical breadboard in planar circuits. The device 300 includes metal mirrors 312 and a waveguide 316 created by deep deposition channels.

Photonic circuit devices include wavelength management components and extend from a fixed single-wavelength filter to a multi-channel tunable wavelength router. The core component of these devices is an optical resonator integrated into a conventional silica planar waveguide. An integrated Fabry-Perot resonator can be used to fabricate a wavelength filter. The resonator is designed to transmit the wavelength that is desired to be removed, or filtered, from the multi-channel signal. The remaining wavelengths are reflected by the Fabry-Perot resonator. Moreover, the methods of fabrication in accordance with the present invention allows the fabrication of multi-cavity Fabry-Perot resonators to create flat-top optical filters. These flat top filters provide the pass-band and drop-off characteristics essential for low-cross talk wavelength selection in diverse dense WDM (DWDM) applications.

As discussed hereinbefore, the components in accordance with the preferred embodiments of the present invention are enabled by the precision fabrication of Fabry-Perot reflectors into a planar waveguide so that they are perpendicular to light propagation direction. This is accomplished by creating a photonic crystal within the planar waveguide using, for example, but not limited to, SFD processing. The use of the photonic crystal reflector allows the photonic bandgap of the crystal to be engineered, thereby allow its reflective properties to be designed for its specific application. These devices can be tuned to operate on selected wavelengths over a wide spectral range by inducing a small change in the refractive index of the Fabry-Perot cavity.

The components of preferred embodiments of the present invention combine the efficiency and manufacturability of planar waveguides for fiber-coupling, packaging and waveguiding with the performance and functional advantages of the photonic crystal structures. Moreover, the photonic crystals in the integrated circuits of the present invention are formed only in microscopic regions along the planar waveguide structure where they offer critical functional advantage. This eases processing and maximizes circuit yield.

Preferred embodiments of the present invention include wavelength filter and routing devices that utilize resonant Fabry-Perot cavities for wavelength selection. The waveguide Fabry-Perot structural filter is composed of a photonic circuit and photonic crystal mirrors. As discussed hereinbelow, the Fabry-Perot resonant cavity is explained, and the operation of wavelength filters based on integrated Fabry-Perot resonators is further explained. Further the implementation of Fabry-Perot resonators using photonic crystal reflectors is illustrated, and the analysis of the requirements for wavelength tunable components is presented.

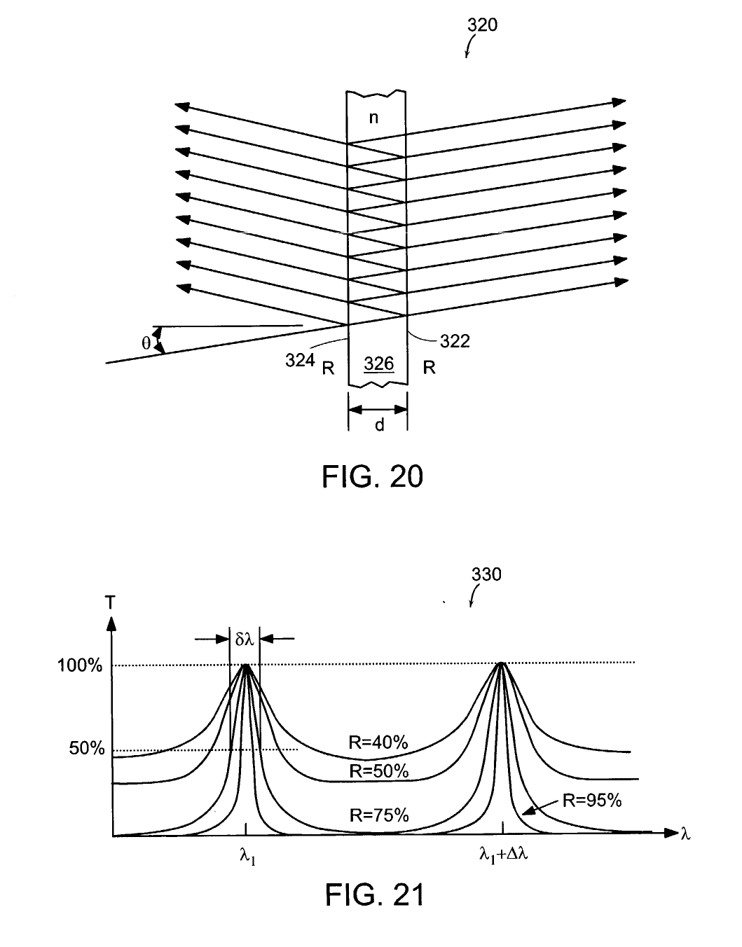

The Fabry-Perot structure is an important optical device which works based on multi-path interference of a beam of light. The interference provides a resonance at a particular wavelength, resulting in the transmission of light for only a very narrow band centered around the resonant wavelength. This provides a transmission output with a very sharp peak. The Fabry-Perot structure consists of two partially transmitting mirrors 322, 324 that are separated by a distance “d” to form a reflective cavity 326 between the mirrors, as illustrated in FIG. 20. To understand the operation of the Fabry-Perot resonator, consider that light impinges on the first mirror surface 324. From classical optics, the rays of light are partially reflected and partially transmitted from the first mirror 324 and then also partially reflected and partially transmitted from the second mirror 322. These multiple reflected and transmitted beams of light interfere with each other to define the reflection and transmission spectrum of the Fabry-Perot cavity 326. Specifically, the Fabry-Perot resonant cavity is designed such that light of only a particular wavelength is passed through the cavity, for example, transmitted, while all other wavelengths are reflected.

Classically, and for visible light wavelengths, this structure is fabricated by coating the surfaces of an optically flat glass plate of precise thickness with a gold film so thin that it is semi-transparent. The properties of these mirrors are extremely important as the magnitude of both the transmission and reflection of light off the mirror surface is critical for optimum performance of the resonant cavity.

Analytically, when a plane wave is incident on the mirror at angle θ, the transmission of the cavity is given by the following formula

$$T ( λ ) = \frac{{( 1 - R )}^{2}}{{( 1 - R )}^{2} + 4 R {sin}^{2} ( δ / 2 )} \qquad ( 1 )$$

where,

$$δ = \frac{4 π nd}{λ} cos ( θ ) \qquad ( 2 )$$

In these equations, R is the reflectivity of the mirrors, n is the refractive index of the cavity material between the mirrors, and d is the separation distance between the mirrors, referred to as the cavity length. This relationship shows the strong dependence of the transmission through the Fabry-Perot resonator on the reflectivity value of the mirror. Physically, the transmission and reflection intensities are the product of the complex conjugates of the superimposed wave amplitude sum. FIG. 21 shows the spectral transmission characteristics 330 of a Fabry-Perot cavity for a range of reflectivity values.

The transmission equation clearly shows zero transmission through the resonator if the mirror is perfectly reflecting, for example, if R=1. The value of the reflectivity is determined to optimize transmission and other critical attributes as follows. The width of the transmission peak, given by its full width at half-maximum (FWHM) is governed by the following:

$$δ λ = \frac{1 - R}{{R}^{1 / 2}} \cdot \frac{{λ}^{2}}{2 nd} \qquad ( 3 )$$

This relationship shows that increasing either the mirror reflectivity, R, or the cavity length, d, results in a smaller FWHM, or sharper spectral transmission peak. As with any resonant structure, there are a set of resonant peaks that occur at fixed periods in the wavelength spectrum. The wavelength difference between these resonant peaks is defined as the free spectral range (FSR) and is given by the following:

$$Δ λ = \frac{{λ}^{2}}{2 nd} \qquad ( 4 )$$

This relationship illustrates that increasing the cavity length, d, moves the resonant peaks closer together. This is an important consideration for wavelength filter design. For instance, the design of a fixed wavelength filter can benefit from a short cavity length since the adjacent resonant peaks may have a large wavelength separation from the desired transmitted wavelength. Conversely, the operation of a tunable filter can benefit from a longer cavity length, where a smaller separation between transmitted peaks can be utilized to maximize the tuning range.

Over the free spectral range of the Fabry-Perot resonator, the maximum transmission can reach unity (100%), while the minimum transmission depends on the reflectivity of mirror and is given by the following:

$${T}_{min} = \frac{{( 1 - R )}^{2}}{{( 1 + R )}^{2}} \qquad ( 5 )$$

An important figure of merit for the quality of the resonator is the ratio of the maximum to minimum transmission taken over the entire free spectral range. This is termed the extinction ratio (ER) and is determined from the following equation:

$$\frac{{T}_{max}}{{T}_{min}} = 10 log [ \frac{{( 1 + R )}^{2}}{{( 1 - R )}^{2}} ] ( dB ) \qquad ( 6 )$$

and indicates, for example, that to achieve an ER of 30 dB the reflectivity R be higher than 0.95 (or 95%).

These properties show that a major consideration in the design of the Fabry-Perot resonant cavity filter is the value of the mirror reflectivity. For a filter designed around a selected cavity length, allowing selection of the desired spectral range, the mirror reflectivity must be optimized for maximum transmission (minimizing signal loss) and peak sharpness (minimizing channel cross-talk). The use of photonic crystal reflectors allows the design and implementation of these optimized Fabry-Perot resonators for wavelength filter and routing applications.

As discussed hereinbefore, a photonic crystal is composed of the periodic distribution of different dielectric materials in a macroscopic range. When considering the true quantum nature of light, this periodic structure provides a periodic “potential” to photons, resulting in a photonic bandgap. This is a direct analogy to the electronic bandgap, which results from the periodic electrical potential field created by the periodic arrangement of atoms in a semiconductor crystal. In a material having a photonic bandgap, light can only propagate in certain directions and is literally excluded from occupying certain regions of the photonic crystal. Photonic crystals can be formed with periodicities in one, two or three orthogonal directions. Only the three-dimensional structure has a truly complete bandgap. However, both one and two dimensional photonic crystals can be practically utilized because of the optical confinement they offer in specific directions and they can be more readily implemented with conventional optical systems.

In preferred embodiments of the present invention Fabry-Perot resonant cavity filters are formed in conventional planar waveguides by depositing an optical material into arrays of sub-micron features lithographically patterned into the waveguide in selected areas. These patterned areas, which have lateral dimensions of only a few to a tenth microns, define the Fabry-Perot reflector. The deposited optical material has a significantly different refractive index than the waveguide material. This process creates a photonic crystal within the waveguide. The bandgap properties of this photonic crystal are designed to act on light propagating along the waveguide as a Fabry-Perot resonator mirror with optimized performance for the specific wavelength filtering application. Two such mirrors are formed separated from each other by the precise dimensions required for the specified cavity length.

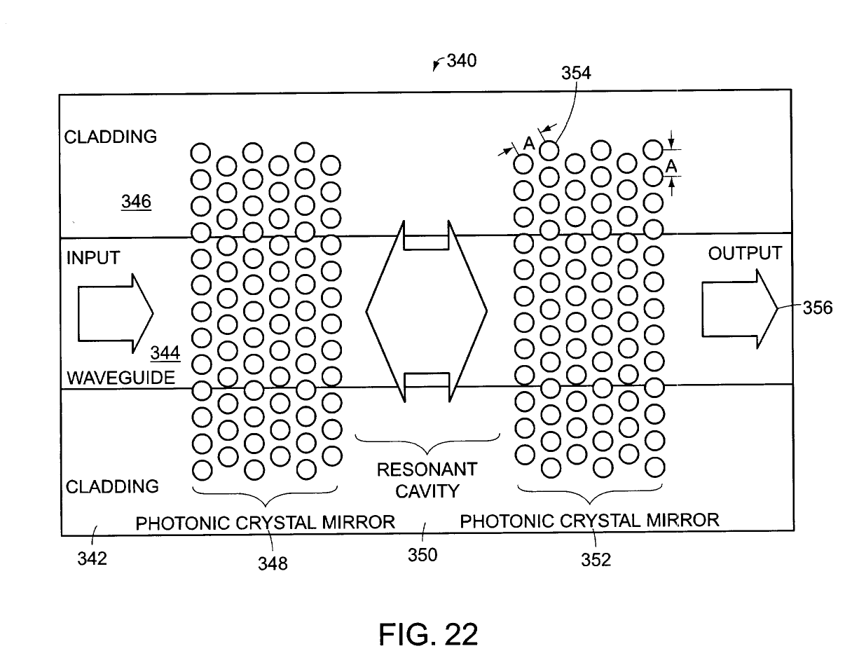

In this integrated Fabry-Perot filter configuration, light is confined for straight propagation by the waveguide geometry, in which the refractive index of guiding layer is higher than that in the cladding. This configuration is illustrated in FIG. 22, as viewed from the top of a waveguide Fabry-Perot filter using photonic crystal mirrors in accordance with a preferred embodiment of the present invention. The photonic crystal 354 illustrated is a two-dimensional hexagonal structure with a lattice dimension ‘a’.

When used as a wavelength filter in a preferred embodiment for a DWDM application, the optical signal includes multiple wavelengths propagating along the planar waveguide and is input onto the first photonic crystal mirror 348. There is no optical loss with incidence on the photonic crystal, as the optical front simply sees a mirror. The mirrors 348, 352 are identical and are designed for an optimal reflectivity to allow resonant optical interference within the Fabry-Perot cavity 350, which is the planar waveguide media 344. When this occurs, a particular wavelength peak is transmitted through the Fabry-Perot resonator and the output signal 356 continues to propagate along the planar waveguide. The full optical signal, minus the transmitted peak spectrum, is reflected back from the Fabry-Perot resonator. Photonic crystal structures typically have a propagation loss of between approximately 1 to 10 dB per centimeter of propagation length. In a preferred embodiment Fabry-Perot structure, the optical signal transverses a length of the photonic crystal on the order of 10 microns. Therefore, in a preferred embodiment the anticipated signal loss from this Fabry-Perot cavity is less than approximately 0.1 dB, including the multi-pass resonance.

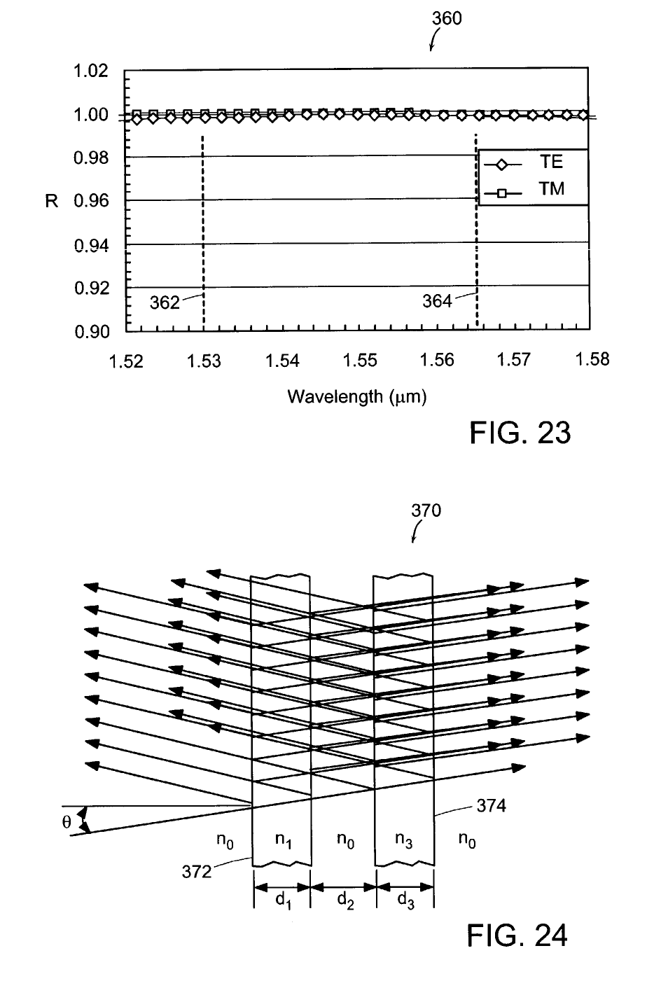

As discussed hereinbefore, the ability to design an optimal reflector with photonic crystals is enabling. This is achieved by forming a two-dimensional photonic crystal within a planar waveguide. While the two-dimensional photonic crystal structure does not provide a complete band-gap, this reflection configuration readily achieves the desired resonator mirror properties. Importantly, the photonic crystal mirror is designed to be polarization independent, working in both transverse electric (TE) and transverse magnetic (TM) modes. The simulation results in FIG. 23 illustrate the design of a photonic crystal Fabry-Perot reflector optimized for C-band operation. The vertical markers 362, 364 show the C-band operating window. According to the transparent characteristics in optical glass, the transmission spectra is divided into several wavelength ranges, such as, for example, the C, L, S bands. In preferred embodiments the bands have the following ranges: C-band: 1530 nm˜1565 nm, L-band: 1565 nm˜1625 nm, and S-band: 1460 nm˜1530 nm.

The transmission characteristics of a single Fabry-Perot, as described hereinbefore, provide an extremely narrow transmission peak with sloping sidewalls. Due to this narrow FWHM, it is difficult to use this kind of filter in the DWDM system. A filter using multiple resonant Fabry-Perot cavities addresses the problem of a narrow transmission peak. For example, an illustration of a dual cavity Fabry-Perot structure is shown in FIG. 24. The double cavity Fabry-Perot type of filter 370 is composed of two common Fabry-Perot resonators 372, 374 separated at a certain coupling distance L. In preferred embodiments the channel spacing for particular frequencies is as follows: at 100 GHz the channel spacing is 0.8 nm; at 50 GHz the channel spacing is 0.4 nm and at 25 GHz the channel spacing is 0.2 nm.

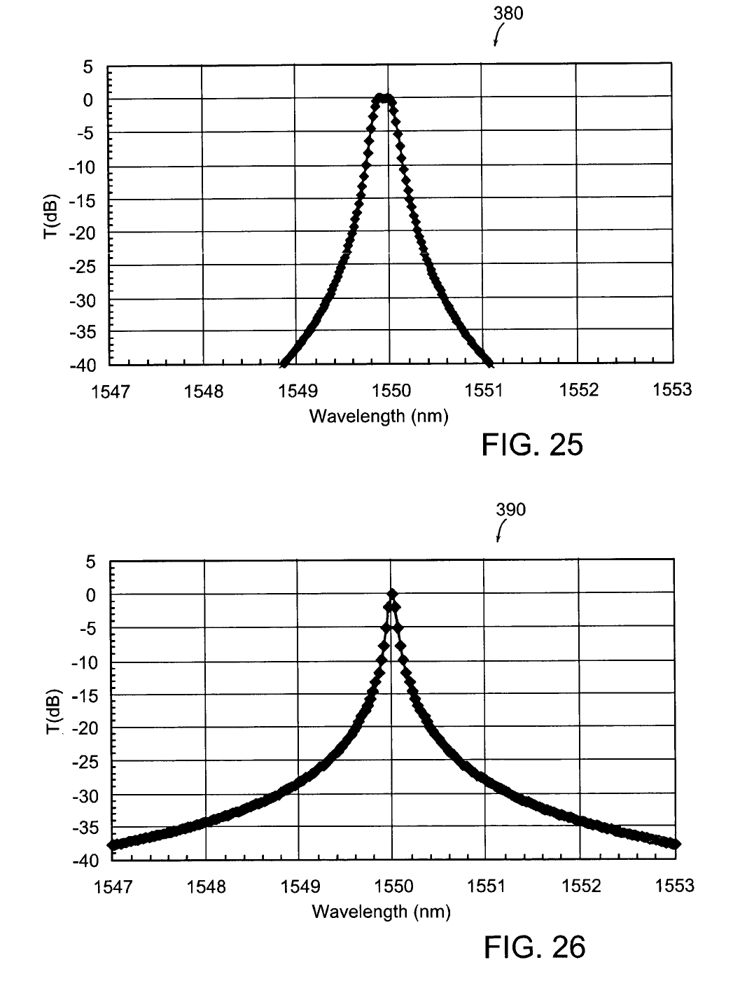

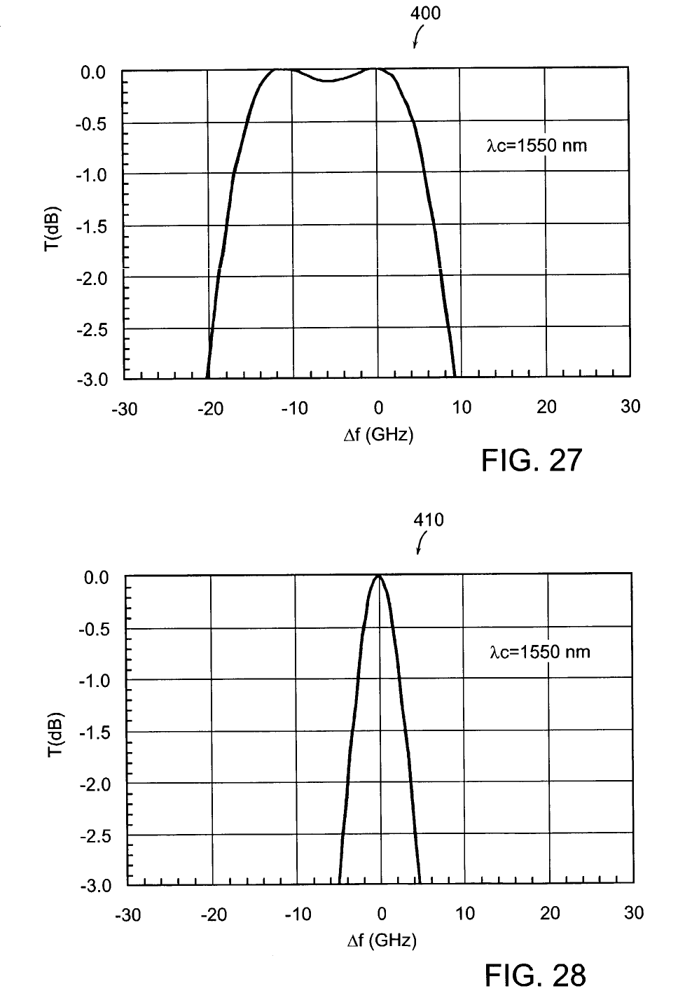

FIGS. 25-28 illustrate the comparisons of the transmissions at −40 dB and −3 dB extinction ratio between a double cavity and single cavity. FIGS. 25 and 27 illustrate the transmission spectra in a double cavity Fabry-Perot structure with the x axis expressed in wavelength (nm) and a frequency differential Δf (GHz), respectively, in accordance with preferred embodiments of the present invention. In comparison FIGS. 26 and 28 graphically illustrate the transmission spectra in a single cavity Fabry-Perot structure with the x axis expressed in wavelength (nm) and Δf (GHz), respectively, in accordance with preferred embodiments of the present invention. The phase difference between the cavities is determined by the distance between the cavities (denoted as d₂ in FIG. 24). Pass band characteristics can be simplistically viewed as the product of two slightly offset spectra. The offset of spectra is determined by the distance between the cavities.

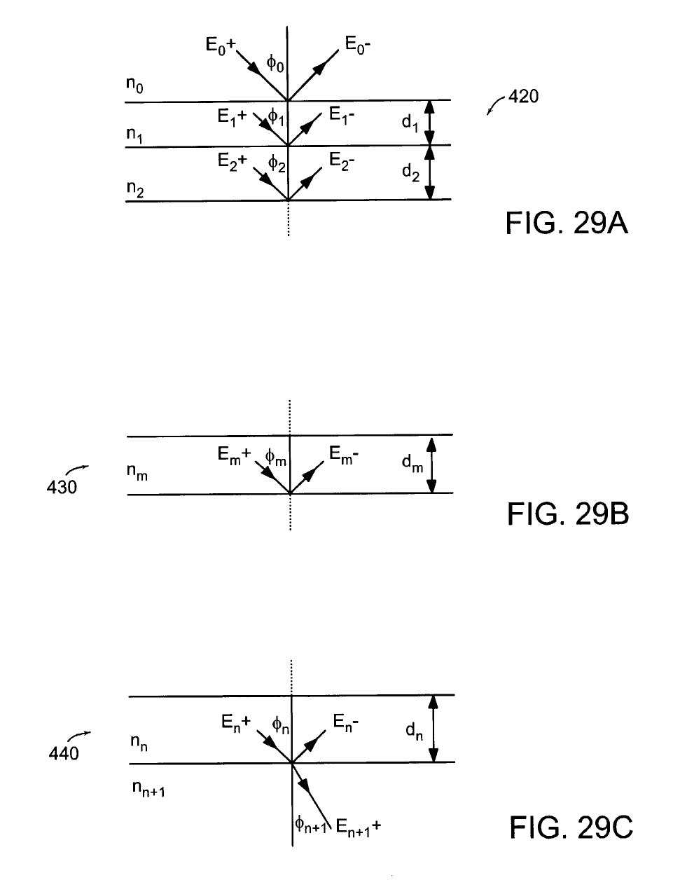

Another form, more convenient for computation, can be obtained if the relations between the electric vectors in successive layers are expressed in terms of Fresnel coefficients. For the system of n layers shown in the FIGS. 29A-29C, according to the continuity at the boundary, the recurrence relation of the electric field may be written in the matrix form as the following.

$$( \begin{matrix}{E}_{m - 1}^{+} \\ {E}_{m - 1}^{-}\end{matrix} ) = \frac{1}{{t}_{m}} ( \begin{matrix}{ⅇ}^{ⅈ {δ}_{m - 1}} , {r}_{m} {ⅇ}^{ⅈ {δ}_{m - 1}} \\ {r}_{m} {ⅇ}^{- ⅈ {δ}_{m - 1}} , {ⅇ}^{ⅈ {δ}_{m - 1}}\end{matrix} ) ( \begin{matrix}{E}_{m}^{+} \\ {E}_{m}^{-}\end{matrix} ) \qquad ( 7 )$$

The relationship between E₀ and Eₙ₊₁ may be written as the following:

$$( \begin{matrix}{E}_{0}^{+} \\ {E}_{0}^{-}\end{matrix} ) = \frac{( {C}_{1} ) ( {C}_{2} ) … ( {C}_{n + 1} )}{{t}_{1} {t}_{2} … {t}_{n + 1}} ( \begin{matrix}{E}_{n + 1}^{+} \\ {E}_{n + 1}^{-}\end{matrix} ) \qquad ( 8 )$$

wherein

$${C}_{m} = ( \begin{matrix}{ⅇ}^{ⅈ {δ}_{m - 1}} , {r}_{m} {ⅇ}^{ⅈ δ} \\ {r}_{m} {ⅇ}^{- ⅈ {δ}_{m - 1}} , {ⅇ}^{ⅈ {δ}_{m - 1}}\end{matrix} ) \qquad ( 9 )$$

The product of the matrix is rewritten for simplicity as the following:

$$( \begin{matrix}A , B \\ C , D\end{matrix} ) = ( {C}_{1} ) ( {C}_{2} ) … ( {C}_{n + 1} ) \qquad ( 10 )$$

Thus the following relationship may be obtained under the reality Eₙ₊₁=0

$$( \begin{matrix}{E}_{0}^{+} \\ {E}_{0}^{-}\end{matrix} ) = \frac{1}{{t}_{1} {t}_{2} ⋯ {t}_{n + 1}} ( \begin{matrix}{AE}_{n + 1}^{+} \\ {CE}_{n + 1}^{+}\end{matrix} ) \qquad ( 11 )$$

Consequently, the transmission T and reflection R can be expressed as the following:

$$R = \frac{( {E}_{0}^{-} ) {( {E}_{0}^{-} )}^{*}}{( {E}_{0}^{+} ) {( {E}_{0}^{+} )}^{*}} = \frac{{CC}^{*}}{{AA}^{*}} \qquad ( 12 )$$

$$T = \frac{( {E}_{n + 1}^{+} ) {( {E}_{n + 1}^{+} )}^{*}}{( {E}_{0}^{+} ) {( {E}_{0}^{+} )}^{*}} = \frac{( {t}_{1} {t}_{2} … {t}_{n + 1} ) {( {t}_{1} {t}_{2} … {t}_{n + 1} )}^{*}}{{AA}^{*}} \qquad ( 13 )$$

wherein rᵢ and tᵢ are the Fresnel coefficients of reflection and transmission on the i^{th} interface, respectively, which are polarization dependent at normal incidence, as well as

$${δ}_{i} = \frac{2 π {n}_{i} {d}_{i} cos {φ}_{i}}{λ} \qquad ( 14 )$$

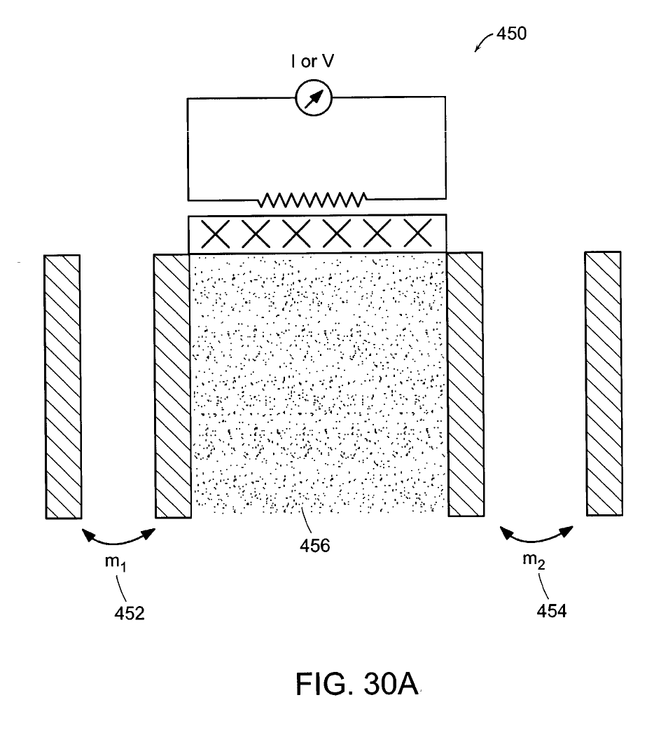

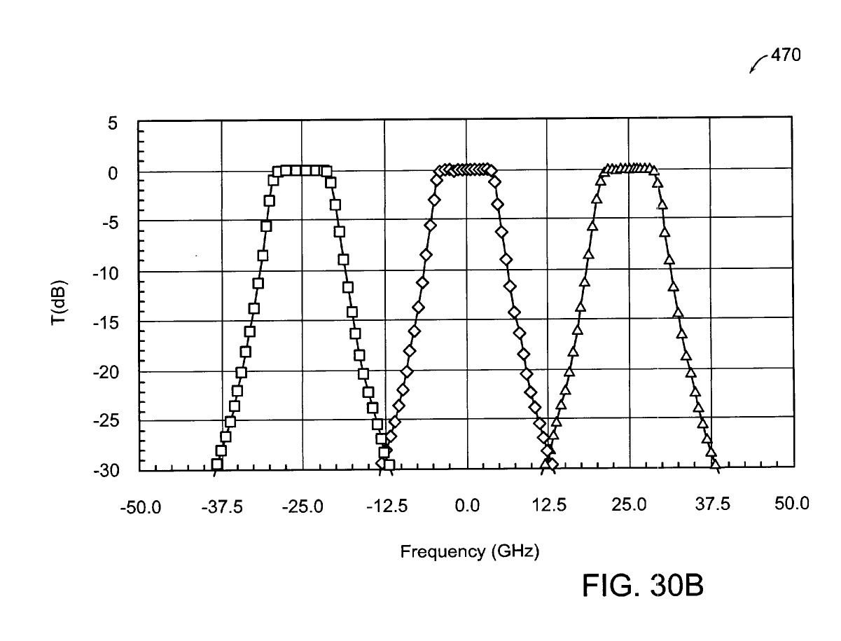

The filter may be tuned by any effects that can change the refractive index of the cavity material, such as thermal-optics (TO), electro-optics (EO), magneto-optics (MO) and piezo-optics (PO). FIG. 30A is a sectional view of a tunable filter in accordance with a preferred embodiment. The index of refraction of the cavity material 456 is adjusted by changing, for example, the current or voltage using thermal-optics or electro optics, respectively. The direct tuning process may be accomplished over the full C-band to account for a high refractive index differential (Δn). In preferred embodiments, the C-band range of wavelengths is 1.53 to 1.57 μm while the L-band range is approximately 1.57 to 1.62 μm. A resonant tuning process to account for a vernier effect may be used in preferred embodiments wherein tuning over the same range is conducted for two such Fabry-Perot resonators. In the preferred embodiment, one Fabry-Perot resonator is tuned with respect to the other to account for the vernier effect.

The tuning range of the wavelength Δλ is determined by an index change Δn expressed as the following:

$$\frac{Δ λ}{λ} = \frac{Δ n}{n} \qquad ( 15 )$$

For 1% wavelength tuning of Δλ, a 1% index change An can be made in a preferred embodiment. For the entire C or L band, the wavelength range δλ is approximately 30 nm thus, a 2% index change is required in a preferred embodiment. In addition, for preferred embodiments of waveguide based devices, a 2% index change may alter guiding mode properties. In alternative embodiments, a dual-cavity structure with a small difference in resonant frequencies with respect to each other are used. This method of a preferred embodiment results in discrete wavelength tuning or wavelength jumping, which can be matched to wavelength series in DVDM.

FIG. 30B is a graphical illustration of a tuning spectrum for a 25 GHz space DWDM resulting from a direct tuning method in accordance with a preferred embodiment. The center wavelength λc is 1550 nm and the differential refractive index is approximately ±2×10⁻⁴.

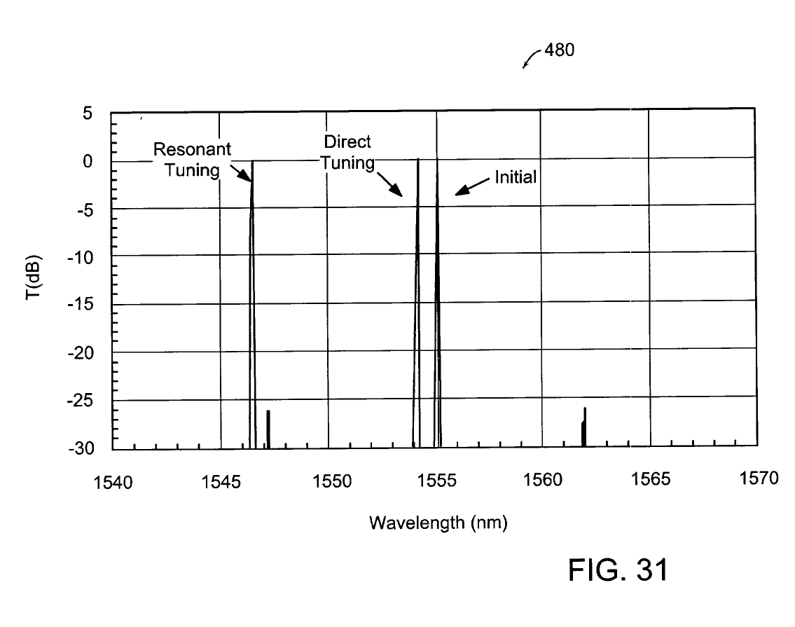

FIG. 31 graphically illustrates the numerical comparison of the direct tuning method and the resonant tuning method that accounts for vernier effects. In a numerical simulation in accordance with a preferred embodiment, the resonant tuning method can be tuned to approximately 10 times the wavelength tuning (Δλ˜8 nm) than made by the direct tuning (Δλ˜0.8 nm).

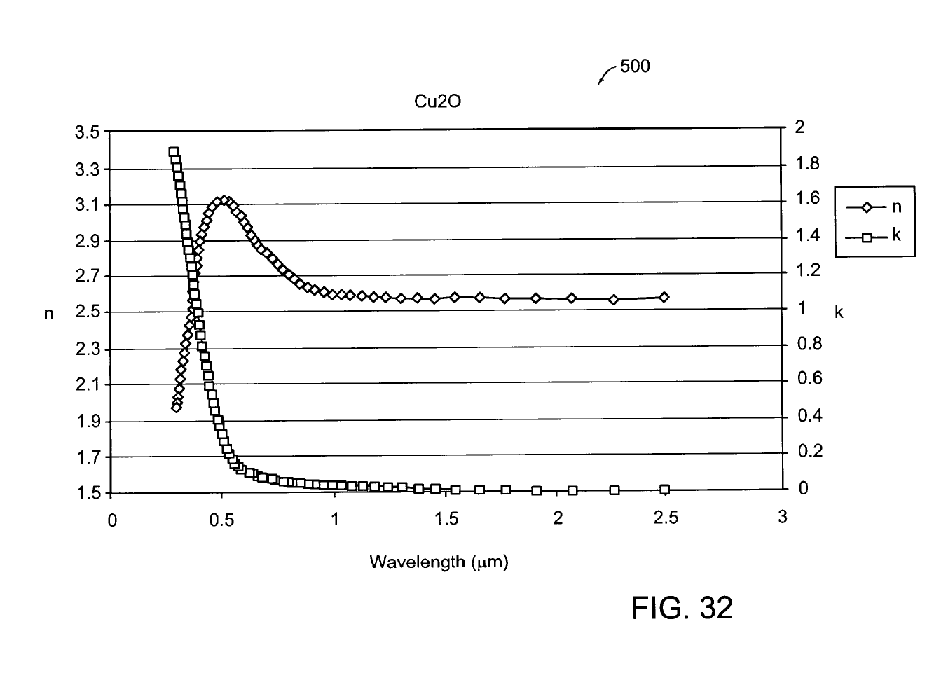

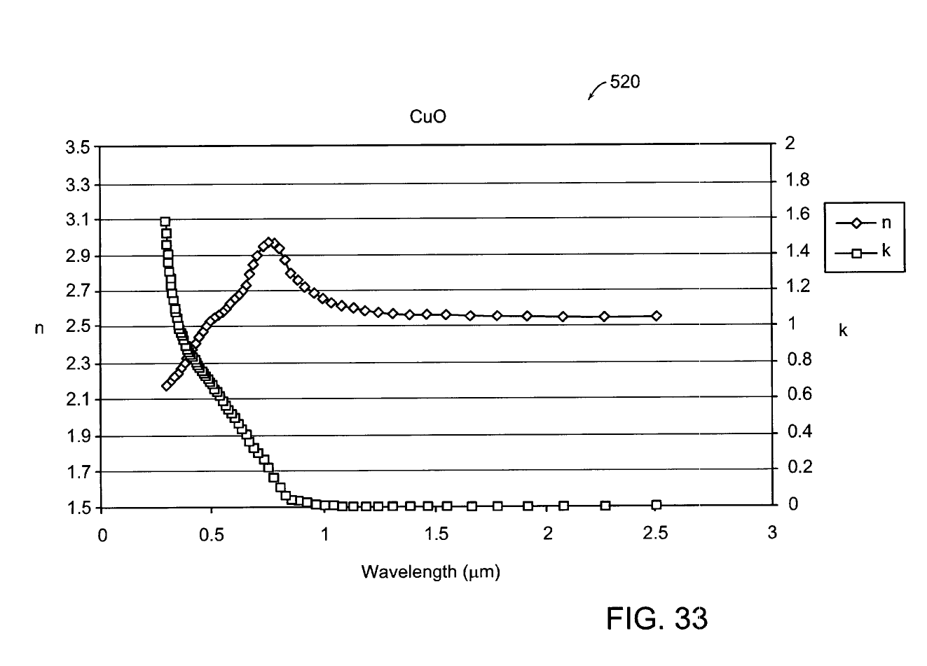

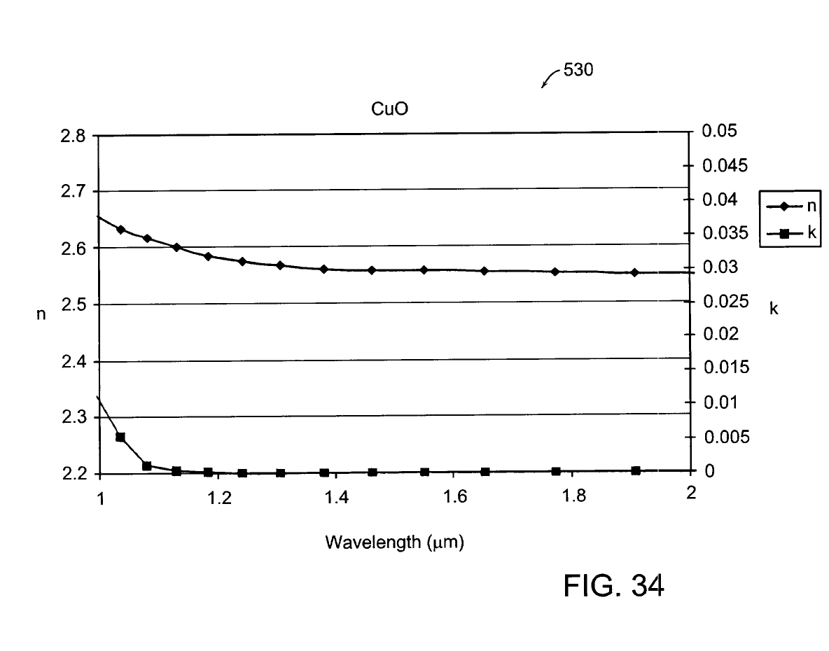

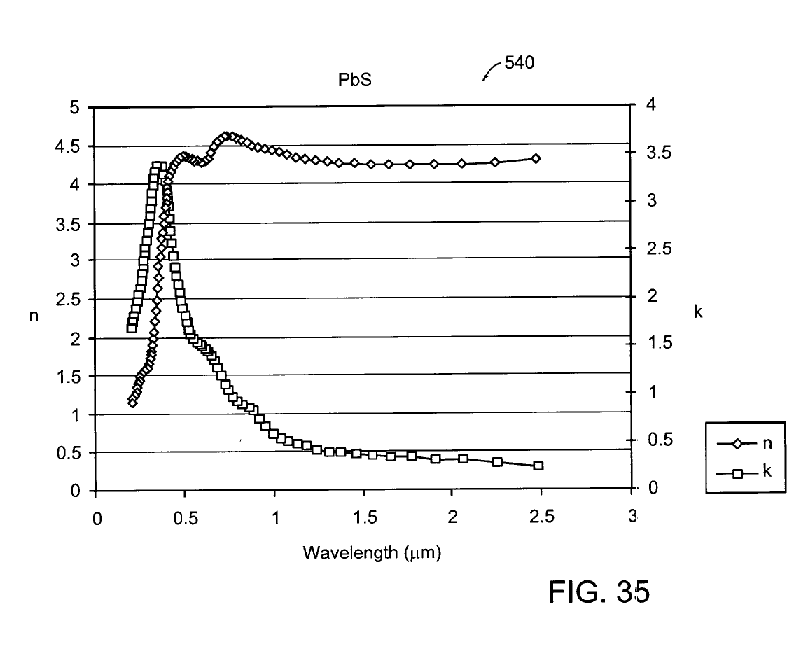

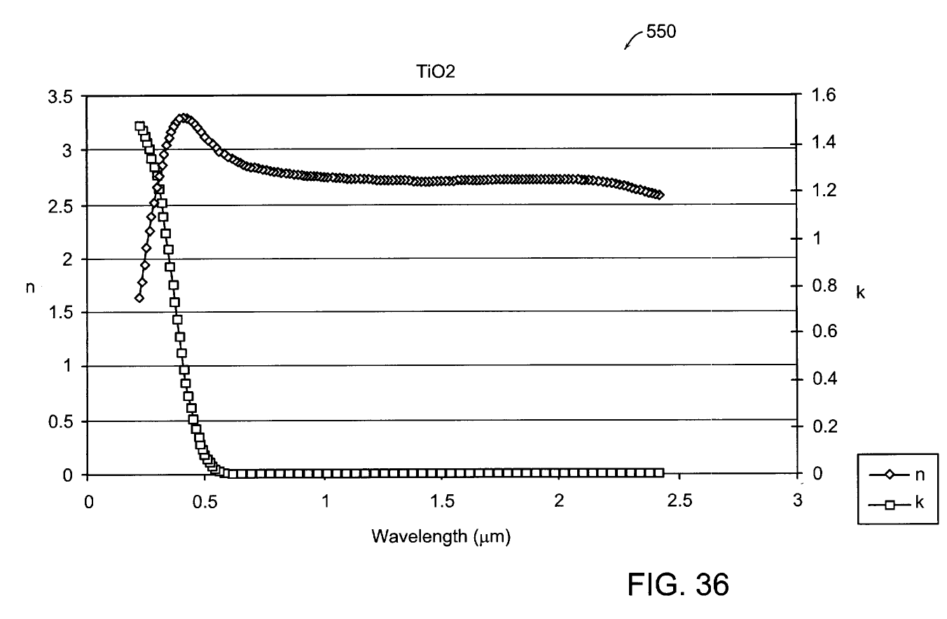

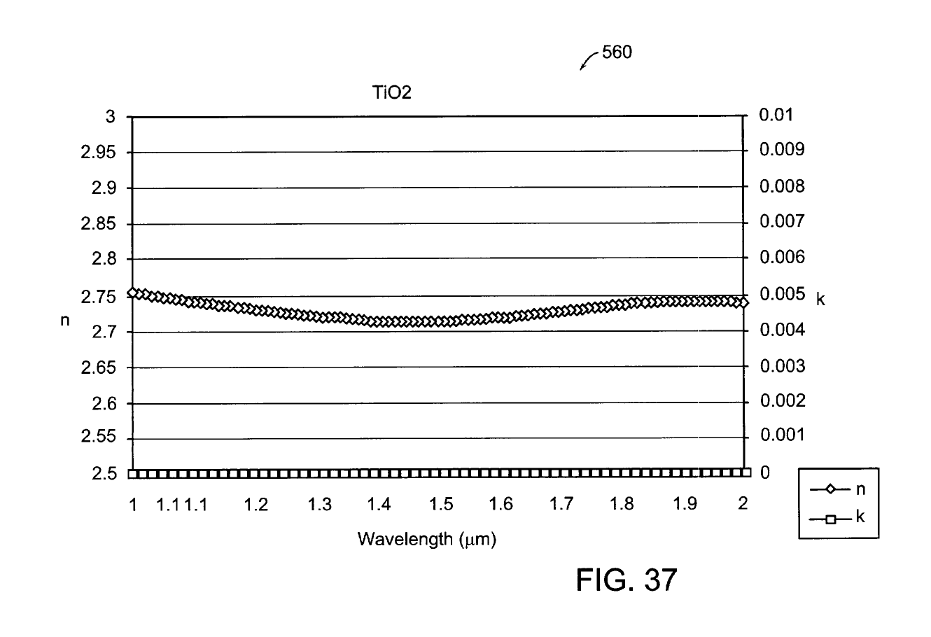

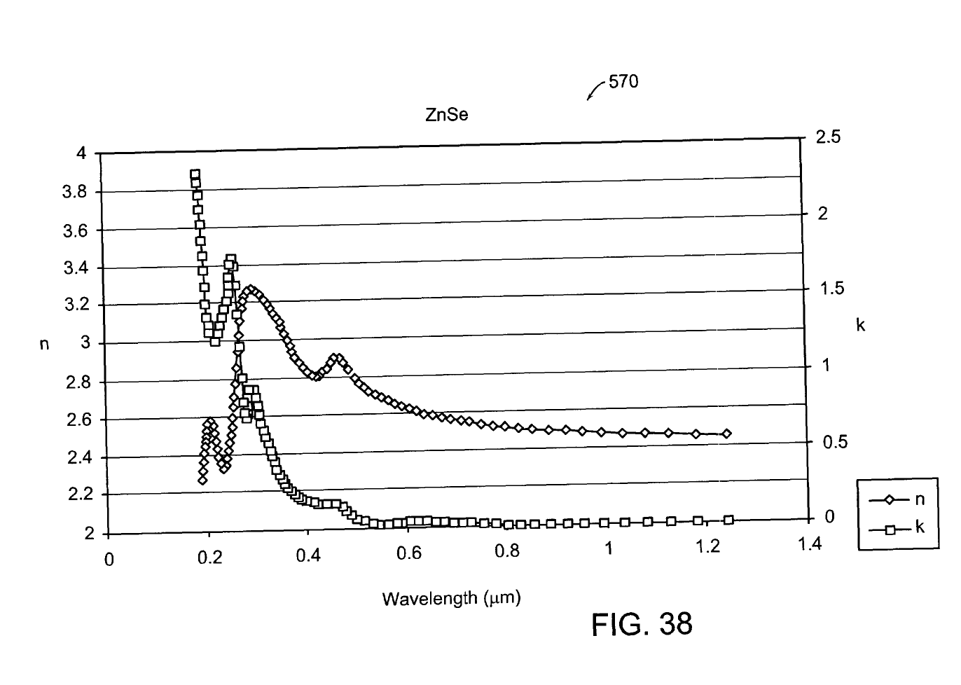

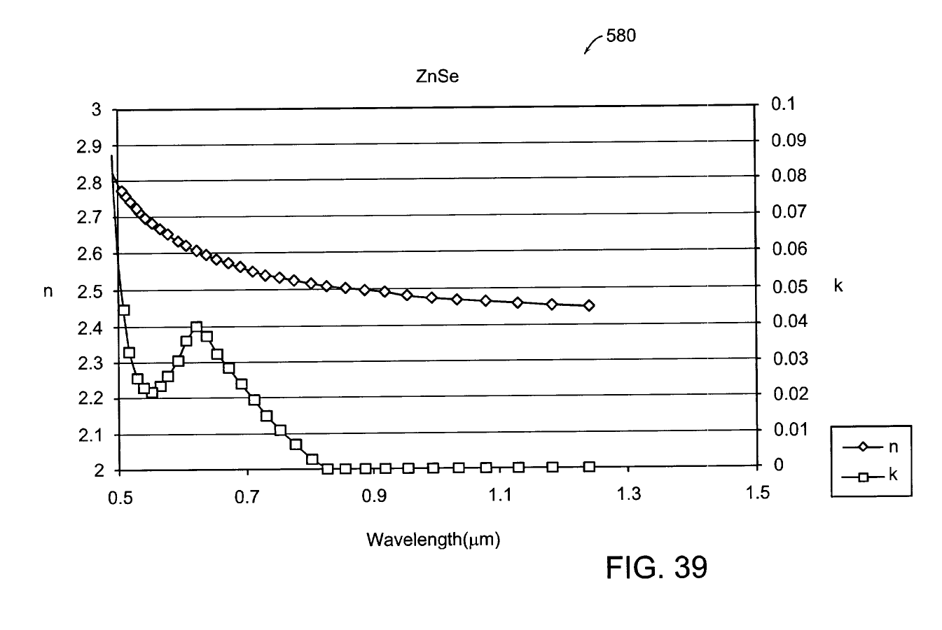

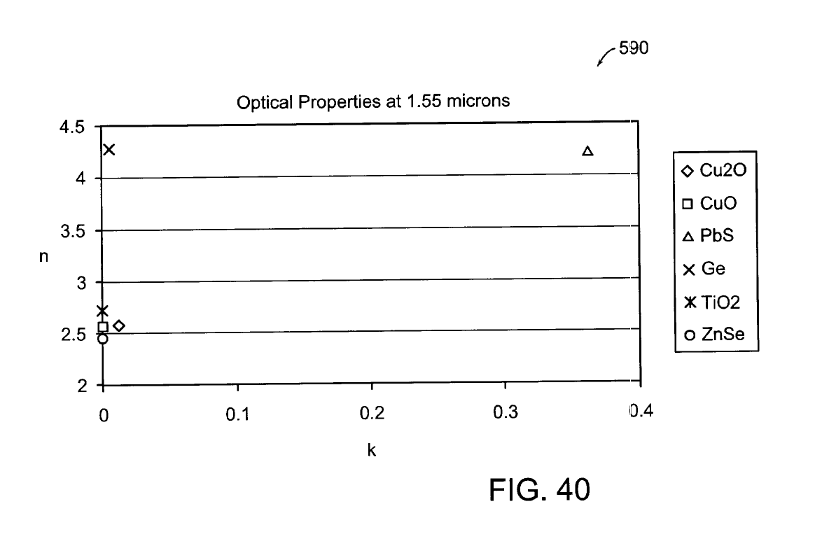

FIGS. 32 through 40 graphically illustrate the spectral plots of the optical properties such as, for example, the refractive index (n) and absorption coefficient (k) for several materials of interest in accordance with preferred embodiments of the present invention. These materials include copper dioxide, both Cu₂O and CuO, lead sulphide (PbS), titanium dioxide (TiO₂), and zinc selenide (ZnSe). These varieties of materials have a refractive index that is higher than the refractive index of substrates used and are disposed in the hole structures. The transmission properties of these materials vary but are appropriate for the wavelengths used in optical circuit devices in accordance with preferred embodiments of the present invention.

Further, the metals are used to provide appropriate values of reflectivity for mirrors disposed in the devices in accordance with preferred embodiments. SFD provides an appropriate processing method to manufacture devices having mirrors or reflectors and/or resonators.

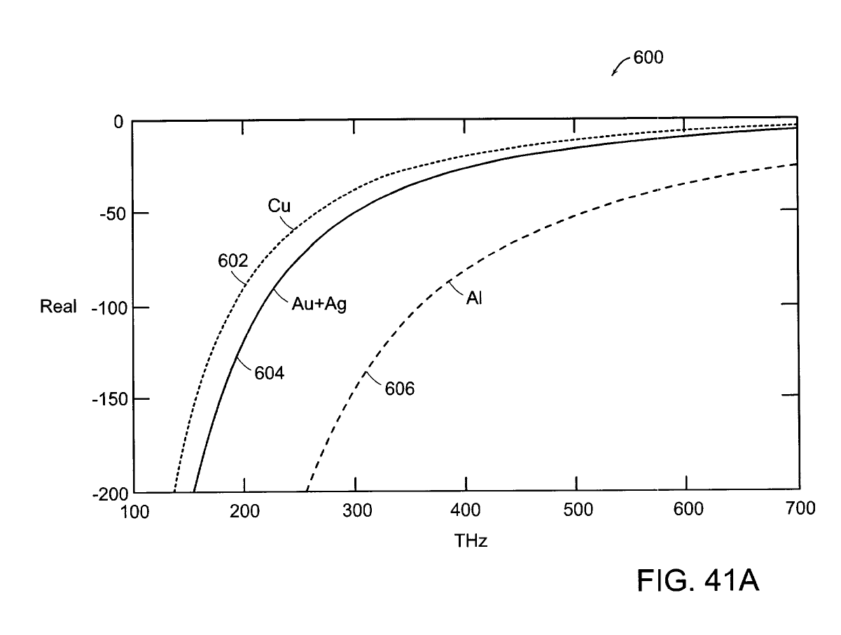

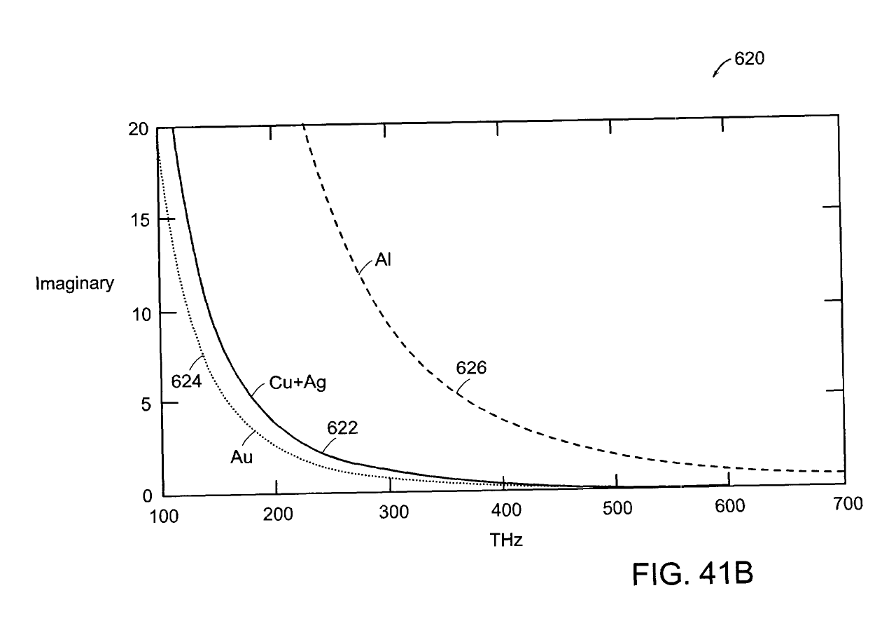

FIGS. 41A and 41B illustrate the dielectric constants for copper, silver, gold and aluminum in accordance with the preferred embodiments of the present invention. The real and imaginary values for the dielectric constants are illustrated, respectively. The dielectric constant relationship is given by the following:

ε=ε′+iε″=(n+ik)²

wherein the ε is the dielectric constant, ε′ and ε″ are respectively the real and imaginary parts of dielectric constant; n is the refractive index, and k is the absorption coefficient of material.

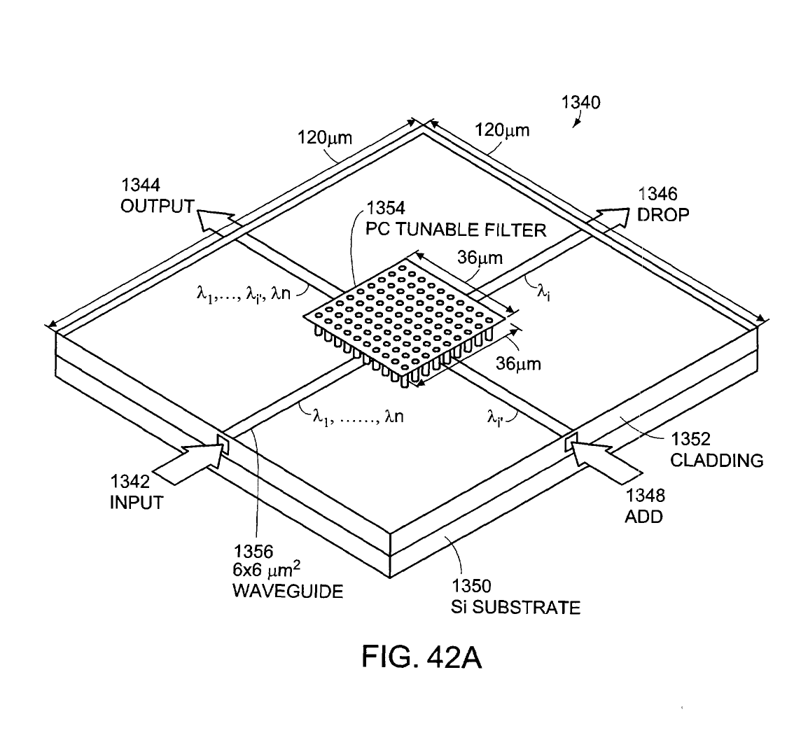

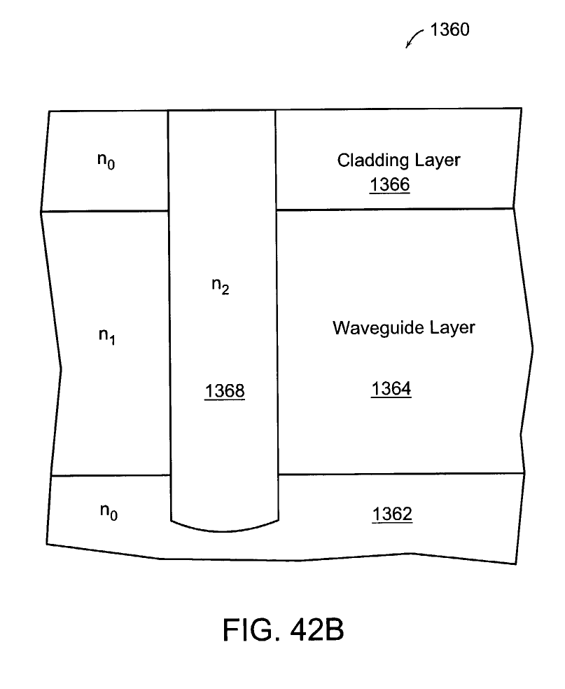

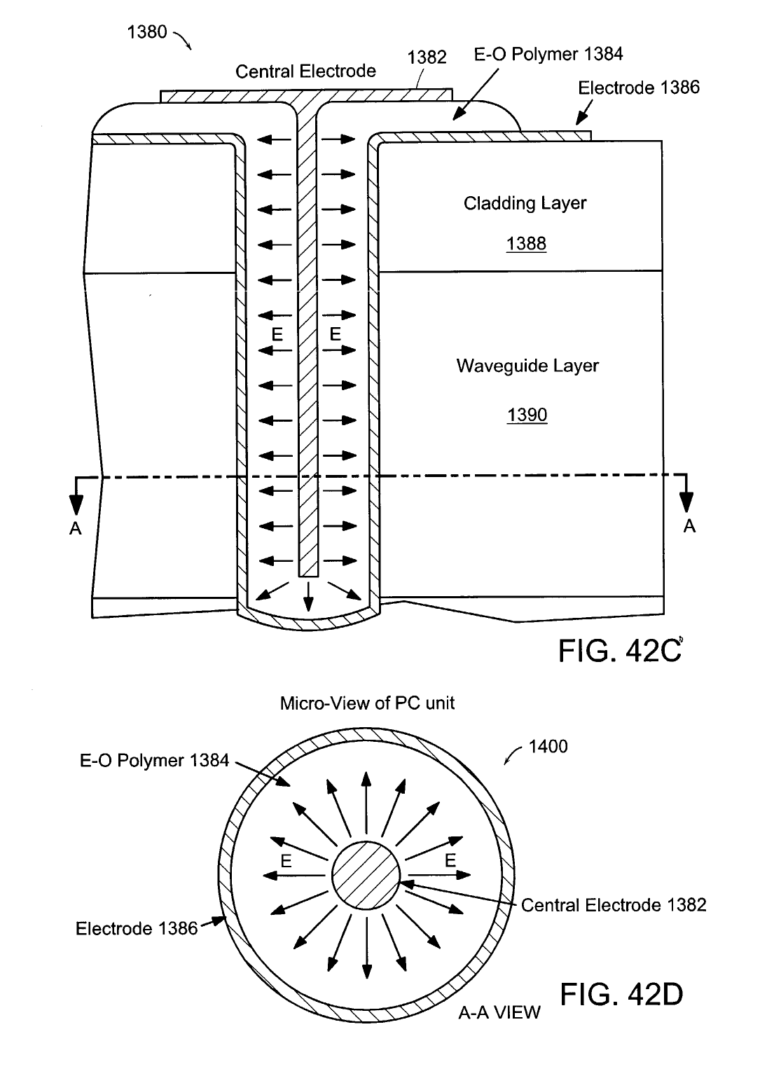

FIG. 42A is a preferred embodiment of a tunable filter 1340 in accordance with the present invention. The function of this preferred embodiment is the tuning of the transmission wavelength. The device 1340 includes an input port 1342, an output port 1346, an add port 1348, and a drop port 1346. The substrate 1350 has disposed over it a cladding layer 1352. A waveguide 1356 is formed in the cladding. Preferably the dimensions of the waveguide are 6×6 μm² to optimize fiber coupling. A photonic crystal tunable filter is coupled to the waveguide 1356. Based on the theoretical analysis of a three-dimensional photonic crystal, the filtering performance can be realized with polarization independency. This preferred embodiment realizes the same wavelength filtering both for two orthogonal polarized lights using a two-dimensional photonic crystal. However, another preferred embodiment includes a two-dimensional photonic crystal (PC) filter which has a band-gap reflector for one polarization mode while it has the filtering performance for another polarization mode. Thus, the photonic crystal filter is configured to have the filter performance for the TE mode while having the band-gap reflection for TM mode in waveguide, or vice versa.

FIG. 42B is a cross-sectional view of the filter 1340 illustrated in FIG. 42A.

The substrate layer 1362 has a low refractive index (n₀) in comparison to the refractive indices of the waveguide layer 1364, and the layer of material used to fill the structures such as holes disposed in the device.

FIGS. 42C and 42D are a cross-sectional view 1380 and a view 1400 along the line A-A, respectively, in accordance with the preferred embodiment illustrated in FIG. 42A. A micro-view of the photonic crystal tunable filter 1354 illustrates a waveguide layer 1390, a cladding layer 1388 and an electrode 1386 disposed within a gap created in the cladding layer 1388 and waveguide layer. A central electrode 1382 is disposed in the gap along with an electro-optic polymer 1384.

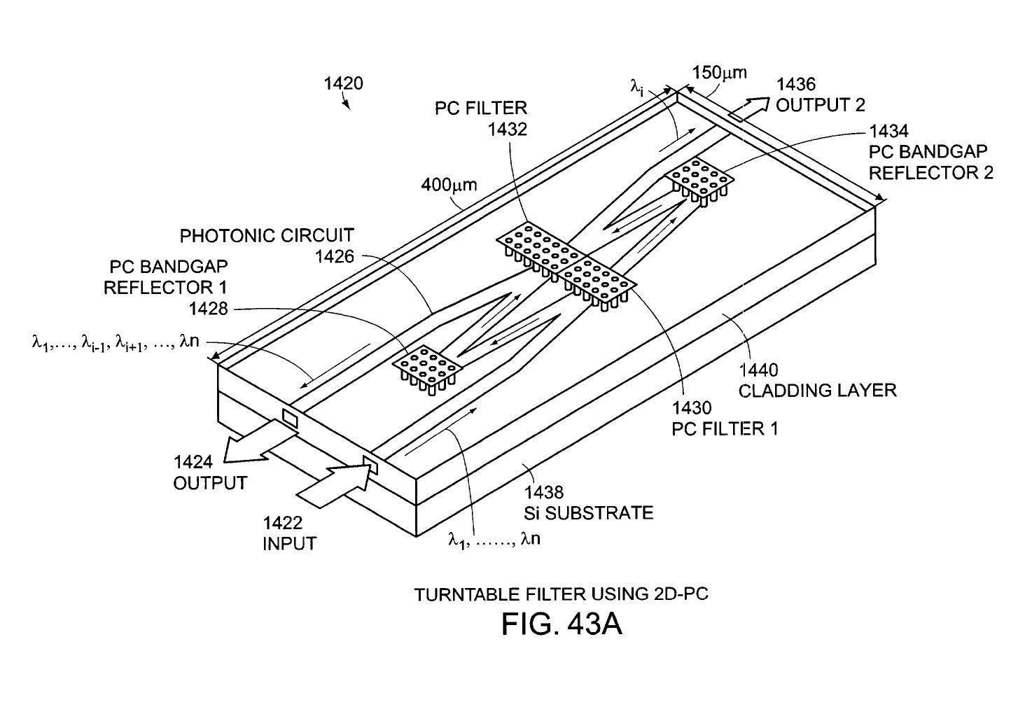

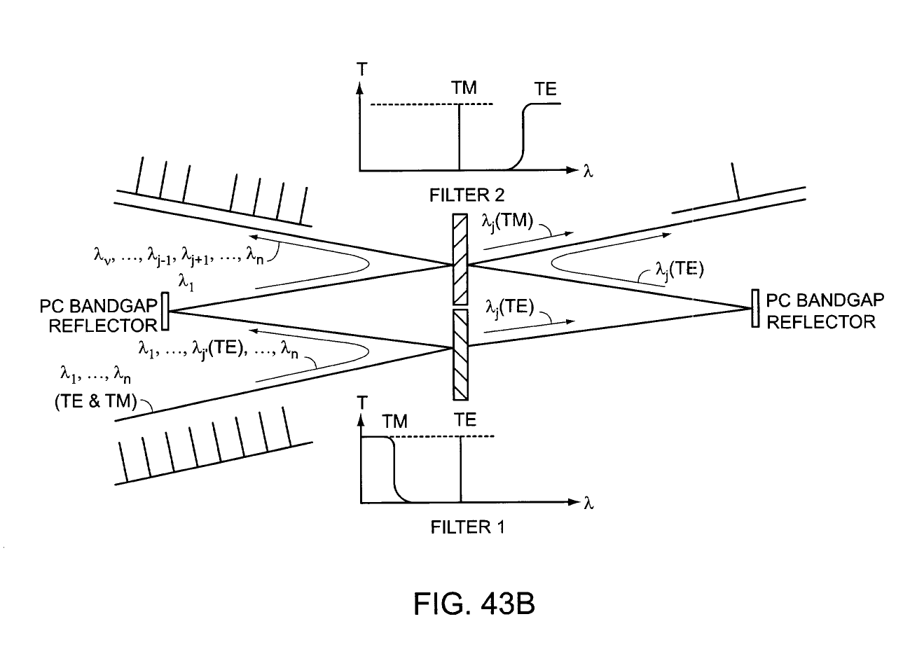

FIGS. 43A and 43B illustrate a preferred embodiment of a tunable filter 1420 having two-dimensional photonic crystals and the related directions of propagation respectively in accordance with the present invention. There are two photonic crystal band-gap reflectors 1428, 1434 which reflect both TE and TM modes. The photonic crystal filter 1430 reflects approximately all wavelength TM and other TE modes while it allows wavelength λᵢ in TE mode to pass through. The second filter 1432 reflects approximately all wavelength TE and other TM modes while it allows wavelength λᵢ in TM mode to pass through. Thus, when a group of wavelength light is injected from the input port 1422, λᵢ wavelength TE mode signal passes through the filter 1430 while all TM and other TE modes are reflected. At the second filter 1432, λᵢ wavelength TM mode signal passes through to combine with λᵢ wavelength TE mode signal while all other wavelengths of the TE and TM mode are reflected into the output port. When the passing central wavelength is tuned by some manner, using, for example, EO, MO, PO, TO effects, the turnable wavelength filter is included in the conventional photonic circuit using two-dimensional photonic crystal structures.

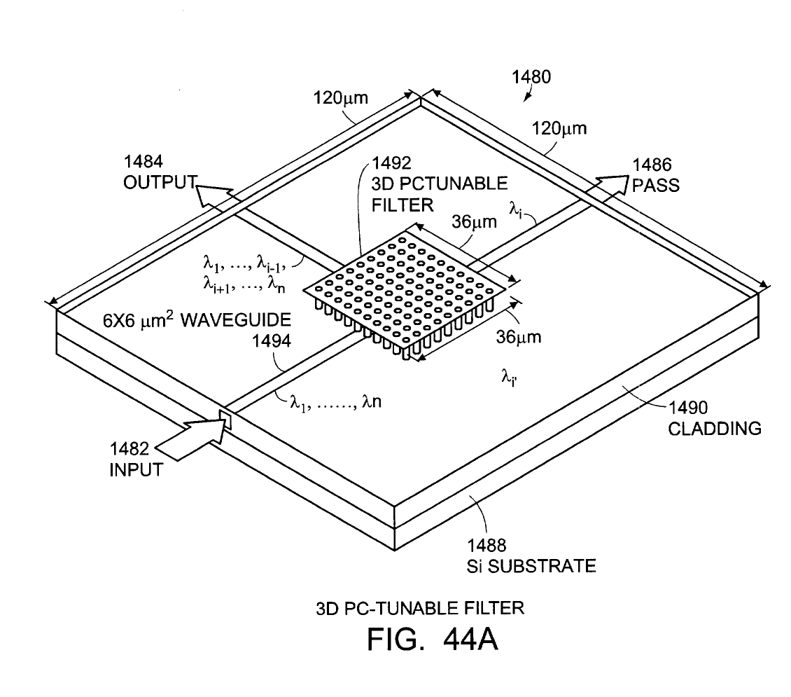

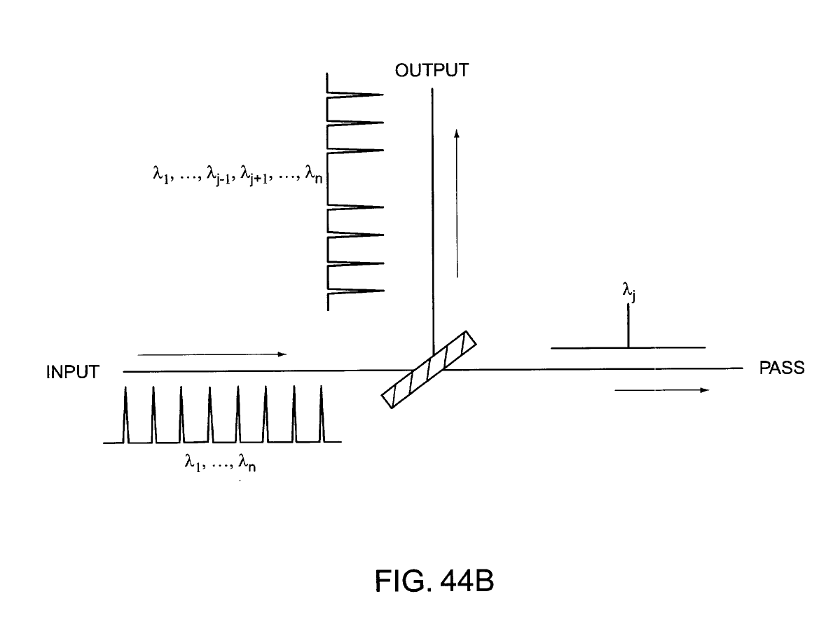

FIGS. 44A and 44B illustrate a three-dimensional photonic crystal tunable filter 1480 along with a diagram of the direction of propagation in accordance with a preferred embodiment of the present invention. The three-dimensional photonic crystal tunable filter 1480 includes an input port 1482, an output port 1484, and a port 1486 to allow the propagation of desired frequencies. The tunable filter 1492 is coupled between the waveguides 1494. The desired frequency λᵢ is transmitted while the unwanted frequencies are reflected toward the output port 1484 by the tunable filter 1492. The tunable filter 1492 is periodic along all three different axes. The filter 1492 has the ability to tune the frequency of a resonant mode.

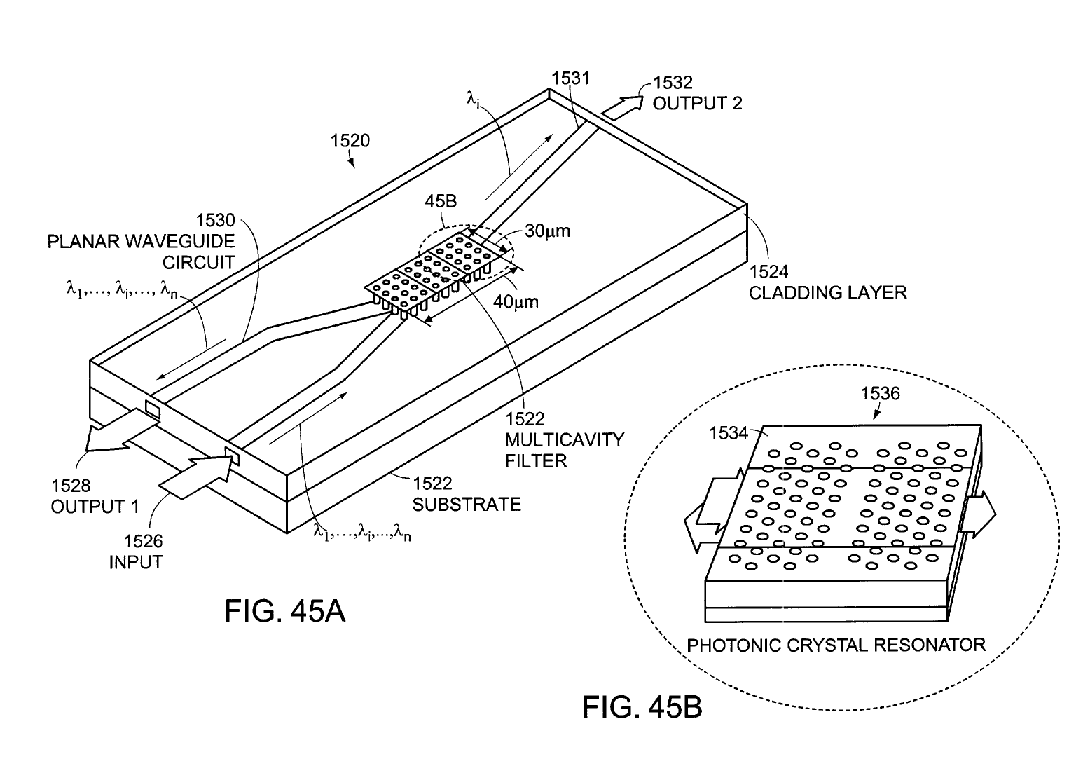

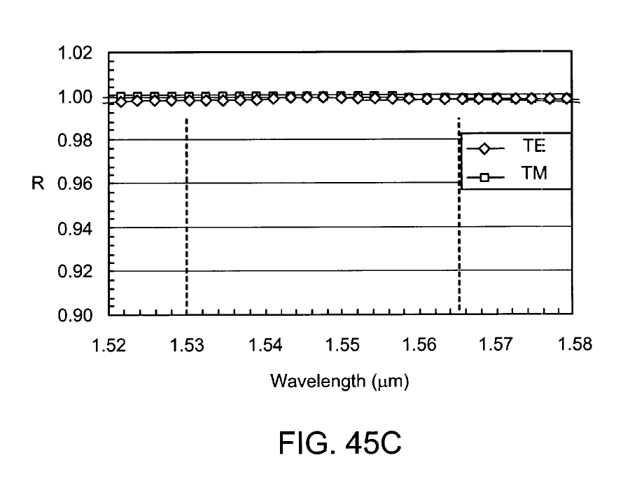

FIGS. 45A and 45B illustrate a preferred embodiment of a multicavity tunable filter device 1520 in accordance with the present invention. The multi-cavity in particular, a three cavity filter 1522 is disposed between the waveguides 1530, 1531 that connect the input port 1526 and the output ports 1528, 1532. The photonic crystal filter 1522 includes three cavities such as cavity 1536. The photonic crystal micro-cavity contains non-linear materials. The photonic crystal microcavity is essentially a structure made of a first material having a first dielectric constant and of an electrode disposed in the center as described with respect to FIG. 42C.

FIG. 45C is a graphical plot of reflectivity versus wavelength for a mirror used in the filter described with respect to FIGS. 45A and 45B. The transmission illustrated is in the C-band.

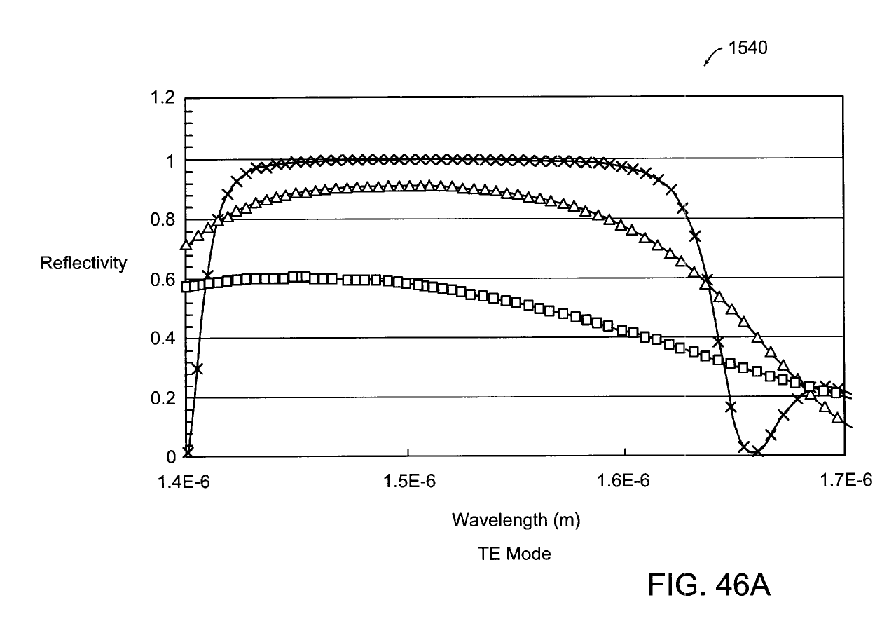

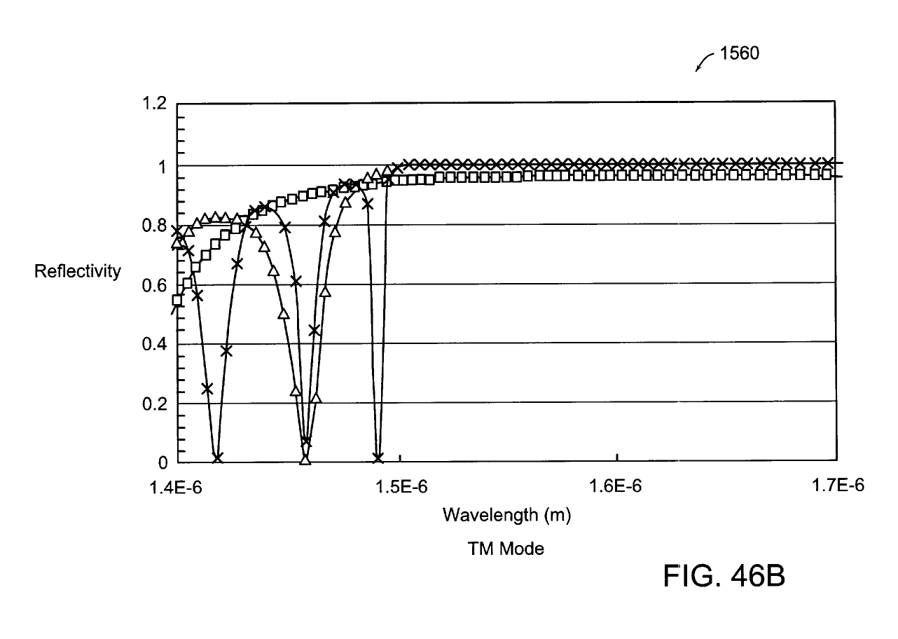

FIGS. 46A and 46B graphically illustrate the reflectivity in the transverse electric (TE) mode and transverse magnetic (TM) mode of preferred embodiments of tunable filter devices in accordance with a preferred embodiment of the present invention. The reflectivity of the TE mode of a two-dimensional photonic crystal composed of a cylinder semiconductor on silica accounts for the mode whose electric field vector is normal to the direction of propagation. The TM mode, illustrated in graph 1560 illustrates low cross talk characteristics. The refractive index values for the waveguide layer and material used in the holes is as follows: n₁=3.192, n₂=1.46 with the respective dielectric constants being ε₁=10.2 and ε₂=2.1316.

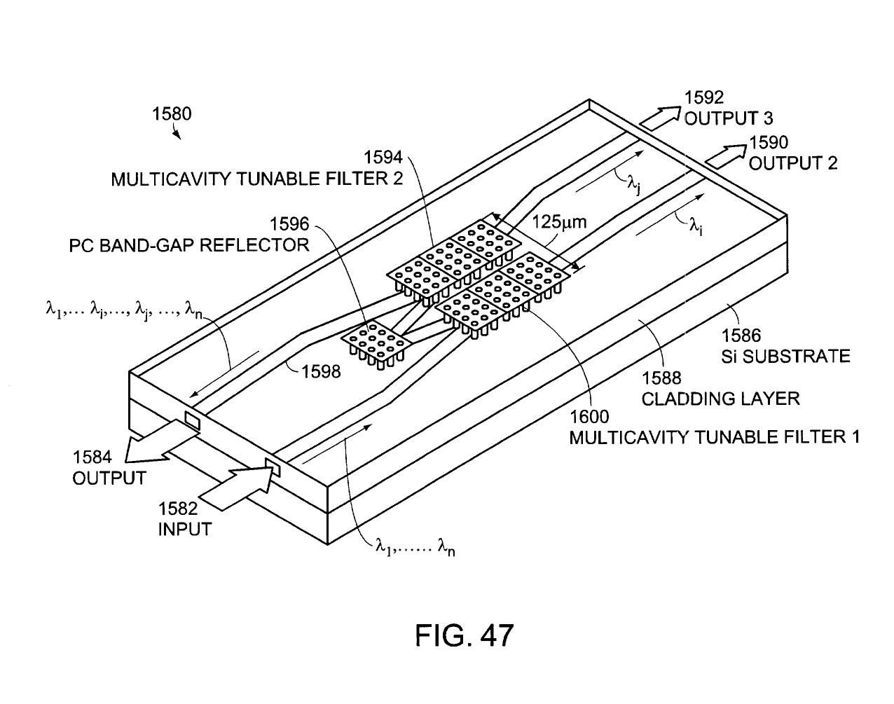

FIG. 47 is a preferred embodiment of a dual wavelength tunable filter 1580 in accordance with the present invention. The multiport wavelength router and particularly, the dual wavelength top-flat tunable filter device 1580 includes two multi-cavity tunable filters 1594, 1600 disposed between the photonic crystal waveguide such as waveguide 1598.

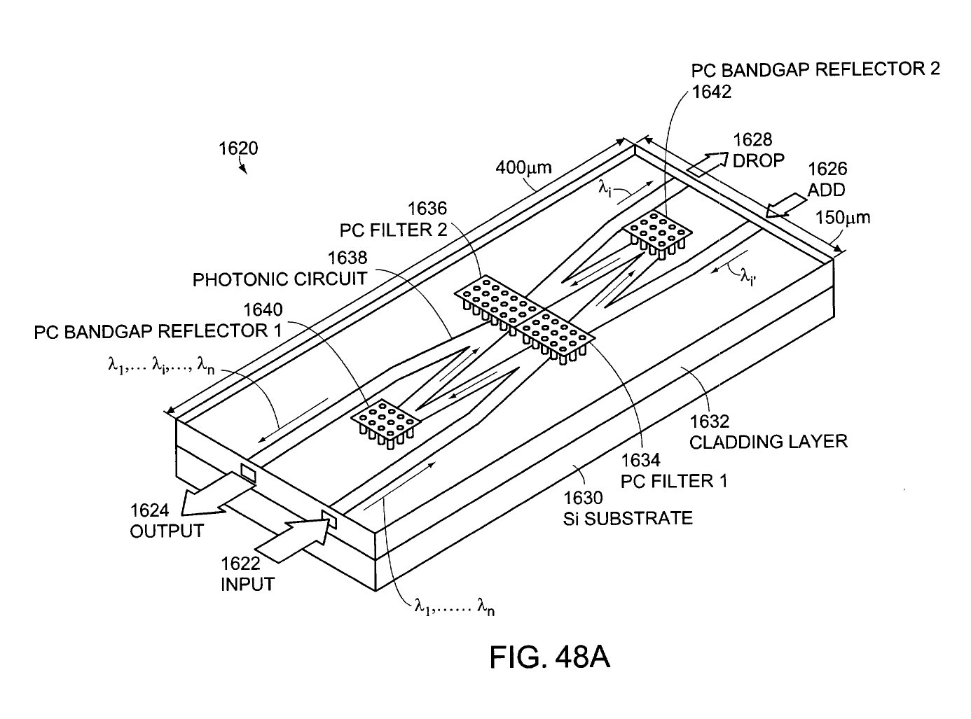

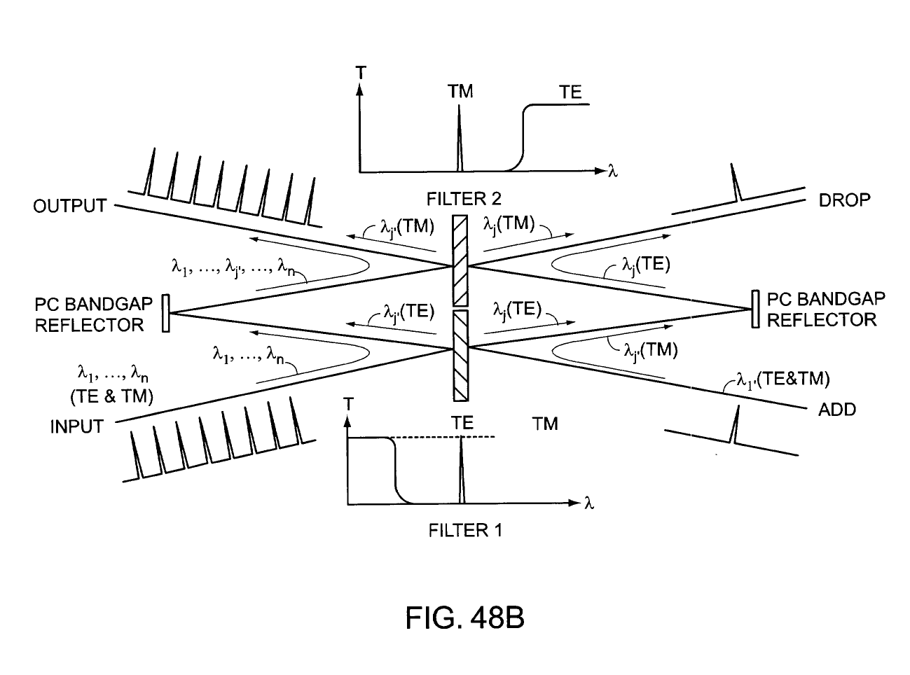

FIGS. 48A and 48B illustrate a preferred embodiment of an optical add/drop multiplexer device and the directions of propagation respectively in accordance with the present invention. The multiplexer device 1620 provides the ability of selectively dropping wavelength λᵢ in an Optical Add/Drop multiplexing (OADM) system.

Based on the theoretical analysis of photonic crystal, the filtering performance can be realized with polarization independency. The two-dimensional photonic crystal (PC) filters 1634, 1636 have the band-gap reflector for one polarization mode while they have the filtering performance for another polarization mode. Thus, the photonic crystal filter can be made to have the filter performance for TE mode while having the band-gap reflection for TM mode in waveguide, or vice versa and thus providing the wavelength selectable add/drop multiplexer.

There are two photonic crystal band-gap reflectors 1640, 1642 which reflect both TE and TM modes. The filter 1634 reflects all wavelength TM and absorb TE modes totally while it lets wavelength λᵢ in TE mode to pass through. The second filter 1636 reflects all wavelength TE and absorb TM modes totally while it lets wavelength λᵢ in TM mode to pass through. When multi-wavelength light is injected from the input port 1622, λᵢ wavelength TE mode signal passes through the filter 1634 while all TM and other TE modes are reflected. At the second filter 1636, λᵢ wavelength TM mode signal passes through to combine with λᵢ wavelength TE mode signal while all other wavelength TE and TM modes are reflected into the output port 1624. This preferred embodiment is also a wavelength selectable 1×2 switch.

For the adding function, λᵢ wavelength light is injected from the add port 1626. The TE mode passes through the filter 1634 while the TM mode is reflected. At the second filter 1636, the TE mode is reflected while the TM mode passes through. Thus, both TE and TM modes of adding wavelength λᵢ join into the output port 1624. In a preferred embodiment, when the passing central wavelength is tuned, the tunable wavelength OADM is formed in the conventional photonic circuit using two-dimensional photonic crystal structures.

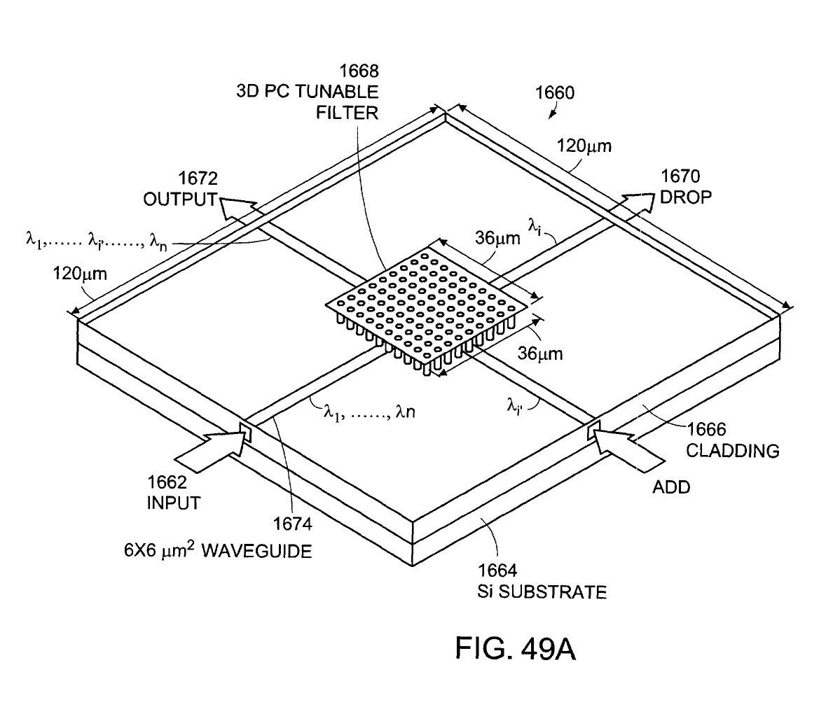

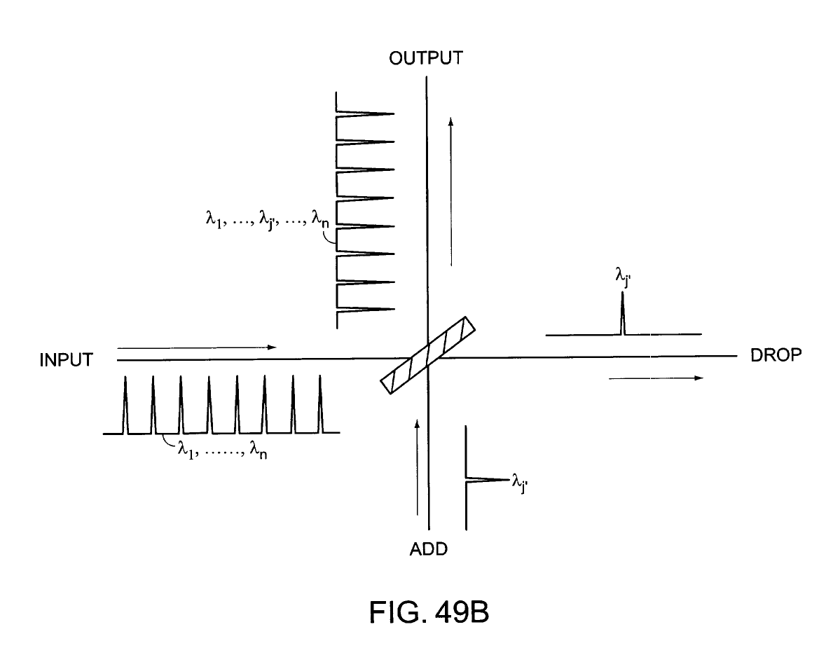

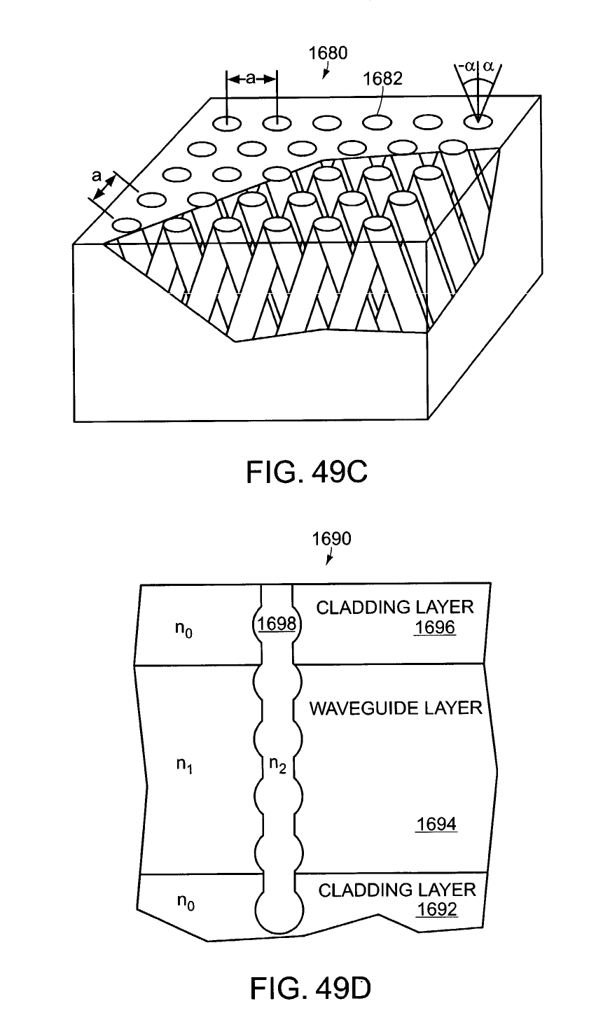

FIGS. 49A and 49B illustrate a preferred embodiment of an optical add/drop multiplexer 660 using a three-dimensional photonic crystal tunable filter 1668 and the related spectrum, respectively, in accordance with the present invention. The principles described with respect to FIG. 48A apply here with the exception that the photonic crystal is periodic along all three different axes.

FIG. 49C is a view of a three-dimensional photonic crystal structure 1680 realized by a lithographic pattern and exemplary angle-controlling etching methods in accordance with the present invention.

FIG. 49D is a cross-sectional view 1690 of elements in a three-dimensional photonic crystal structure realized by a lithographic pattern and exemplary wet-dry mixed etching technologies in accordance with a preferred embodiment of the present invention.

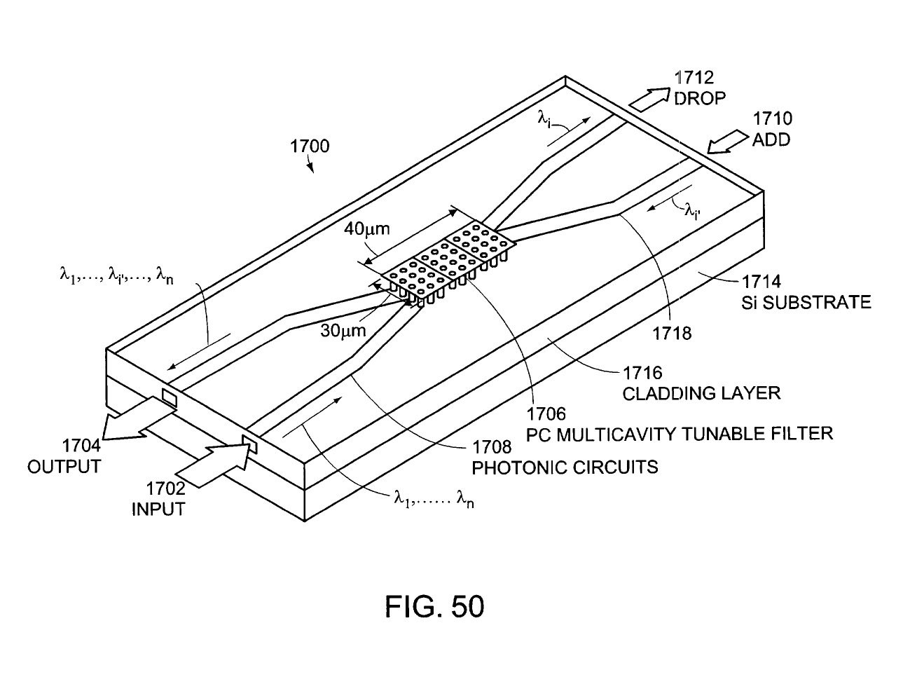

FIG. 50 illustrates a dynamic four port optical add/drop multiplexer 1700 in accordance with a preferred embodiment of the present invention. The multiplexer 1700 provides the ability to dynamically add or drop signals. The device employs a photonic crystal tunable filter which includes a resonator system disposed between waveguides such as waveguides 1708, 1718. The input port 1702 is coupled to an input waveguide 1708 which carries a signal having a plurality of frequencies. The optical multiplexer is disposed between the input waveguide 1708 and the add and drop ports 1710, 1712.

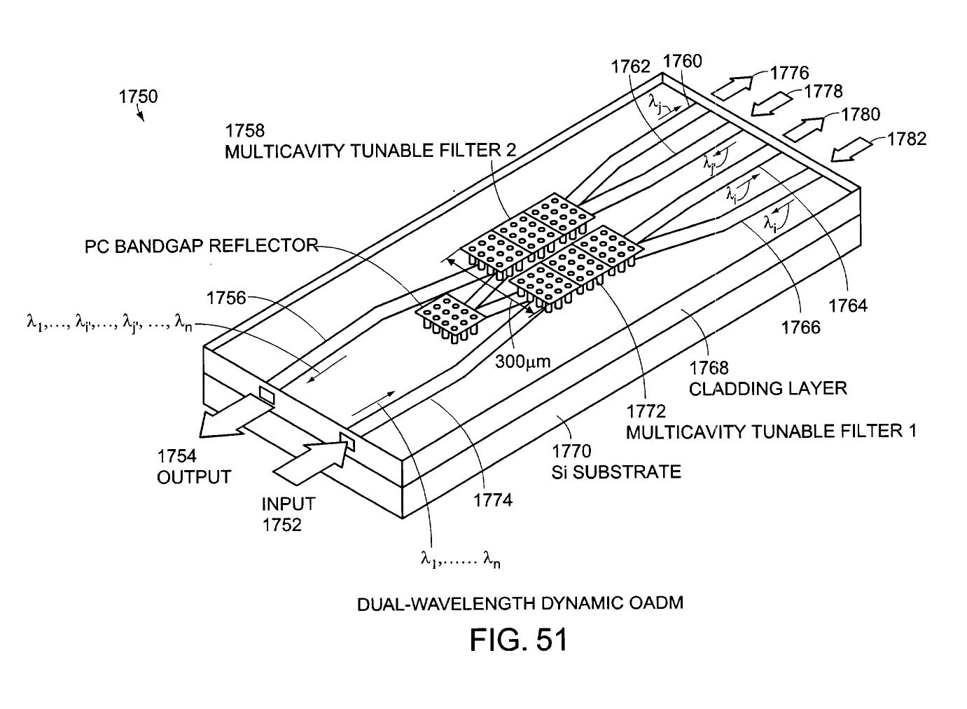

FIG. 51 illustrates a multi-port wavelength router in accordance with a preferred embodiment of the present invention. The multi-port dual-wavelength router 1750 has a plurality of multicavity tunable filters 1758, 1772 and a photonic crystal band gap reflector 1774. Additional wavelengths are carried by waveguides 1762 and 1782 while signals are dropped by ports 1776 and 1780.

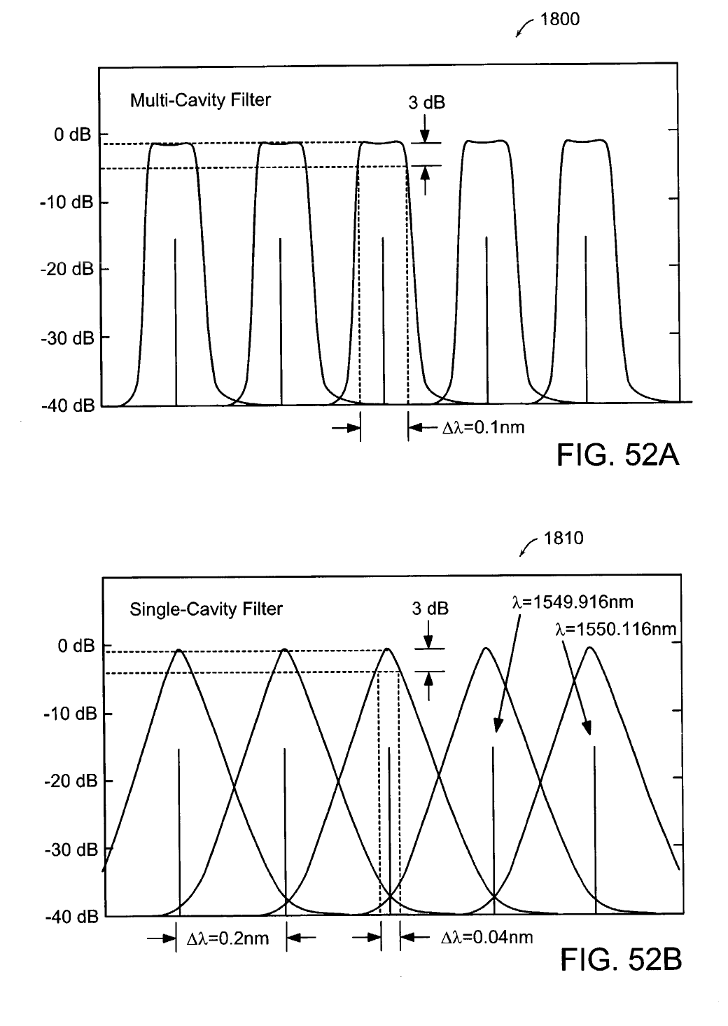

FIGS. 52A and 52B illustrate graphically the levels of cross talk in a single cavity filter and a multi-cavity device, respectively, in accordance with preferred embodiments of the present invention. The level of cross talk in a multi-cavity filter device as illustrated in graph 1800 is lower than the level of cross talk in the graph 1810. The integrated multi-cavity filter forms a flat top filter, with low cross talk and polarization independent characteristics. In a preferred embodiment, the multi-cavity filters can be formed as circuit chips and approximately 650 circuit chips can populate a square inch.

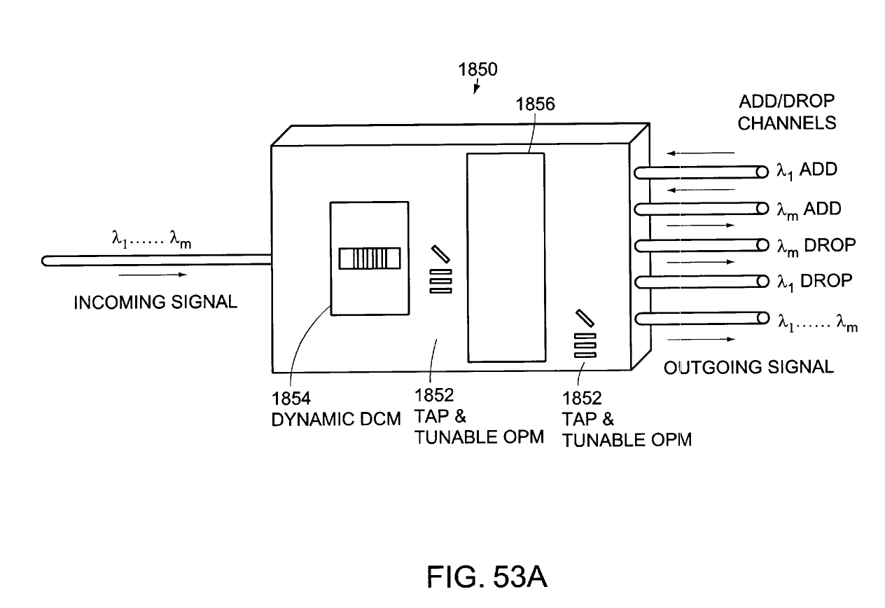

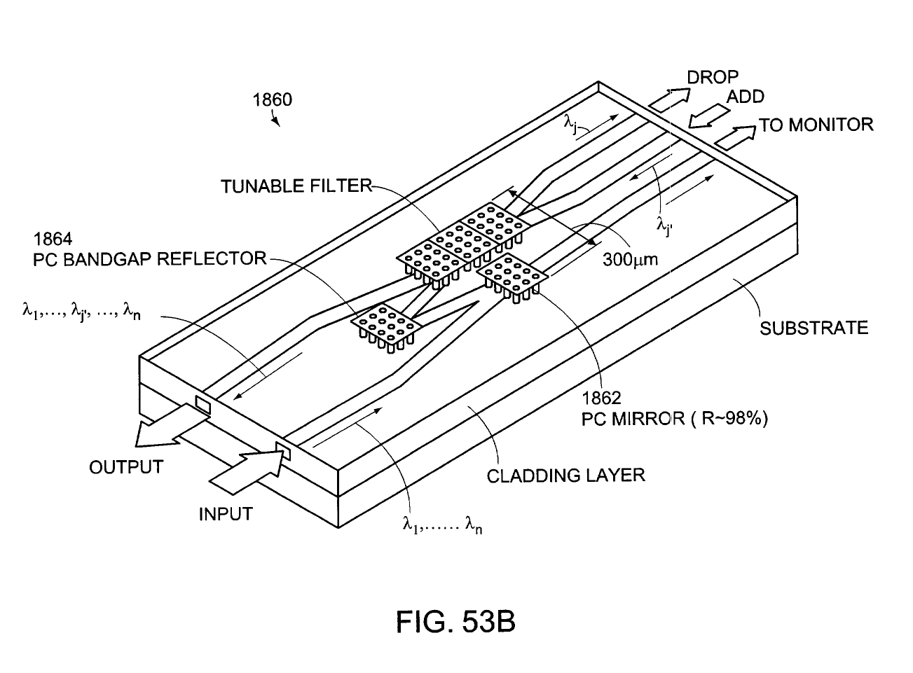

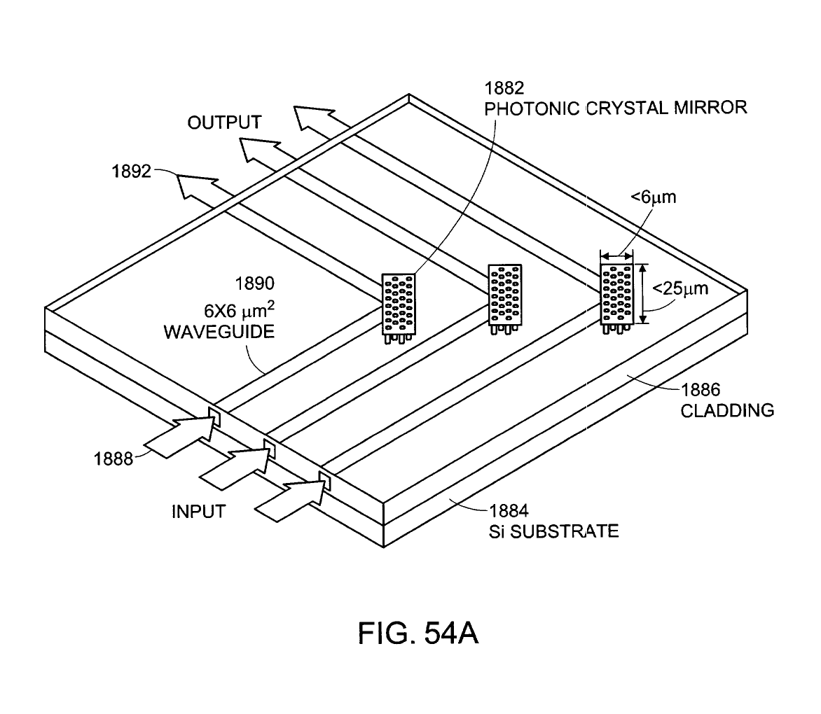

FIG. 53A is a multi-functional device 1850 including an optical add/drop multiplexer, an optical performance monitor 1852, a power tap, a dispersion compensation module 1854 and a wavelength router 1856. The output port in a preferred embodiment is a multi-output port with separate add and drop channels.

FIG. 53B is a schematic illustration of a 2×2 wavelength router 1860 with an integrated tap. The wavelength router includes the dynamic chromatic dispersion compensator, WDM filters, and a power tap as well as the approximately 100% reflectors 1862. Several integrated taps are used to split several percentages of optical signals into the optical performance monitors.

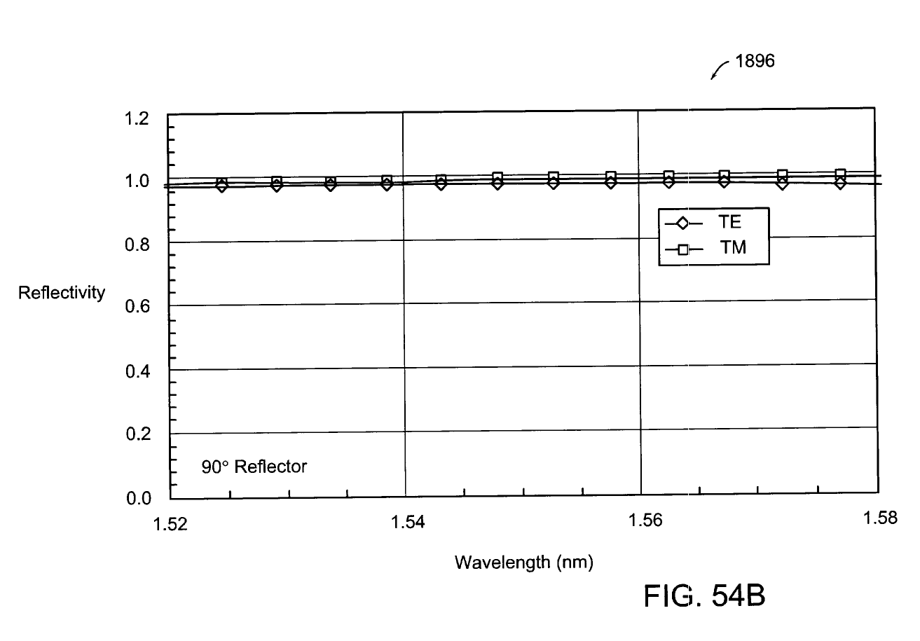

FIG. 54A is a schematic diagram of a photonic crystal device having zero-radius waveguide bends in accordance with the present invention. The device includes photonic crystal reflectors with low loss characteristics. The waveguides, such as waveguide 1890, have dimensions to enable optimal fiber coupling. For example, the waveguide dimensions are 6×6 μm². The device configuration includes a fan-in and fan-out configuration for the inputs and outputs.

FIG. 54B graphically illustrates the reflectivity versus the wavelength of the photonic crystal device illustrated with respect to FIG. 54A. The curves illustrate the polarization independence of the 90° photonic crystal reflectors.

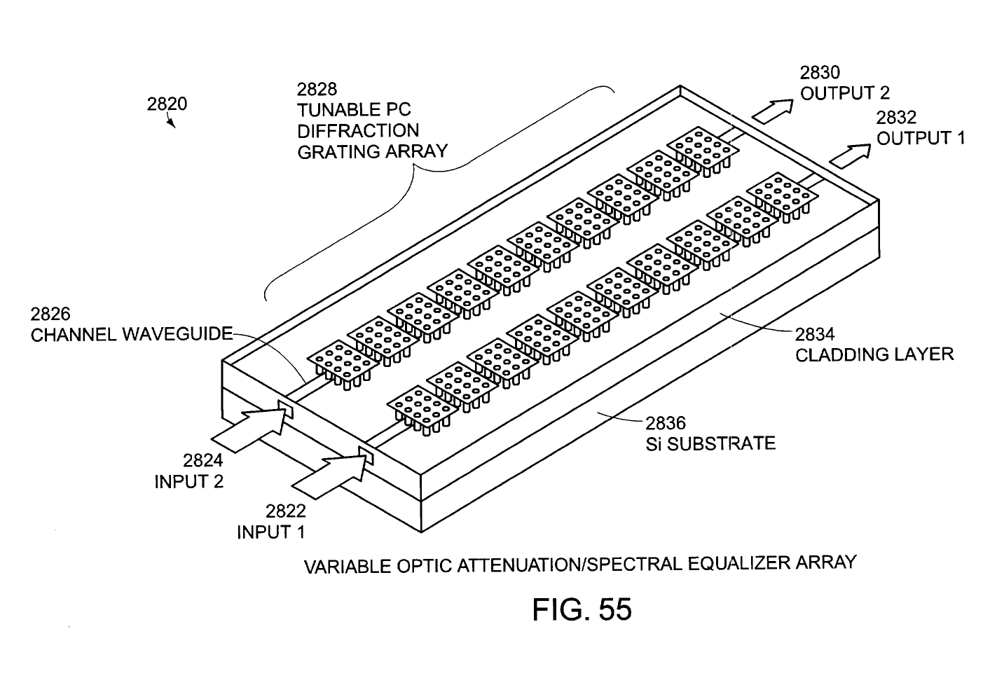

FIG. 55 is a preferred embodiment of a variable optical attenuation spectral equalizer array 2820 in accordance with the present invention. The spectral equalizer array 2820 makes the multi-channel optical power level flat in dense wavelength division multiplexer (DWDM) amplification. Based on the theoretical analysis of three-dimensional volume grating, the optical diffraction ratio can be dependent on the wavelength with polarization independency. The two-dimensional photonic crystal (PC) diffraction grating such as present in the tunable photonic crystals diffracts only one polarization electric field while another polarized light is transmitted through. Thus, the photonic crystal grating can be made to diffract the TE mode only in wavelength dependency, while the TM mode passes through without loss in waveguide, or vice versa.

There are several groups of photonic crystal diffraction gratings. Each group is composed of two diffraction gratings as a central wavelength λᵢ and with bandwidth Δλᵢ, one working for TE mode and another for TM mode. Diffraction of light is adjustable independently in different group of gratings, resulting in a flat power level over a desired wavelength range.

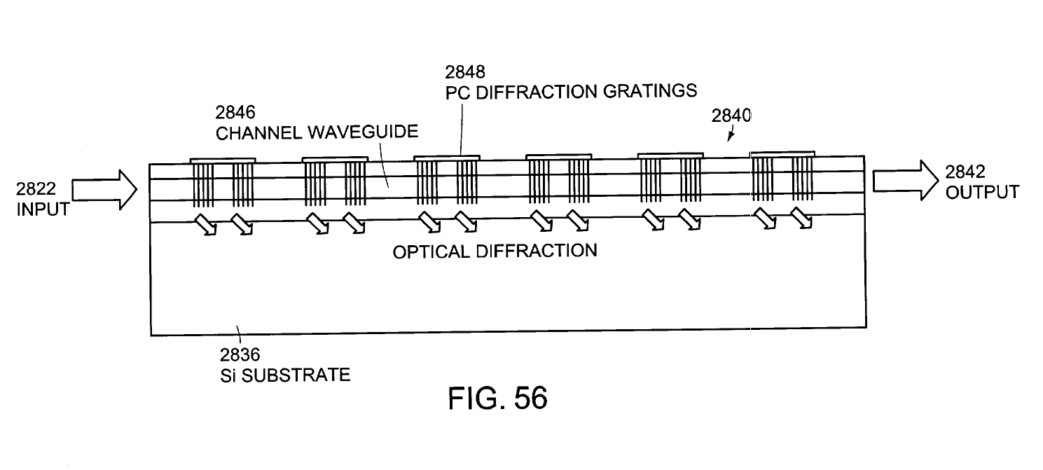

FIG. 56 is a cross-sectional view 2840 of the spectral equalizer array illustrated with respect to the preferred embodiment in accordance with the present invention in FIG. 55.

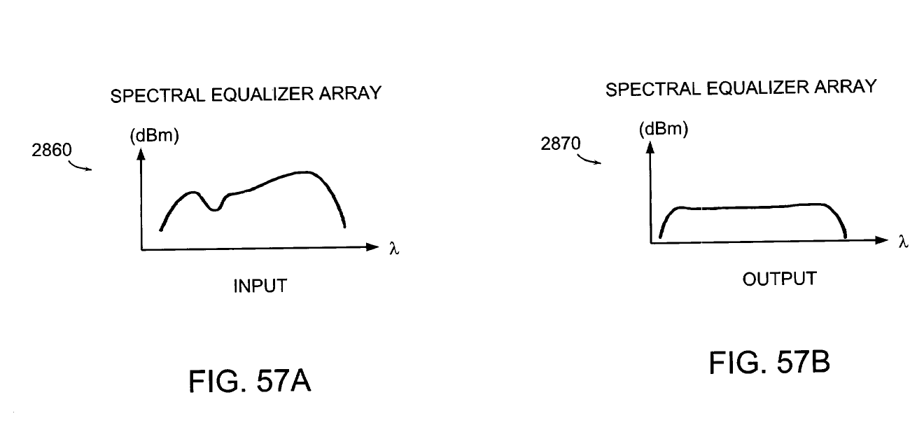

FIGS. 57A and 57B graphically illustrate the spectrums 2860, 2870 at the input port and the output port of the preferred embodiment illustrated in FIG. 55. The output spectrum is flattened over the desired wavelength range.

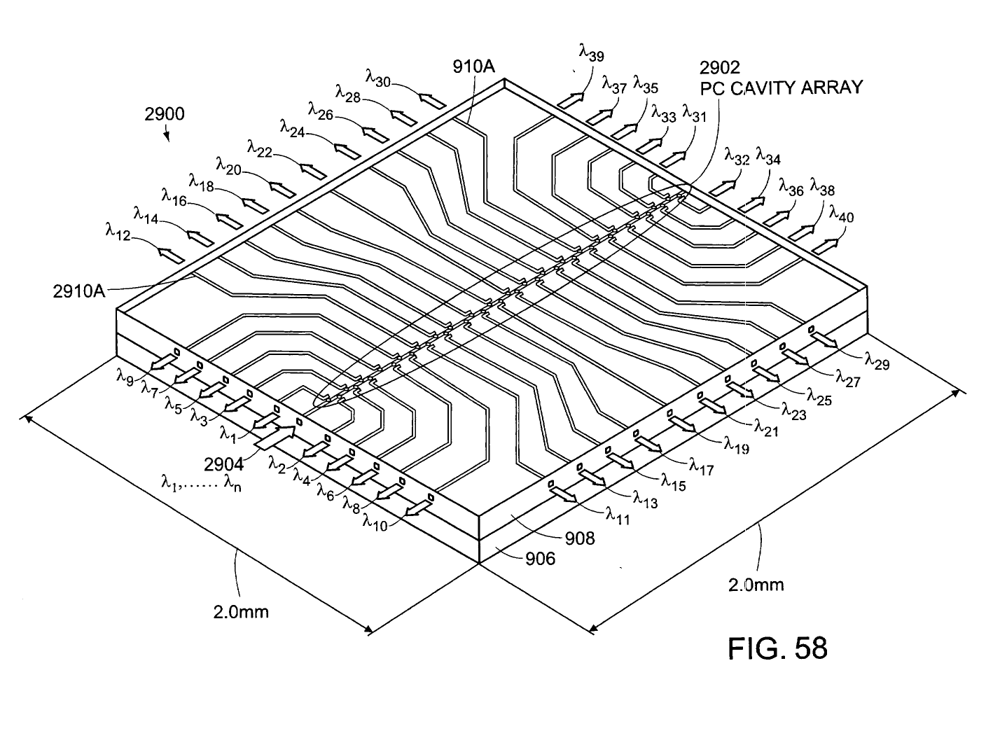

FIG. 58 illustrates an alternate preferred embodiment of a resonant coupled waveguide structure 2900 in accordance with the present invention. A silicon substrate 2906 has a cladding 2908 disposed over the substrate. A plurality of photonic crystal waveguides 2910a . . . n are disposed in the cladding. The use of this alternative embodiment of the waveguide structure comports with the increasing interest in photonic integrated circuits (PIC's) and the increasing use of all-optical fiber networks as backbones for global communication systems which have been based in large part on the extremely wide optical transmission bandwidth provided by dielectric materials. This has accordingly led to an increased demand for the practical utilization of the full optical bandwidth available. In order to increase the aggregate transmission bandwidth, it is generally preferred that the spacing of simultaneously transmitted optical data streams, or optical data channels, be closely packed to accommodate a larger number of channels, such as guides 2910a . . . n. In other words, the difference in wavelength between two adjacent channels is preferably minimized.

This configuration 2900 accesses one channel of a wavelength division multiplexed (WDM) signal while leaving other channels undisturbed and can be used for optical communication systems. The resonant coupled waveguide structure provides for channel dropping because it can potentially be used to select a single channel with a very narrow linewidth. The waveguides, for example, 2910a . . . n, the bus 2902 and the drops, are coupled through the waveguide structure. While WDM signals, (i.e. multi-frequency signals) propagate inside one waveguide (the bus), a single frequency-channel is transferred out of the bus and into the other waveguide (the drop) either in the forward or backward propagation direction, while completely prohibiting cross talk between the bus and the drop for all other frequencies.

The performance of the resonant coupled waveguide structure may be determined by the transfer efficiency between the waveguides. Perfect efficiency corresponds to 100% transfer of the selected channel into either the forward or backward direction in the drop, with no forward transmission or backward reflection into the bus. All other channels remain unaffected by the presence of the waveguide structure.

The forward propagating wave in the bus excites a rotating mode in the waveguide structure, which in turn couple into the backward propagating mode in the drop. Ideally, at resonance, a 100% transfer can be achieved. However, radiation losses inside the waveguide structure have the effect of reducing the transfer efficiency. Furthermore, the resonant coupled waveguide structure supports multiple resonances. The photonic crystal microcavities do not suffer from intrinsic radiation losses, and can be truly single mode, and are somewhat insensitive to fabrication-related disorder.

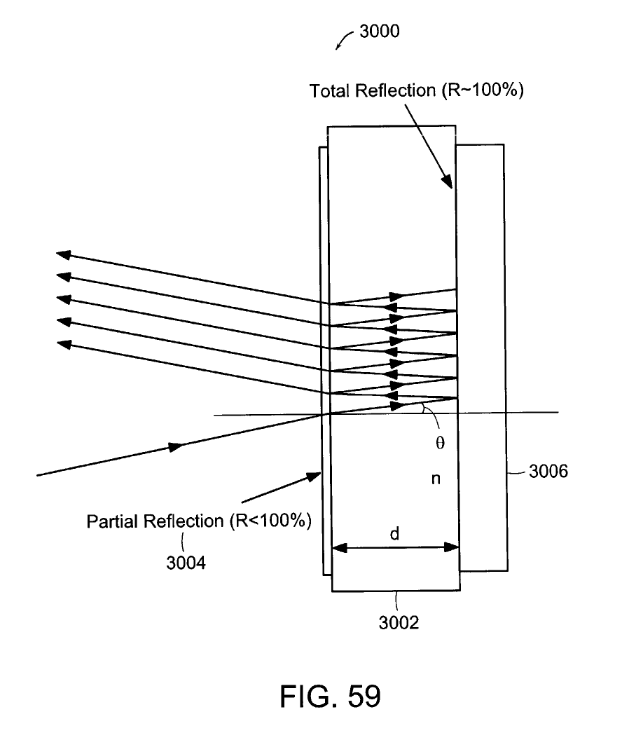

In alternate preferred embodiments of the present invention, a Gires-Tournois etalon is an asymmetric Fabry-Perot cavity with a rear mirror reflectivity of 100%, while the front mirror is a partially reflecting dielectric coating with R<100%. FIG. 59 illustrates the asymmetric Fabry-Perot cavity in accordance with the present invention. The reflectivity of the whole stack is approximately 100%, because light cannot pass through the second mirror 3006 and the whole stack is lossless. All the electromagnetic energy is reflected provided the mirror reflectivity remains approximately 100% in the spectral regions of interest. It is an ideal configuration to have a purely phase modulation, which in preferred embodiments is used in the application of a chromatic dispersion compensation.

In this preferred embodiment of a Gires-Toumois etalon device 3000, the reflection coefficient can be written as the following:

$$r = {ⅇ}^{ⅈ ψ} = \frac{- \sqrt{R} + {ⅇ}^{- 2 ⅈ ϕ}}{1 - \sqrt{R} \cdot {ⅇ}^{- 2 ⅈ ϕ}} \qquad ( \text{17a} )$$

where φ is given by

$$ϕ = \frac{2 π}{λ} nd cos θ \qquad ( \text{17b} )$$

The phase shift upon reflection, ψ is defined in equation (17a) and can be expressed in terms of φ as

$$ψ = 2 arc tg [ \frac{1 + \sqrt{R}}{1 - \sqrt{R}} tg ϕ ] \qquad ( 18 )$$

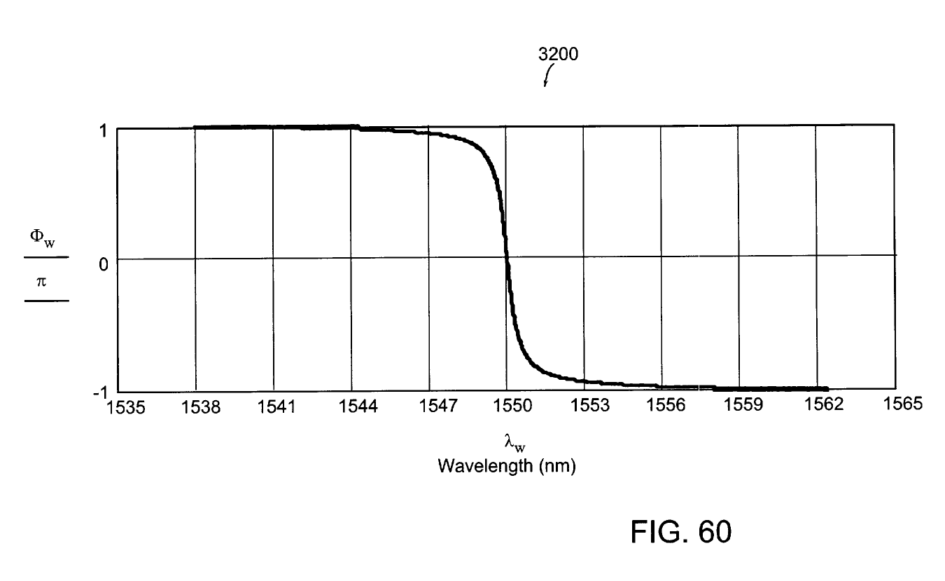

In the limit when the reflectivity of the front mirror vanishes (R=0), this phase is reduced to 2φ, which can be defined simply as the round trip optical phase gained by the light beam. When the reflectivity is greater than zero (R>0), the phase ψ may be ubstantially increased because of the multiple reflections in the asymmetric Fabry-Perot cavity. It means that the chromatic dispersion of the cavity material can be magnified. FIG. 60 shows the phase ψ plotting versus wavelength from equation (18) in accordance with a preferred embodiment of the present invention.

This result illustrates that the chromatic dispersion is nearly zero at most wavelength ranges, except in the narrow band wavelengths that fulfill the cavity resonant conditions. This characteristic is very useful to the applications like as chromatic dispersion compensation and optical delay lines at discrete wavelengths.

In the material, components and transmission systems, the traveling time τ for a group of velocity v_{g} and optical path L is

$$τ = \frac{L}{{V}_{g}} , or τ = L {β}^{′} = L \frac{\partial β}{\partial ω} = \frac{\partial ψ}{\partial ω} \qquad ( 19 )$$

where β is the propagation constant and β′ is the first derivative with respect to ω. The variation of traveling time τ with respect to frequency ω is

$$\frac{\partial τ}{\partial ω} = L {β}^{″} = L \frac{{\partial }^{2} β}{\partial {ω}^{2}} = \frac{{\partial }^{2} ψ}{\partial {ω}^{2}} \qquad ( 20 )$$

where β″ is the second derivative with respect to ω.

For a signal with a spectral width Δω, then the traveling time extension Δτ is

$$\begin{matrix}Δτ = L {β}^{″} Δω = \frac{{\partial }^{2} ψ}{\partial {ω}^{2}} Δω \\ or & \text{(21a)} \\ Δτ = - \frac{2 π c}{{λ}^{2}} \frac{{\partial }^{2} ψ}{\partial {ω}^{2}} Δλ & \text{(21b)}\end{matrix}$$

The optical pulse extension can be expressed by the Group Velocity Dispersion (GVD) coefficient a as the following:

$$\begin{matrix}Δτ = α L Δω \\ α = \frac{1}{L} \frac{{\partial }^{2} ψ}{\partial {ω}^{2}}\end{matrix} \qquad ( 22 )$$

Thus, the pulse spread caused chromatic dispersion depends on ψ.

Starting from (18) equation, the second derivative (group-velocity dispersion coefficient) of the phase of light reflected from G-T etalon can be expressed as

$$ΔΦ = α L = \frac{{\partial }^{2} ψ}{\partial {ω}^{2}} = - 2 {( \frac{nd}{c} )}^{2} \cdot \frac{1 + \sqrt{R}}{1 - \sqrt{R}} \cdot \frac{4 \sqrt{R} {( 1 - \sqrt{R} )}^{2} sin ( 2 ϕ )}{{[ {( 1 - \sqrt{R} )}^{2} + 4 \sqrt{R} {sin}^{2} ( ϕ ) ]}^{2}} \qquad ( 23 )$$

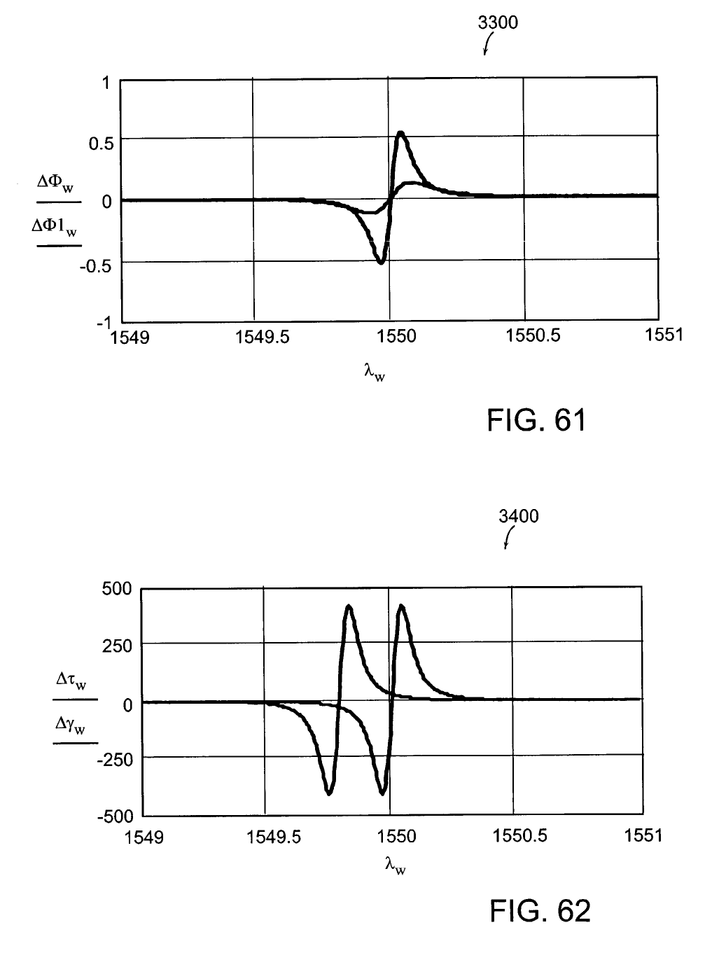

By equation from (18) and (23), the group-velocity dispersions can be calculated for the light beams through the Gires-Toumois (G-T) etalon device in accordance with a preferred embodiment, as shown in the FIG. 61, in which the front mirror reflectivities are respectively 0.95 and 0.9. The value of d=50 λc/n and the center wavelength λc is 1550 nm.

The group-velocity dispersion (GVD) has a number covering a range from the negative and positive ones in the wavelength range around the cavity resonance, which can be adjusted by the fitness of the cavity according to the relation (23). These characteristics are very useful to correct the signal pulse extension caused by the chromatic dispersion. The propagation of light in a long fiber is supposed to create the extension Δτ of optical pulse, because of the chromatic dispersion of guiding mode and material of fiber. The extension Δτ is positive. The central wavelength of pulse λ_{c} is within the resonant range in G-T etalon and ΔΦ_{λ}<0. The pulse width is compressed by Δτ′=ΔΦΔω. To achieve Δτ′+Δτ+0, the pulse extension can be completely compensated through the Gires-Toumois etalon.

As mentioned hereinbefore, group-velocity dispersion exists only around the resonant wavelength, and the resonant wavelengths are determined by the cavity length and the refractive index of etalon materials. These characteristics provide the way to tune the compensating wavelengths. Thus, either index or the etalon length can be used to realize the tuning functionality for the chromatic dispersion compensation. FIG. 62 shows one such simulation result of tuning for GVD compensation.

Moreover, this kind of chromatic dispersion compensation can be achieved for a series of wavelengths at one Gires-Toumois etalon, if the etalon has the multi-resonant longitudinal modes. Supposing mode separation in wavelength is equal to the channel space in DWDM, the tunable chromatic dispersion compensation is feasible to whole channels of DWDM at one tunable Gires-Toumois etalon.

In a preferred embodiment, heterogeneous integration devices are formed by combining formation and etch processes, including coating interior surfaces of optical MEMs and microfluidic devices, interior surfaces of fibers and fiber bundles, and creating three-dimensional structures by cycles of etch, SFD and/or conventional deposition. Preferred embodiments include free space integrated optics, which are small Micro-Electromechanical Systems (MEMs) longitudinal designs on surfaces, but which do not involve waveguides.

TABLE 1.0

| | Photonic Crystal | | | |
|---|---|---|---|---|
| MEMs Technology | Technology (3-cavity) | | | |
| Insertion Loss | 2.5-3 | dB | 1.5 | dB |
| Contrast ratio | 40 | dB | 40 | dB |
| Channel selectivity | 50 | dB | 60 | dB |
| Filter width @ 3 dB | 40 | pm | 100 | pm |
| Filter width @ 25 dB | 400 | pm | 150 | pm |
| Tuning range | 45 | nm | 45 | nm |
| Wavelength | 1500-1630 | nm | 1500-1600 | nm |
| Operating Temperature | 0-70° | C. | 0-70° | C. |
| Operating Humidity | 5-95% | | 5-95% | |
| Price (1-10) | $5,000 | | $1,000 | |
| Price (1000+) | $3,500 | | $500 | |

Table 1.0 illustrates a comparison of photonic crystal technology and MEMs technology. Recent advances in micro-electro-mechanical systems (MEMS) have made it possible to produce compact optomechanical structures and microactuators at low-cost, using batch-processing techniques. Movable optomechanical structures, micromotors rotating at record speeds (over a million revolutions per minute), and linear microactuators with extremely high accuracy (on the order of 10 nm) are just a few examples. MEMS technology has opened up many new possibilities for optical and optoelectronic systems, including optomechanical devices that can be monolithically integrated on a single chip. Compared with macro-scale optomechanical devices, micromechanical devices are smaller, lighter, faster (higher resonant frequencies), and more rugged. Very efficient light modulators, switches, broadly tunable lasers, detectors, and filters can now be realized. This family of new devices is called micro-opto-electro-mechanical systems (MOEMS) or, simply, optical MEMS. The applications of optical MEMS include projection and head-mounted displays, optical data storage, printing, optical scanners, switches, modulators, sensors, and optoelectronic components packaging. Preferred embodiments of the present invention integrate MEMs devices and photonic crystal devices discussed hereinbefore.

MEMS technology includes both bulk and surface micro machining in bulk micromachining, precise mechanical structures created on silicon wafers by anisotropic etching. The etching rate of silicon in crystal planes is much slower than in other planes in etchants such as EDP, KOH, or TMAH. As a result, bulk micromachining can create very precise V-grooves, pyramidal pits, and cavities. These V-grooves for positioning or aligning optical fibers and micro-optics can then be coated with materials using SFD technology discussed herein.

In contrast to bulk micromachining, in preferred embodiments of the present invention, surface micromachined structures can be made entirely from thin films deposited on the surface of a wafer using SFD. Alternating layers of structural and sacrificial layers are successively grown and patterned on the substrate. Sacrificial etching, the key technology for surface micromachining, selectively removes sacrificial layers from underneath the structural layers, creating free-standing thin-film mechanical structures. Polysilicon thin films and silicon dioxide sacrificial layers are popular surface micromachining materials because of their mechanical properties and the high selectivity of sacrificial etching. Other material combinations may be configured, for example, using aluminum structural layers and organic sacrificial layers for a digital micromirror device and integrating micromirrors on silicon chips with a complementary metal dioxide-semiconductor (CMOS) transistor driving circuit for projection display application.

MEMS technology has made it possible, for the first time to integrate an entire optical table onto a single silicon chip. Optical elements such as lenses, mirrors, and gratings are batch fabricated along with the XYZ stages and the microactuators. Several XYZ stages are used to align the microlenses and a tunable optical delay line to form a femtosecond optical autocorrelator. Similarly, many other optical functions can be implemented on a free space micro-optical-bench (FS-MOB) in accordance with preferred embodiments of the present invention. FS-MOBs offer many advantages over conventional optical systems.

One of the most important building blocks of FS-MOB is the out-of-plane micro-optical elements. Their optical axes are parallel to the substrate so that the optical elements can be cascaded, similar to the bulk optical systems built on optical tables. Conventional micro-optics fabrication techniques can only produce in-plane microlenses, that is, microlenses lying on the surface of the substrate. In MEMS FS-MOB, the surface-micro-machined microhinges can “flip up” the microlenses after they are fabricated.

The out-of-plane micro-optical elements can also be integrated with actuated translation or rotation stages for optical alignment or tuning of an optical circuit such as one formed in accordance with preferred embodiments of the present invention using SFD. Instead of anchoring the optomechanical plates to the substrate, it is attached to another suspended polysilicon plate, which is free to move in the direction determined by the confinement structures.

The preferred embodiments are simulated and analyzed using simulation tools such as, but not limited to, Translight, provided by the University of Glasgow, which provides the ability of theoretical modeling.

The claims should not be read as limited to the described order or elements unless stated to that effect. Therefore, all embodiments that come within the scope and spirit of the following claims and equivalents thereto are claimed as the invention.

What is claimed:

1. A photonic crystal structure, comprising:
a substrate having a surface characteristic; and
at least a first material disposed on the surface characteristic and conformally covering the surface.

2. The photonic crystal structure of claim 1 wherein the first material is disposed using supercritical fluid deposition processes.

3. The photonic crystal structure of claim 1 wherein the surface characteristic is a patterned substrate.

4. The photonic crystal structure of claim 1 wherein the first material comprises one of at least a metal, a semiconductor, a polymer, a monomer, a mixture of metals, a metal dioxide, a metal sulphide and metal alloys.

5. The photonic cyrstal structure of claim 3 wherein the patterned substrate has submicron features.

6. The photonic crystal structure of claim 5 wherein the features have an aspect ratio of between approximately twenty and thirty.

7. The photonic crystal structure of claim 1 wherein the substrate is one of a silicon wafer, and a silicon wafer having a silicon dioxide cladding layer.

8. The photonic crystal structure of claim 1 comprising a thin film filter.

9. The photonic crystal structure of claim 1 comprising an integrated circuit.

10. An integrated waveguide device, comprising:
a substrate having a first refractive index characteristic;
a first material disposed on the substrate having a second refractive index characteristic, and forming a waveguide layer; and
a second material disposed at least within the first material having a third refractive index characteristic wherein the third refractive index characteristic is greater than the first and second refractive index characteristics.

11. The integrated waveguide device of claim 10 further comprising a cladding layer disposed on the first material.

12. The integrated waveguide device of claim 10 wherein the dimensions of the waveguide layer is approximately 6×6 μm².

13. The integrated waveguide device of claim 10 wherein the second material is deposited in one of a plurality of at least holes, trenches and cylinders.

14. The integrated waveguide device of claim 10 wherein the aspect ratio of the plurality of holes is approximately in the range of 20 to 30.

15. The integrated waveguide device of claim 10 wherein the first material has at least one patterned array of submicron features such that the second material is deposited therein.

16. A photonic crystal filter, comprising:
an input waveguide which carries a signal having at least one frequency including at least one desired frequency;
an output waveguide; and
a photonic crystal resonator system coupled between said input and output waveguides operable for the adjustable transfer of said at least one desired frequency to said output waveguide.

17. The photonic crystal filter of claim 16 wherein the filter is a fixed single-wavelength filter.

18. The photonic crystal filter of claim 16 wherein the filter is tunable for at least one of wavelength and polarization.

19. The photonic crystal filter of claim 16 wherein the photonic crystal resonator system is a multi-cavity Fabry-Perot resonator.

20. The photonic crystal filter of claim 16 wherein the photonic crystal resonator system is a single cavity Fabry-Perot resonator.

21. The photonic crystal filter of claim 16 wherein the photonic crystal resonator system comprises a first photonic crystal mirror and a second photonic crystal mirror, the second photonic crystal mirror being spaced from the first photonic crystal mirror to form a resonant cavity.

22. The photonic crystal filter of claim 21 wherein the first and second photonic crystal mirrors include a two-dimensional hexagonal structure.

23. The photonic crystal filter of claim 21 wherein the first and the second photonic crystal mirrors include a three-dimensional structure.

24. The photonic crystal filter of claim 16 wherein a change in a refractive index characteristic of the photonic crystal resonator system provides for tuning of the filter.

25. The photonic crystal filter of claim 24 wherein the refractive index can be controlled by using one of at least thermal-optics, electro-optics, magneto-optics and piezo-optics means.

26. The photonic crystal filter of claim 16 wherein said photonic crystal resonator system comprises a photonic crystal that is a three-dimensionally periodic dielectric structure.

27. The photonic crystal filter of claim 16 wherein said photonic crystal resonator system comprises a photonic crystal that is a two-dimensionally periodic dielectric structure.

28. The photonic crystal filter of claim 16 wherein the photonic crystal resonator system comprises a one-dimensionally periodic photonic crystal.

29. A photonic crystal wavelength router, comprising:
at least a first input waveguide;
at least a first output waveguide;
a chromatic dispersion compensator;
at least one wavelength division multiplex filter; and
at least one photonic crystal reflector.

30. The photonic crystal wavelength router of claim 29 further comprising a power tap disposed therein.

31. The photonic crystal wavelength router of claim 29 wherein the router comprises a material with tunable dielectric or absorbing properties.

32. The photonic crystal wavelength router of claim 29 comprises one of at least a one-dimensionally periodic photonic crystal, a two-dimensionally periodic photonic crystal and a three-dimensionally periodic photonic crystal.

33. A photonic crystal optical add/drop multiplexer, comprising:
an input waveguide;
at least a first output waveguide;
an optical performance monitor coupled between the input waveguide and the at least first output waveguide;
a photonic crystal wavelength router; and
a dispersion compensation module.

34. A photonic crystal dynamic optical add/drop multiplexer comprising:
a plurality of input waveguides;
a plurality of output waveguides;
a plurality of photonic crystal resonator systems disposed between the plurality of input waveguides and plurality of output waveguides; and
a photonic crystal reflector coupled to the plurality of photonic crystal resonator systems.

35. A method of producing an integrated photonic circuit device, comprising:
providing a substrate with a surface characteristic and a first refractive index characteristic;
disposing at least a first material with a second refractive index characteristic onto the surface characteristic, wherein the second refractive index characteristic is higher than the first.

36. The method of producing an integrated photonic circuit device of claim 36 further comprising:
etching the surface characteristic of the substrate to form a plurality of cavities having an aspect ratio characteristic; and
depositing a second material having a third refractive index characteristic in the plurality of cavities, the third refractive index characteristic being higher than the first and the second refractive index characteristic.

37. The method of producing an integrated photonic circuit device of claim 37 wherein the aspect ratio characteristic is approximately 30.

38. A periodic three dimensional photonic crystal structure comprising:
a substrate having a surface characteristic;
at least one thin film deposited on the surface characteristic to result in a multi-layer photonic crystal, the multi-layer photonic crystal being adapted to have an induced variation in an index of refraction characteristic and wherein a plurality of the multi-layer photonic crystals are placed in a stack configuration and a material is deposited into interstitial gaps formed in the stack configuration using supercritical fluid deposition processes.

39. The periodic three-dimensional photonic crystal structure of claim 38 wherein the substrate is spherical in shape.

40. An optical waveguide structure, comprising;
a first waveguide;
a second waveguide that intersects with said first waveguide; and
at least one photonic crystal resonator at the intersection of said first and second waveguides to minimize cross talk between signals of said first and second waveguides.
